(19) United States
(12) Patent Application Publication
(10) Pub. No.: US 2025/0071471 A1
(43) Pub. Date: Feb. 27, 2025

(54) ACOUSTIC OUTPUT DEVICES

(71) Applicant: SHENZHEN SHOKZ CO., LTD., Shenzhen (CN)

(72) Inventors: Lei ZHANG, Shenzhen (CN); Guangyuan ZHU, Shenzhen (CN); Junjiang FU, Shenzhen (CN); Liwei WANG, Shenzhen (CN); Xin QI, Shenzhen (CN)

(73) Assignee: SHENZHEN SHOKZ CO., LTD., Shenzhen (CN)

(21) Appl. No.: 18/942,755

(22) Filed: Nov. 10, 2024

Related U.S. Application Data
(63) Continuation of application No. PCT/CN2022/133192, filed on Nov. 21, 2022.

(51) Int. Cl. H04R 1/28; H04R 9/02; H04R 9/04; H04R 9/06

(52) U.S. Cl. CPC H04R 1/2811; H04R 9/025; H04R 9/045; H04R 9/06; H04R 2460/13

(57) ABSTRACT

Embodiments of the present disclosure provide an acoustic output device including: a transducer configured to generate a mechanical vibration based on an electrical signal, the transducer including a magnetic circuit assembly and a vibration transmission sheet; a housing configured to accommodate the transducer, the housing including a panel and a shell, the magnetic circuit assembly being elastically connected to the housing through the vibration transmission sheet, and the transducer transmitting the mechanical vibration to a user through the panel; and an additional element connected to the magnetic circuit assembly. The additional element is elastically connected to the panel through the magnetic circuit assembly.

### CROSS-REFERENCE TO RELATED APPLICATIONS

This application is a continuation of International Application No. PCT/CN2022/133192, filed on Nov. 21, 2022, the contents of which are incorporated herein by reference in their entirety.

### TECHNICAL FIELD

The present disclosure is related to a field of acoustic technology, and in particular to an acoustic output device.

### BACKGROUND

In the design of some acoustic output devices (e.g., headphones, hearing aids, eyeglasses, helmets, AR/VR devices), it is often necessary to set up other devices in addition to speakers to realize a proper operation of the speakers or to enrich functions of the acoustic output devices. The speaker generally may include a bone conduction speaker and an air conduction speaker. The bone conduction speaker is capable of converting an electrical signal into a mechanical vibration signal and transmitting the mechanical vibration signal to the auditory nerves of a human body through tissues and bones of the human body to enable a user to hear a sound. However, additional devices (e.g., a microphone, a sensor, an air conduction speaker, a battery, a circuit board, etc.) disposed on the basis of the bone conduction speaker have a certain mass that can affect the vibration output of the bone conduction speaker and reduce the sensitivity of the bone conduction speaker. Additionally, the additional element and the magnetic circuit assembly in the transducer may have a problem of attracting or repelling each other and causing the magnetic circuit assembly to flip and deform.

Therefore, how to reduce the effect of the mass of the additional devices on the vibration output of the bone conduction speaker to ensure the high sensitivity of the bone conduction speaker is an urgent problem that needs to be solved.

### SUMMARY

One embodiment of the present disclosure provides an acoustic output device. The acoustic output device includes: a transducer configured to generate a mechanical vibration based on an electrical signal, the transducer including a magnetic circuit assembly and a vibration transmission sheet; a housing configured to accommodate the transducer, the housing including a panel and a shell, the magnetic circuit assembly being elastically connected to the housing through the vibration transmission sheet, and the transducer transmitting the mechanical vibration to a user through the panel; and an additional element connected to the magnetic circuit assembly, the additional element being elastically connected to the panel through the magnetic circuit assembly.

### BRIEF DESCRIPTION OF THE DRAWINGS

The exemplary embodiments are described in detail with reference to the drawings. These embodiments are not limiting, and in these embodiments, the same numbering denotes the same structure, wherein:

FIG. 1 is a schematic diagram illustrating a structure of an acoustic output device according to some embodiments of the present disclosure;

FIG. 2 is a schematic diagram illustrating a structure of an acoustic output device according to some embodiments of the present disclosure;

FIG. 3 is a curve diagram illustrating frequency response curves of acoustic output devices according to some embodiments of the present disclosure;

FIG. 4 is a schematic diagram illustrating a structure of an acoustic output device according to some embodiments of the present disclosure;

FIG. 5 is a curve diagram illustrating frequency response curves of acoustic output devices according to some embodiments of the present disclosure;

FIG. 6 is a curve diagram illustrating frequency response curves of acoustic output devices according to some embodiments of the present disclosure;

FIG. 7 is a schematic diagram illustrating a structure of an acoustic output device according to some embodiments of the present disclosure;

FIG. 8 is a curve diagram illustrating frequency response curves of different acoustic output devices according to some embodiments of the present disclosure;

FIG. 9 is a schematic diagram illustrating a structure of an acoustic output device according to some embodiments of the present disclosure;

FIG. 10 is a curve diagram illustrating frequency response curves of acoustic output devices according to some embodiments of the present disclosure;

FIG. 11 is a curve diagram illustrating frequency response curves of acoustic output devices according to some embodiments of the present disclosure;

FIG. 12 is a schematic diagram illustrating a structure of an acoustic output device according to some embodiments of the present disclosure;

FIG. 13 is a schematic diagram illustrating a structure of an acoustic output device according to some embodiments of the present disclosure;

FIG. 14 is a curve diagram illustrating frequency response curves of acoustic output devices according to some embodiments of the present disclosure;

FIG. 15 is a schematic diagram illustrating a structure of an acoustic output device according to some embodiments of the present disclosure;

FIG. 16 is a curve diagram illustrating frequency response curves of acoustic output devices according to some embodiments of the present disclosure;

FIG. 17 is a schematic diagram illustrating a structure of an acoustic output device according to some embodiments of the present disclosure;

FIG. 18 is a schematic diagram illustrating a structure of an acoustic output device according to some embodiments of the present disclosure;

FIG. 19 is a schematic diagram illustrating a structure of an acoustic output device according to some embodiments of the present disclosure;

FIG. 20 is a schematic diagram illustrating a structure of an acoustic output device according to some embodiments of the present disclosure;

FIG. 21 is a curve diagram illustrating frequency response curves of acoustic output devices according to some embodiments of the present disclosure;

FIG. 22 is a schematic diagram illustrating a structure of an acoustic output device according to some embodiments of the present disclosure;

FIG. 23 is a curve diagram illustrating frequency response curves of acoustic output devices according to some embodiments of the present disclosure;

FIG. 24 is a schematic diagram illustrating a structure of an acoustic output device according to some embodiments of the present disclosure;

FIG. 25 is a schematic diagram illustrating a structure of an acoustic output device according to some embodiments of the present disclosure;

FIG. 26 is a schematic diagram illustrating a structure of an acoustic output device according to some embodiments of the present disclosure;

FIG. 27 is a schematic diagram illustrating a structure of an acoustic output device according to some embodiments of the present disclosure;

FIG. 28 is a curve diagram illustrating sound leakage frequency response curves of acoustic output devices according to some embodiments of the present disclosure;

FIG. 29 is a schematic diagram illustrating a structure of an acoustic output device according to some embodiments of the present disclosure;

FIG. 30 is a schematic diagram illustrating a structure of an acoustic output device according to some embodiments of the present disclosure;

FIG. 31 is a schematic diagram illustrating a structure of an acoustic output device according to some embodiments of the present disclosure;

FIG. 32 is a schematic diagram illustrating a structure of an acoustic output device according to some embodiments of the present disclosure;

FIG. 33 is a schematic diagram illustrating a structure of an acoustic output device according to some embodiments of the present disclosure;

FIG. 34 is a curve diagram illustrating frequency response curves of acoustic output devices according to some embodiments of the present disclosure;

FIG. 35 is a schematic diagram illustrating a structure of an acoustic output device according to some embodiments of the present disclosure;

FIG. 36 is a curve diagram illustrating frequency response curves of acoustic output devices according to some embodiments of the present disclosure;

FIG. 37 is a schematic diagram illustrating a structure of an acoustic output device according to some embodiments of the present disclosure;

FIG. 38 is a schematic diagram illustrating a structure of an acoustic output device according to some embodiments of the present disclosure;

FIG. 39 is a schematic diagram illustrating a structure of an acoustic output device according to some embodiments of the present disclosure;

FIG. 40 is a schematic diagram illustrating a structure of an acoustic output device according to some embodiments of the present disclosure;

FIG. 41 is a schematic diagram illustrating a structure of an acoustic output device according to some embodiments of the present disclosure;

FIG. 42 is a curve diagram illustrating frequency response curves of acoustic output devices according to some embodiments of the present disclosure;

FIG. 43 is a curve diagram illustrating frequency response curves of acoustic output devices according to some embodiments of the present disclosure;

FIG. 44 is a curve diagram illustrating sound leakage frequency response curves of acoustic output devices according to some embodiments of the present disclosure;

FIG. 45 is a curve diagram illustrating sound leakage frequency response curves of acoustic output devices according to some embodiments of the present disclosure;

FIG. 46 is a schematic structure diagram illustrating a top view of a vibration transmission sheet according to some embodiments of the present disclosure;

FIG. 47 is a schematic diagram illustrating a three-dimensional (3D) structure of a vibration transmission sheet according to some embodiments of the present disclosure;

FIG. 48 is a schematic diagram illustrating a wearing state of a speaker according to some embodiments of the present disclosure;

FIG. 49A is a schematic diagram illustration a structure of a speaker according to some embodiments of the present disclosure;

FIG. 49B is a schematic diagram illustrating a structure of a magnetic conductive shield according to some embodiments of the present disclosure;

FIG. 49C is a schematic diagram illustrating positions of an exemplary first magnetic conductive plate and a first coil according to some embodiments of the present disclosure;

FIG. 50 is a schematic diagram illustrating a structure of a speaker according to some embodiments of the present disclosure;

FIG. 51 is a schematic diagram illustrating a structure of a speaker according to some embodiments of the present disclosure;

FIG. 52A is a schematic diagram illustrating a structure of a speaker according to some embodiments of the present disclosure;

FIG. 52B is a comparison diagram illustrating effects of different distances between a bone conduction speaker and an air conduction speaker on a magnetic field of a coil according to some embodiments of the present disclosure;

FIG. 53 is a schematic diagram illustrating a structure of a transducer according to some embodiments of the present disclosure;

FIG. 54A is an exploded diagram illustrating a transducer according to some embodiments of the present disclosure;

FIG. 54 B is a comparison diagram illustrating impedances of transducers of a single voice coil and a dual voice coil according to some embodiments of the present disclosure;

FIG. 54C is a schematic diagram illustrating a portion of a cylindrical magnetic conductive shield according to some embodiments of the present disclosure;

FIG. 54D is a schematic diagram illustrating a bowl-shaped magnetic conductive shield according to some embodiments of the present disclosure;

FIG. 55 is a comparison diagram illustrating frequency response curves of magnetic conductive shields with and without grooves;

FIG. 56 is a schematic structure diagram illustrating a top view of a magnetic conductive plate according to some embodiments of the present disclosure;

FIG. 57 is a comparison diagram illustrating frequency response curves of magnetic conductive plates without and with holes according to some embodiments of the present disclosure;

FIG. 58 is a comparison diagram illustrating frequency response curves of magnetic conductive plates without and with holes according to embodiments of the present disclosure;

FIG. 59 is a comparison diagram illustrating BL value curves when a second hole on a magnetic conductive plate is at different distances from a center of the magnetic conductive plate according to some embodiments of the present disclosure;

FIG. 60 is a comparison diagram illustrating frequency response curves when a second hole has different diameters according to some embodiments of the present disclosure;

FIG. 61 is a comparison diagram illustrating BL value curves when a second hole has different diameters and a comparison diagram illustrating acceleration curves of a speaker when a mass of a speaker is in a range of 2 g to 5 g according to some embodiments of the present disclosure;

FIG. 62 is a schematic diagram illustrating a structure of a magnetic circuit assembly in a form of a Halbach Array (HA) according to some embodiments of the present disclosure; and

FIG. 63 is a comparison diagram illustrating BL value curves of magnetic circuit assemblies with different magnetic portion arrays according to some embodiments of the present disclosure.

### DETAILED DESCRIPTION

To more clearly illustrate the technical solutions of the embodiments of the present disclosure, the following description of the accompanying drawings required to be used in the description of the embodiments will be briefly described. Obviously, the accompanying drawings in the following description are only some examples or embodiments of the present disclosure, and it is possible for those skilled in the art to apply the present disclosure to other similar scenarios based on the accompanying drawings without creative labor. Unless obviously obtained from the context or the context illustrates otherwise, the same numeral in the drawings refers to the same structure or operation.

Embodiments of the present disclosure describe an acoustic output device. In some embodiments, an acoustic output unit of the acoustic output device is a bone conduction speaker. In some embodiments, the acoustic output device includes a transducer, a housing, and an additional element. The transducer generates mechanical vibrations based on an electrical signal. The transducer includes a magnetic circuit assembly, a coil, and a vibration transmission sheet. The housing is configured to accommodate the transducer. The housing includes a panel and a shell. The transducer transmits the mechanical vibration to a user through the panel. In the acoustic output device disposed by embodiments of the present disclosure, the vibration transmission sheet has elasticity, the magnetic circuit assembly is elastically connected to the housing through the vibration transmission sheet, and the additional element is connected to the magnetic circuit assembly to remain elastically connected to the panel. For example, the magnetic circuit assembly is elastically connected to the panel through the vibration transmission sheet, so that the additional element can remain elastic connection with the panel when connected to the magnetic circuit assembly. For another example, the magnetic circuit assembly is connected to a sidewall (or referred to as a back plate) in the shell opposite to the panel through the vibration transmission sheet. For another example, there are a plurality of vibration transmission sheets, and the plurality of vibration transmission sheets include a first vibration transmission sheet and a second vibration transmission sheet. The magnetic circuit assembly is connected to the panel and the back plate through the first vibration transmission sheet and the second vibration transmission sheet, respectively, so that the additional element remains elastic connection with the panel when connected to the magnetic circuit assembly. The additional element is connected to the magnetic circuit assembly directly or indirectly. For example, the additional element is directly rigidly connected to the magnetic circuit assembly. For another example, both the additional element and the magnetic circuit assembly are rigidly connected to the shell. For another example, the acoustic output device further includes a support member. The additional element is rigidly connected to the support member, and the support member is rigidly connected to the magnetic circuit assembly. In the acoustic output device disposed in the embodiments of the present disclosure, the additional element is connected to the magnetic circuit assembly, so as to prevent the additional element and the magnetic circuit assembly from being attracted to each other or repelled by each other, causing the magnetic circuit assembly to flip and deform and affect the vibration stability of the transducer.

In the acoustic output device disposed in the embodiment of the present disclosure, the additional element and the magnetic circuit assembly vibrate with respect to the panel to generate a resonance peak located within a target frequency range, which ensures that the sensitivity of the acoustic output device is not affected by the additional element in a range greater than the frequency corresponding to the resonance peak, so as to ensure that the sensitivity of the acoustic output device with the additional element is not affected by the additional element in a frequency range greater than the resonant frequency, thereby avoiding the decrease of the sensitivity of the bone conduction acoustic output device due to the additional element disposed on the bone conduction speaker. In addition, the acoustic output device provided in the embodiments of the present disclosure has a flatter frequency response curve in a frequency range greater than the resonant frequency corresponding to the resonance peak, which ensures that the acoustic output device has a better acoustic output effect, thereby improving the listening experience of the user. Further, when the transducer generates a low frequency (a frequency range below the resonant frequency corresponding to the resonance peak) mechanical vibration, the low frequency vibration of the panel (the vibration in a frequency range below the resonant frequency corresponding to the resonance peak) is transmitted to the additional element to drive the additional element to vibrate together, and the mass of the additional element increases the mass of a vibration load of the transducer, which affects the sensitivity of acoustic output device in the frequency range below the resonant frequency corresponding to the resonance peak. When the transducer generates a high frequency (a range higher than the resonant frequency corresponding to the resonance peak) mechanical vibration, the high frequency vibration of the panel hardly vibrates the additional element due to the elastic connection (e.g., the presence of the vibration transmission sheet) between the additional element and the panel, and the elastic connection between the magnetic circuit assembly and the panel. The mass of the additional element has no effect on the vibration load mass of the transducer, thus ensuring that the sensitivity of the acoustic output device is not affected by the additional element in the frequency range above the resonant frequency corresponding to the resonance peak.

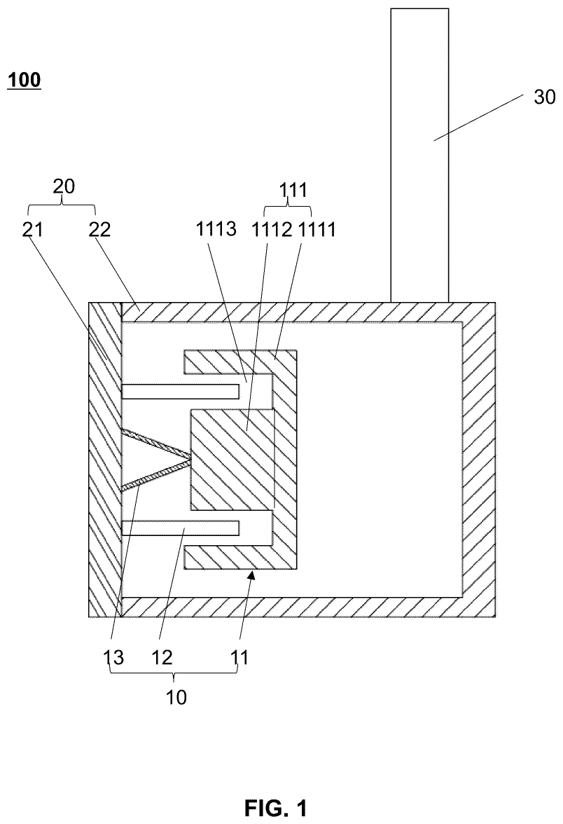

FIG. 1 is a schematic diagram illustrating a structure of an acoustic output device according to some embodiments of the present disclosure. As shown in FIG. 1, in some embodiments, an acoustic output device 100 includes a transducer 10 and a housing 20 for accommodating the transducer 10. In some embodiments, the housing 20 includes a panel 21 and a shell 22. The shell 22 is a structure that is internally hollow, and the panel 21 and the shell 22 form an accommodation cavity to accommodate the transducer 10. The transducer 10 is connected to the panel 21, and the transducer 10 transmits a mechanical vibration to a user through the panel 21. In some embodiments, the panel 21 and the shell 22 are an integrated structure. In some embodiments, the shell 22 is an integrated structure or a structure formed by connecting a plurality of components. For example, in some embodiments, the shell 22 includes an annular side panel and a back plate. The back plate is fixed to a side of the annular side panel opposite the panel 21 and form the shell 22. In some embodiments, the panel 21 and the shell 22 are also mutually independent structures. The shell 22 is a structural that is internally hollow and has an opening at one end. The panel 21 is rigidly connected to the end of the shell 22 that has the opening and covers the opening of the shell 22 to form the accommodation cavity for accommodating the transducer 10. In some embodiments, when a user wears the acoustic output device 100, the panel 21 fits against the head of the user, and then transmit the mechanical vibration to auditory nerves of the user through tissues and bones of the user, thereby enabling the user to hear bone conduction sounds. It is to be noted that the rigid connection in the present disclosure refers to a connection between two connecting members (e.g., the panel 21 and the shell 22), where when one of the connecting members is displaced or stressed, the other connecting member connected thereto is substantially free from displacement or relative deformation relative to the one of the connecting members, i.e., the two connecting members may be essentially considered as a whole during vibration. For example, the two connecting members are directly connected and an overall tensile strength (Pa) of the two connecting members is greater than 50% of the tensile strength of a base material of any one of the two connecting members. As another example, the two connecting members are connected through a rigid connecting element. The rigid connecting element itself has a tensile strength greater than the tensile strength of the base material of any one of the two connecting members. The rigid connection also refers that a high frequency vibration (e.g., the vibration greater than 6 KHz, greater than 8 KHz, or greater than 10 KHz) between the two connecting members is able to be efficiently transmitted between the two connecting members. In addition, the rigid connection also refers that a resonant frequency generated by the vibration transmitted between the two connecting members is located at a very high frequency position. For example, the resonant frequency generated by the vibration transmitted between the two connecting members is greater than 6000 Hz. As another example, the resonant frequency generated by the vibration transmitted between the two connecting members is greater than 8000 Hz. As a further example, the resonant frequency generated by the vibration transmitted between the two connecting members is greater than 10,000 Hz.

The transducer 10 may be used to convert an electrical signal into a mechanical vibration, and the mechanical vibration is then transmitted to the user through the panel 21. In some embodiments, the transducer 10 includes a magnetic circuit assembly 11, a coil 12, and a vibration transmission sheet 13 (also known as an elastic support member). In some embodiments, the magnetic circuit assembly 11 may include at least one magnet 111, and the magnet 111 may generate a magnetic field. In some embodiments, the magnet 111 includes a magnetic conductor 1111 and a magnetic member 1112. The magnetic conductor 1111 may be a structure with a concave groove, and the magnetic member 1112 may be disposed in the concave groove and fixedly connected to the magnetic conductor 1111. A sidewall of the magnetic conductor 1111 corresponding to the concave groove and a circumferential sidewall of the magnetic member 1112 form a magnetic gap 1113. In some embodiments, the magnetic conductor 1111 may be processed from a soft magnetic material. In some embodiments, the soft magnetic material includes a metal material, a metal alloy, a metal oxide material, an amorphous metallic material, etc., for example, an iron, an iron-silicon alloy, an iron-aluminum alloy, a nickel-iron alloy, an iron-cobalt alloy, a low carbon steel, a silicon steel sheet, a silicon steel sheet, a ferrite, etc. In some embodiments, the magnetic member 1112 refers to any element capable of generating the magnetic field. In some embodiments, the magnetic member 1112 includes a metal alloy magnet, a ferrite, etc. The metal alloy magnet may include a neodymium-iron-boron, samarium-cobalt, an aluminum-nickel-cobalt, a ferrochrome-cobalt, an aluminum-iron-boron, a ferrocarbon-aluminum, etc., or combinations of more than one thereof. The ferrite may include a barium ferrite, a steel ferrite, a manganese ferrite, a lithium-manganese ferrite, etc., or combinations of more than one thereof.

In some embodiments, the magnetic circuit assembly 11 is elastically connected to the housing 20 through the vibration transmission sheet 13. In some embodiments, the magnetic circuit assembly 11 is elastically connected to the panel 21 through the vibration transmission sheet 13. In some embodiments, the magnetic circuit assembly 11 and the shell 22 (e.g., a sidewall of the housing 20 adjacent or opposite to the panel 21) are elastically connected through the vibration transmission sheet 13. In some embodiments, the magnetic circuit assembly 11 is elastically connected to the panel 21 and the shell 22 by different vibration transmission sheets 13, respectively. For example, the vibration transmission sheet 13 includes a first vibration transmission sheet and a second vibration transmission sheet. The first vibration transmission sheet is disposed between the magnetic circuit assembly 11 and the panel 21, and the magnetic circuit assembly 11 and the panel 21 are elastically connected through the first vibration transmission sheet. The second vibration transmission sheet is disposed between the magnetic circuit assembly 11 and the sidewall of the shell 22 opposite to the panel 21. The magnetic circuit assembly 11 and the shell 22 are elastically connected by the second vibration transmission sheet. In some embodiments, at least a portion of the coil 12 is disposed in the magnetic circuit assembly 11. For example, in some embodiments, one end of the coil 12 is connected to the panel 21, and the other end of the coil 12 extends into the magnetic gap 1113 of the magnetic circuit assembly 11. When the transducer 10 is operating, the coil 12 is energized with a signal current. The coil 12 is in the magnetic field generated by the magnet 111, and is subjected to an amperometric force to generate the mechanical vibration, so as to drive the panel 21 and the shell 22 to perform the mechanical vibration, and at the same time, the magnetic circuit assembly 11 is subjected to a reaction force opposite to the force subjected by the coil. It should be noted that the “elastic connection” referred in the present disclosure refers that as two connecting members are elastically connected, when one of the connecting members is displaced or subjected to a force, the other connecting member has the ability to generate displacement or deformation relative to the connecting member; or the two connecting members are connected through a component with elasticity. In addition, the elastic connection may also refer that the overall structure formed by the joining of the two connecting members has a specific resonant frequency that is less than a target threshold. In some embodiments, the target threshold may be 400 Hz, 600 Hz, 800 Hz, 1500 Hz, 2000 Hz, or any other value.

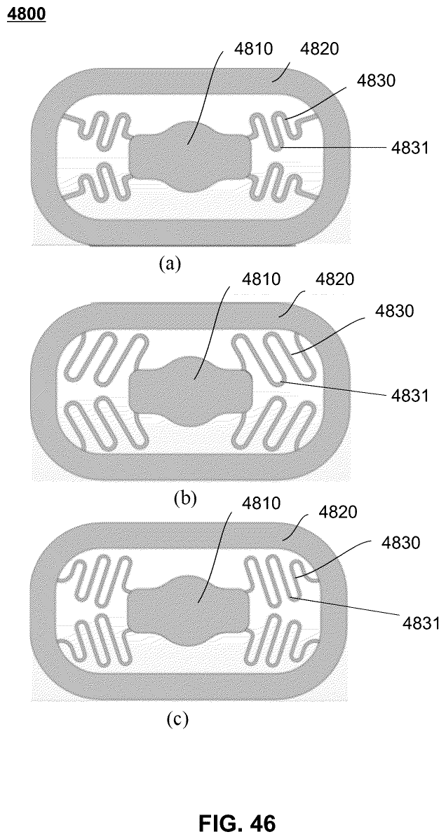

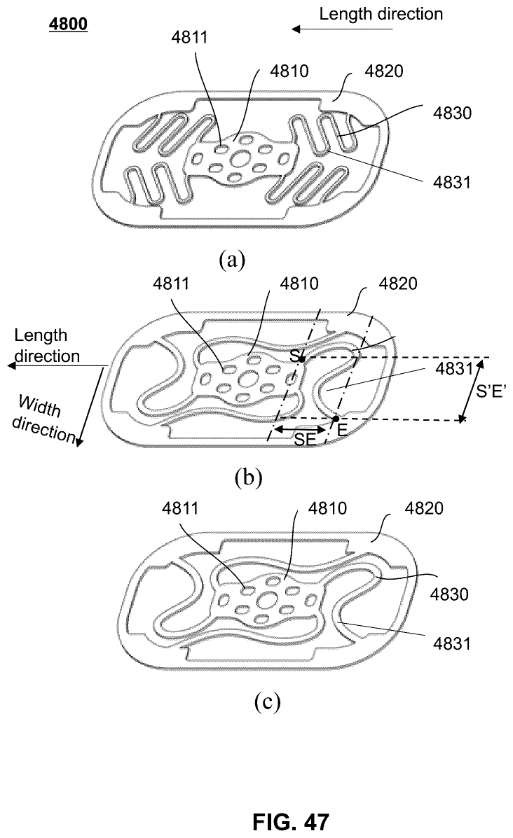

More descriptions of the vibration transmission sheet 13 may be found elsewhere in the present disclosure (e.g., FIG. 46 and FIG. 47 and their related descriptions).

It should be noted that an energy conversion manner in the transducer 10 in the embodiments of the present disclosure may be the moving coil type described above, and may also be an electrostatic type, a piezoelectric type, a moving iron type, a pneumatic type, an electromagnetic type, etc. The acoustic output device (e.g., the acoustic output device 100) disposed in the embodiments of the present disclosure may be any one of a speaker, a headset, a hearing aid, eyeglasses, an augmented reality (AR) device, a virtual reality (VR) device, or a helmet, etc. Further, the above-described elements of the transducer 10, the panel 21, the shell 22, the magnetic circuit assembly 11, the coil 12, the vibration transmission sheet 13, etc., may be regarded as the acoustic output units (also referred to as the bone conduction speakers) of the acoustic output device 100 to provide sound.

In some embodiments, the acoustic output device 100 also includes a support structure 30 configured to wear the bone conduction speaker of the acoustic output device 100 on the ear or a head region of the user (e.g., a mastoid process, a temporal bone, a parietal bone, a frontal bone, etc., on the head, or on left and right sides of the head and on a sagittal axis of the human body at a position in the front side of the ear of the user) without blocking an ear canal of the user. In some embodiments, the support structure 30 is connected to the housing 20 (e.g., the panel 21 or the shell 22). In some embodiments, the support structure 30 is also disposed as an ear-hook or a rear-hanging structure to wrap around a back side of the head. In some embodiments, the support structure 30 is disposed as a headband structure and wound around the top of the head of the user. In some embodiments, the support structure 30 is a structure with a shape adapted to a human ear, such as circular, oval, polygonal (regular or irregular), U-shaped, V-shaped, or semi-circular, so that the support structure 30 is able to be directly hooked up at the ear of the user.

It should be noted that in practice, the user may wear two bone conduction speakers at the same time (i.e., one on the left ear and one on the right ear) so that the user can hear a stereo sound. In some application scenarios where a stereo sound requirement is not very high (e.g., the hearing aids for hearing patients, live teleprompters for presenters, etc.), the user may also wear only one bone conduction speaker.

In some embodiments, when the user wears two bone conduction speakers at the same time, the support structure 30 includes a rear-hanging assembly and two ear-hook assemblies. Two ends of the rear-hanging assembly are connected to one end of a corresponding ear-hook assembly, respectively. The other end of each ear-hook assembly departs from the rear-hanging assembly and is connected to a corresponding bone conduction speaker, respectively. Furthermore, the rear-hanging assembly may be disposed in a curved shape for wrapping around the back side of the head of the user, and the ear-hook assemblies may be disposed in curved shapes for hanging between the ear and the head of the user, thereby facilitating the realization of a requirement of wearing two bone conduction speakers at the same time. In this way, the two bone conduction speakers are located on the left side and the right side of the head of the user, respectively, and the two bone conduction speakers are also fitted to the ear or a head region (e.g., a facial area on the front side of the ear) of the user by a cooperating action of the support structure 30. The user is also able to hear the sound output from the two bone conduction speakers.

The acoustic output device usually requires some additional elements to be disposed (e.g., microphones, transducers, air conduction speakers, etc.) to the bone conduction speaker to fulfill more functional requirements. For example, a microphone is disposed on the bone conduction speaker for collecting a user voice. For another example, a sensor (e.g., a temperature sensor, a humidity sensor, a speed sensor, a displacement sensor, etc.) is disposed on the bone conduction speaker for collecting user information (e.g., a health status, an exercise condition, etc., of the user) or environmental information, etc. For a further example, an air conduction speaker can be disposed on the basis of the bone conduction speaker to make a bone-air conduction speaker for outputting bone conduction and/or air conduction sound to the user to ensure that the user has a better hearing experience. In addition, internal elements of the acoustic output device (e.g., batteries, circuit boards, etc.) may also be integrated into the bone conduction speaker. These internal elements of the acoustic output device and the additional components described above may be considered as additional components of the bone conduction speaker, which can directly be integrated into the housing of the bone conduction speaker or fitted to the magnetic circuit assembly 11.

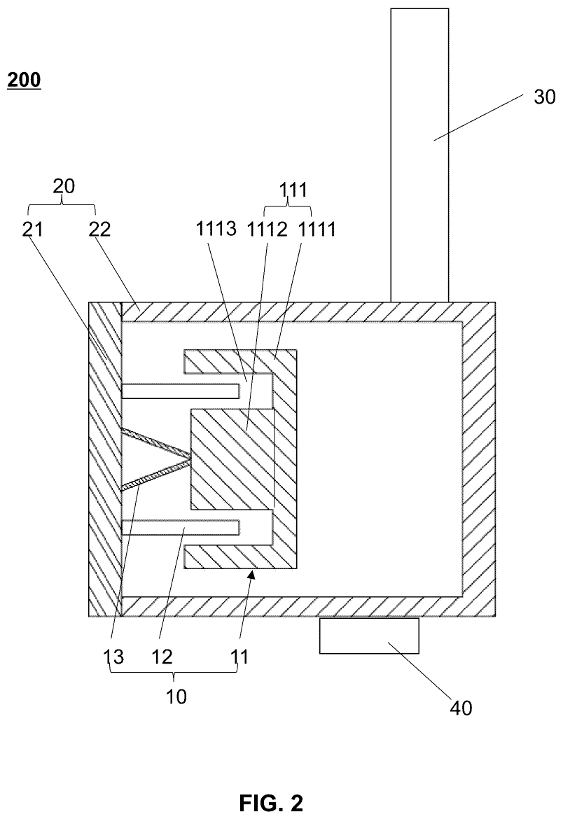

FIG. 2 is a schematic diagram illustrating a structure of an acoustic output device according to some embodiments of the present disclosure. As shown in FIG. 2, an acoustic output device 200 is obtained by providing an additional element 40 to the acoustic output device 100. In some embodiments, the additional element 40 is rigidly connected to the shell 22. The additional element 40 is directly rigidly connected to the shell 22, causing a load mass of vibration of the structure (the panel 21, the shell 22, the additional element 40) driven by the transducer 10 to increase relative to a load mass without the additional element 40, which in turn causes a decrease of the sensitivity of the acoustic output device 200, resulting in a decrease in a volume of a bone conduction sound output by the acoustic output device 200.

An effect of the additional element on a speaker (a bone conduction speaker) is specified below combining frequency response curves of the acoustic output device 100 and the acoustic output device 200. It should be noted that in the present disclosure, the additional element 40 may be disposed inside the accommodation cavity formed by the panel 21 and the shell 22, or may be fixed outside the accommodation cavity, e.g., the additional element 40 may be disposed on an outer surface of the shell 22.

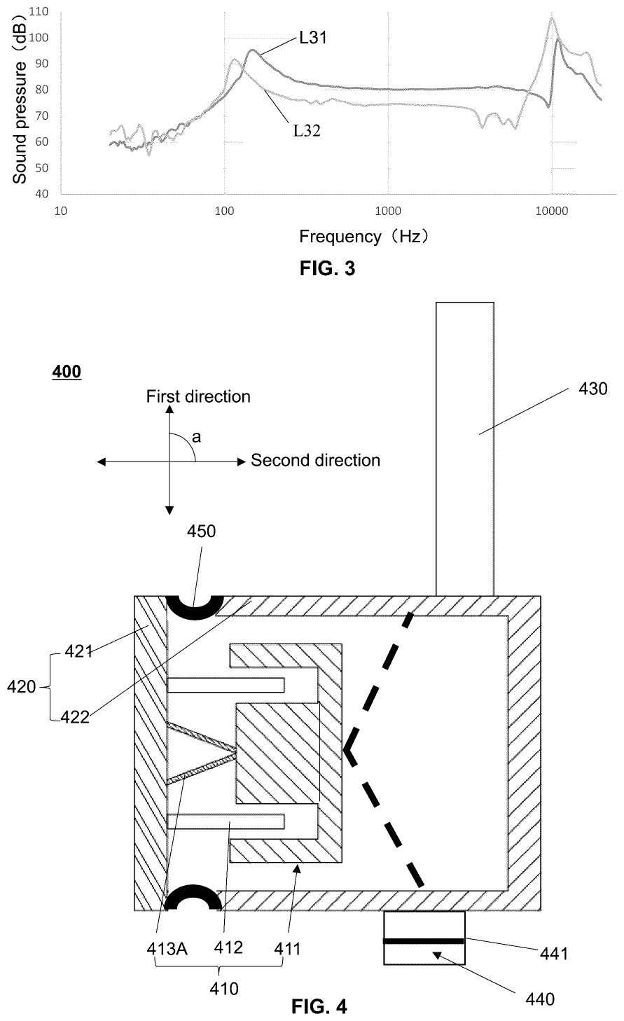

FIG. 3 is a curve diagram illustrating frequency response curves of acoustic output devices according to some embodiments of the present disclosure. As shown in FIG. 3, a horizontal coordinate indicates frequency (Hz), and a vertical coordinate indicates sound pressure (dB) of an acoustic output device at different frequencies. Curve L31 indicates a frequency response curve of the acoustic output device 100, and curve L32 indicates a frequency response curve of the acoustic output device 200. The vibration of the panel 21 also drives air on a side of the panel 21 to vibrate to generate an air conduction sound. To facilitate the measurement of the frequency response curves of the acoustic output device 100 and the acoustic output device 200, in the embodiments of the present disclosure, a vibration force level of the bone conduction sound of the acoustic output device is indicated by measuring a sound pressure level of the air conduction sound near the panel 21. Merely by way of example, a sound sensor (e.g., a microphone) is disposed proximate to the panel 21 to detect the sound pressure level of the air conduction sound generated by the vibration of the air on the side of the panel 21 driven by the vibration of the panel 21. It is appreciated that when there are no special instructions, the determination of a frequency response curve of an acoustic output device covered in the present disclosure may all be accomplished by using the manner described above.

Referring to the frequency response curves L31 and L32, it can be seen that, in a frequency range of 20 Hz to 8,000 Hz, the sound pressure of the acoustic output device 200 is generally smaller than the sound pressure of the acoustic output device 100, that is, the sensitivity of the acoustic output device 200 is lower than the sensitivity of the acoustic output device 100. It can be seen that when the additional element is additionally disposed on the bone conduction speaker in the acoustic output device, the additional element affects the sensitivity of the bone conduction speaker, which is specifically manifested as a decrease in the sensitivity of the bone conduction speaker. This is because a fact that the additional element 40 has a certain mass, which increases the vibration load mass of the transducer 10. The vibration load mass of the transducer 10 increases (at this time, the vibration load mass of the transducer 10 at least includes the mass of the panel 21, the shell 22, and the additional element 40), the sensitivity of the bone conduction speaker decreases, resulting in a lower volume of the sound (the bone conduction sound) output by the acoustic output device 200.

Based on the above-described problem that the sensitivity of the bone conduction speaker of the acoustic output device 200 decreases when an additional element is disposed, embodiments of the present disclosure provide an acoustic output device. In some embodiments, the additional element and the panel are connected by a vibration path including at least one elastic element. In the speaker disposed in some embodiments of the present disclosure, the panel, the elastic element, the shell, and the additional element form a resonant system. The resonant system is able to be located at a second resonant position and generate, at the second resonant position, a second resonant frequency that lies within a target frequency range. In the frequency range after the second resonant frequency, the vibration transmitted between the additional element and the panel is suppressed, which means that the effect of the additional element on the vibration of the panel is reduced, thereby ensuring the sensitivity is not affected or less affected by the additional element in a frequency range greater than the second resonant frequency. In some embodiments, by setting the second resonant frequency at a lower frequency position, it is possible to reduce a frequency range where the sensitivity of the bone conduction speaker decreases due to the additional placement of the additional element on the bone conduction speaker. In addition, in the frequency range greater than the second resonant frequency, the frequency response curve of the acoustic output device is flatter due to the smaller effect of the additional element on the vibration of the panel, which ensures that the acoustic output device has a better acoustic output effect in a wider frequency range, thereby improving the listening experience of a user. In some embodiments, the second resonant frequency described above is generated when the panel and the additional element vibrate in opposite directions and a distance between them reaches the maximum value. When the transducer generates a low frequency (below the second resonant frequency) mechanical vibration, the low frequency mechanical vibration of the panel (vibration below the second resonant frequency) is transmitted to the additional element to drive the additional element to vibrate together. The mass of the additional element increases the vibration load mass of the transducer, which makes the sensitivity of the speaker to be affected by the additional element below the second resonant frequency (similar to the acoustic output device 200). However, the transducer generates a high-frequency (higher than the second resonant frequency) mechanical vibration, the high-frequency mechanical vibration of the panel hardly drives the additional element to vibrate together due to the presence of the elastic element. The mass of the additional element does not have an effect on the vibration load mass of the transducer, thus ensuring that the sensitivity of the acoustic output device is not affected or less affected, by the additional element in the frequency range higher than the second resonant frequency.

In some specific application scenarios, as the additional element may have magnetic components (e.g., components made of magnetic materials such as metal alloy magnets, ferrite, etc., and energized coils, etc.) or magnetically conductive components (e.g., components made of soft magnetic materials such as an iron, nickel-iron alloys, etc.), which are attracted or repelled by the magnetic circuit assembly in the transducer of the acoustic output device, resulting in a flip deformation of the magnetic circuit assembly of the transducer, thereby affecting the stability of vibration of the transducer, and resulting in a poor acoustic output effect of the acoustic output device.

Based on the fact that the additional element and the magnetic circuit assembly in the transducer may be attracted or repelled to each other and cause the magnetic circuit assembly to undergo the flip deformation, when the additional element is disposed at a sidewall of the shell adjacent to the panel, in some embodiments, a vibration transmission sheet (also known as an elastic support member) in the transducer may connect the magnetic circuit assembly to the sidewall of the shell adjacent to the panel, that is, the vibration transmission sheet connects the magnetic circuit assembly and the sidewall of the shell where the additional element is disposed. In some embodiments, the transducer includes at least two vibration transmission sheets. One of the vibration transmission sheets is disposed on a side of the transducer facing the panel to elastically connect the transducer to the panel, and the other vibration transmission sheet is disposed on the side of the transducer depart from the panel to connect the transducer to the shell and support the transducer to ensure that the transducer is able to vibrate stably in an axial direction. Moreover, the vibration transmission sheet disposed on the side of the transducer depart from the panel is capable of connecting the magnetic circuit assembly and the sidewall of the shell with the additional element, so as to reduce or avoid a possibility for a mutual attraction or a mutual repel between the additional element and the magnetic circuit assembly in the transducer, which cause the magnetic circuit assembly to flip deform. In some embodiments, when the additional element is rigidly connected to the support member, the vibration transmission sheet of the transducer connects the magnetic circuit assembly to the support member. At this time, the vibration transmission sheet provides support in a relative movement direction between the magnetic circuit assembly and the additional element, so that the vibration transmission sheet provides better support to the magnetic circuit assembly and stability between the magnetic circuit assembly and the shell is improved. Thus, the situation where the additional element and the magnetic circuit assembly in the transducer attract or repel each other and cause the magnetic circuit assembly to flip and deform, so as to ensure that the vibration of the transducer is more stable. To improve the support effect of the vibration transmission sheet on the magnetic circuit assembly, in some embodiments, an end of the vibration transmission sheet connected to the sidewall of the shell is located, at least partially, in an orthographic projection of the additional element on the sidewall of the shell. For example, at least one support rod of the vibration transmission sheet is disposed within the orthographic projection of the additional element on the sidewall of the shell. In some embodiments, the vibration transmission sheet includes a center region and a plurality of support rods, and the plurality of support rods are spaced apart along a circumferential side of the center region. The center region of the vibration transmission sheet is connected to the side of the magnetic circuit assembly away from the panel, and an end of a support rod away from the center region is connected to the shell. In some embodiments, the vibration transmission sheet is connected to the side of the magnetic circuit assembly departs from the panel and is connected to an intermediate region of the side of the magnetic circuit assembly departs from the panel. The intermediate region refers to a geometric center region of a side of the magnetic circuit assembly departs from the panel. Preferably, the center region of the vibration transmission sheet is connected to the intermediate region of the side of the magnetic circuit assembly departs from the panel. Merely as an example, there are 4 support rods. At this time, a structure of the vibration transmission sheet is approximated as an “X”-shaped structure. The “X”-shaped structure provides an elasticity in a vibration direction of the transducer. In addition, the plurality of support rods have a higher structural strength in a direction perpendicular to the vibration direction of the transducer, which provides a high support effect for the magnetic circuit assembly to ensure that the transducer undergoes the flip deformation during the vibration thereof. In some embodiments, the vibration transmission sheet further includes an edge region. The edge region is connected to an end of the support rod away from the center region, and a circumferential side of the edge region is connected to the shell. For a specific structure of the vibration transmission sheet, reference may be made elsewhere in the present disclosure, for example, to FIG. 46 and FIG. 47 and their related descriptions.

The acoustic output device disposed by the embodiments of the present disclosure is described in detail below in conjunction with the accompanying drawings (FIG. 4-FIG. 32).

FIG. 4 is a schematic diagram illustrating a structure of an acoustic output device according to some embodiments of the present disclosure. As shown in FIG. 4, structures like a transducer 410 (including a magnetic circuit assembly 411, a coil 412, and a vibration transmission sheet 413A), a housing 420 (including a panel 421 and a shell 422), a support structure 430, etc., in an acoustic output device 400 are similar to the structures like the transducer 10 (including the magnetic circuit assembly 11, the coil 12, the vibration transmission sheet 13), the housing 20 (including the panel 21, the shell 22), and the support structure 30, etc., in the acoustic output device 200 shown in FIG. 2, which are not repeated here. A main difference between the acoustic output device 400 shown in FIG. 4 and the acoustic output device 200 shown in FIG. 2 is that an additional element 440 is connected to the panel 421 through a vibration path including an elastic element 450. That is to say, the panel 421 is elastically connected to the shell 422 through the elastic element 450, i.e., the panel 421 with the structures rigidly connected to the panel 421 (e.g., the coil 412), the elastic element 450, the shell 422 with the structures rigidly connected to shell 422 (e.g., the additional element 400, the support structure 430) form a resonant system. It should be noted that when there are other structures rigidly connected to the panel 421 or to the shell 422, these structures are also considered to be a portion of the resonant system. Here, the additional element 440 being rigidly connected to the shell 422 and the panel 421 being elastically connected to the shell 422 with the additional element 440 through the elastic element 450 are taken as examples for illustration. In a lower frequency band (e.g., a frequency range less than 20 Hz), the panel 421 and the shell 422 are approximated to be rigidly connected to each other, and the transducer 10 drives the panel 421 to vibrate, and the panel 421 drives the shell 422 with the additional element 440 to vibrate through the elastic element 45. Due to the additional element 440 has a certain mass, the sensitivity of the acoustic output device with the additional element 440 is relatively low. In a higher frequency band (e.g., a frequency range greater than 20 Hz), the panel 421, the elastic element 450, and the shell 422 may be approximated as a resonant system in which the transducer drives the panel 421 to vibrate, and with an action of the elastic element 450, a relative movement occurs among the panel 421, the shell 422, and parts rigidly connected to the shell 422 (e.g., the additional element 440). Specifically, the vibration of the panel 421 is at a minimum value (e.g., the panel 421 vibrates very little or not at all), and the shell 422 and the additional element 440 undergo a stronger vibration, which can be regarded as a first resonant position of the resonant system. A resonant frequency corresponding to the resonant system being at the first resonant position is a first resonant frequency. In some embodiments of the resonant system, a frequency response curve of the acoustic output device 400 has a resonance valley at the first resonant frequency. It may be appreciated that in some other embodiments of the resonant system, the frequency response curve of the acoustic output device 400 does not have a significant resonance valley at the first resonant frequency. As a vibration frequency of the resonant system is further increased, the panel 421 and the shell 422 and the additional element 440 rigidly connected to the shell 422 undergo a strong vibration until the panel 421 and the shell 422 (and the additional element 440) vibrate in opposite directions and a distance between the two reaches a maximum value, which is regarded as a second resonant position of the resonant system. A resonant frequency corresponding to the resonant system being at the second resonant position is a second resonant frequency. In some embodiments of the resonant system, the frequency response curve of the acoustic output device 400 has a resonance peak at the second resonant frequency. It is appreciated that in some other embodiments of the resonant system, the frequency response curve of the acoustic output device 400 does not have a significant resonance peak at the second resonant frequency. When a frequency is greater than the second resonant frequency, the panel 421 and the shell 422 (and the additional element 440) vibrate in the opposite directions. At this time, a vibration transmission between the shell 422 with the additional element 440, and the panel 421 can be suppressed, i.e., an effect of the shell 422 with the additional element 440 on the vibration of the panel 421 is reduced.

From a viewpoint of a phase of the resonant system, the panel 421 and the shell 422 first move together. At this time, the panel 421 vibrates together with the shell 422 and the additional element 440 connected to the shell 422, at which time, a phase difference between the panel 421 and the shell 422 is 0°. With an increase of the frequency, the panel 421, the shell 422, and the additional element 440 first move in the same direction until the vibration of the panel 421 is very small or does not vibrate, and a stronger vibration occurs in the shell 422 and the additional element 440, i.e., at the first resonant position described above. As the frequency continues to increase, a value corresponding to the phase of the resonant system increases, the panel 421 and the shell 422 with the additional element 440 rigidly connected to the shell 422 vibrate strongly until the panel 421 and the shell 422 (and the additional element 440) vibrate in the opposite directions, and the distance between the two reaches the maximum value, that is, at the second resonant position described above. At this time, the phase difference between the panel 421 and the shell 422 is in a range of 150°-210°, and the resonant system is at the second resonant position. Then, as the frequency continues to increase, the value corresponding to the phase of the resonant system decreases. In the acoustic output device disposed by the embodiments of the present disclosure, the panel 421 and the shell 422 with the additional element 440 are connected through the elastic element 450, which makes the panel 421 and the shell 422 with the additional element 440 resonate, and generate the second resonant frequency that lies within a target frequency range. In a frequency range greater than the second resonant frequency, the vibration transmitted between the additional element 440 and the panel 421 is suppressed, that is, the effect of the additional element 440 on the vibration of the panel 421 is reduced, so as to ensure that the sensitivity of the bone conduction speaker in the acoustic output device is not or less affected by the additional element 440 in a frequency range greater than the resonant frequency corresponding to the second resonant frequency. In some embodiments, by setting the second resonant frequency at a lower frequency position, the frequency range where the sensitivity of the bone conduction speaker in the acoustic output device decreases due to the additional element 440 disposed on the acoustic output device can be reduced. In addition, in a frequency range greater than the second resonant frequency, a frequency response curve of the acoustic output device is flatter due to the smaller effect of the additional element 440 on the vibration of the panel 421, which ensures that the acoustic output device has a better acoustic output effect in a greater frequency range, so as to improve the listening experience of the user.

It may be appreciated that if there are other structures rigidly connected to the panel 421, or if there are other structures rigidly connected to the shell 422, for example, the panel 421 and the structures rigidly connected to the panel 421, the elastic element 450, and the shell 422 with the structure rigidly connected to the shell 422 form the resonant system.

As shown in FIG. 4, in some embodiments, the shell 422 is a structure that is internally hollow and has an opening at one end, and the panel 421 is disposed at the end of the shell 422 with the opening.

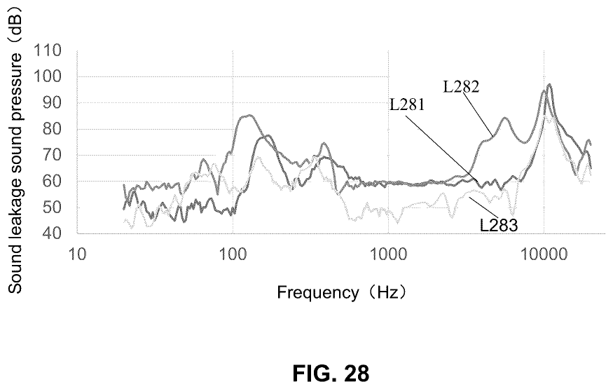

The elastic element 450 is disposed between the panel 421 and the shell 422 to realize an elastic connection between the panel 421 and the shell 422. The elastic element 450 may also be considered as a portion of the housing 420 in the acoustic output device 400. The panel 421, the shell 422, and the elastic element 450 form an accommodation cavity that accommodates the transducer 10. In some embodiments, the elastic element 450 is a ring structure with elasticity, and the panel 421 is elastically connected to the shell 422 through the ring structure and form the accommodation cavity that accommodates the transducer 410. In some embodiments, the elastic element 450 is a ring structure made of an elastic material such as a silicone, a polyurethane, etc. In some embodiments, the ring structure is a single ring structure with a pre-deformation capability or a structure with a plurality of folded rings. When the panel 421 is connected to the shell 422 through the ring structure, the ring with the pre-deformation capability plays a certain supporting role for the panel 421 and the shell 422, thereby improving a structural stability of the acoustic output device. In some embodiments, the panel 421 and the shell 422 are elastically connected by gluing. A glue used to bond the panel 421 and the shell 422 has a certain degree of elasticity and is regarded as the elastic element 450. In some embodiments, the glue used to bond the panel 421 with the shell 422 includes, but is not limited to, a gel type, an organosilicon type, an acrylic type, a polyurethane type, a rubber type, an epoxy type, a hot melt type, a light curing type, etc., and preferably the glue is a silicone bonding type glue, or a silicone sealing type glue. In some embodiments, the additional element 440 is directly or indirectly rigidly connected to the shell 422. For example, in some embodiments, the additional element 440 is rigidly connected to a sidewall of the shell 422 (e.g., the sidewall of the shell 422 adjacent to the panel 421 or the sidewall of the shell 422 opposite to the panel 421) by welding, snap-fitting, threading, adhesive connection, etc. For another example, the additional element 440 is rigidly connected to the shell 422 through a connector such as a bracket, a connection rod, etc. In some embodiments, the additional element 440 shown in FIG. 4 includes an element that is sensitive to a vibration direction (e.g., a speaker, an air conduction microphone, or an accelerometer). In the embodiment shown in FIG. 4, the additional element 440 is an air conduction microphone that is sensitive to the vibration direction, and a vibration direction of a diaphragm 441 of the air conduction microphone (the “second direction” shown in FIG. 4) is approximately perpendicular to the vibration direction of the transducer 410 (the “first direction” shown in FIG. 4). As used herein, the approximately perpendicular is understood as the vibration direction of the transducer forming an angle of 75° to 100°, for example, 80°, 90°, or 95°, etc., with the vibration direction of the diaphragm in the air conduction speaker. The diaphragm of the air conduction speaker generates vibration when the air conduction speaker operates, and when the vibration direction of the transducer is approximately perpendicular to the vibration direction of the diaphragm in the air conduction speaker, there is almost no superposition effect between the vibration generated by the diaphragm and the vibration generated by the transducer. That is, the diaphragm generates vibration, and when the vibration direction of the transducer is approximately perpendicular to the vibration direction of the diaphragm in the air conduction speaker, a sound leakage volume generated by the acoustic output device is low, thereby enabling the acoustic output device to have a better sound leakage reduction effect when disposed with a component that is sensitive to the vibration direction. Specifics about the additional element being an element sensitive to the vibration direction may be found elsewhere in the present disclosure, such as FIG. 4 and FIG. 28. It should be noted that the additional element 440 is not limited to the element sensitive to the vibration direction shown in FIG. 4, but also is a battery, a circuit board, or a sensor that is not sensitive to the vibration direction (e.g., a temperature sensor, a humidity sensor, etc.), at which point the additional element is located at an arbitrary position on the shell 422. In some embodiments, the additional element 440 includes both an element that is sensitive to the vibration direction and an element that is insensitive to the vibration direction. For example, the element that is sensitive to the vibration direction is an accelerometer, and the element that is insensitive to the vibration direction is a circuit board. The circuit board is fixedly connected to the shell 422, and the accelerometer is disposed on the circuit board.

The panel 421 with the structure rigidly connected to the panel 421 (e.g., the coil 412) and the shell 422 with the structure rigidly connected to the shell 422 (e.g., the additional element 440) are elastically connected to each other through the elastic element 450, which are approximated as a resonant system. In some embodiments, the resonant system is capable of being at a second resonant position, and generating a second resonant frequency with a resonant frequency located within a target frequency range. In a frequency range after the resonant frequency corresponding to the second resonant frequency, the vibration transmitted between the additional element 440 and the panel 421 is suppressed, which means that the effect of the additional element 440 on the vibration of the panel 421 is reduced, thereby ensuring that the sensitivity is not affected or less affected by the additional element 440 in a frequency range that is greater than the resonant frequency corresponding to the second resonant frequency. In some embodiments, by disposing the resonant frequency corresponding to the second resonant frequency at a lower frequency position, the frequency range at which the sensitivity of the acoustic output device 400 is decreased due to the additional element 440 can be reduced. Additionally, in the frequency range greater than the resonant frequency corresponding to the second resonant frequency, a frequency response curve of the acoustic output device 400 is flatter due to a smaller effect of the additional element 440 on the vibration of the panel 421, which ensures that the acoustic output device 400 has a better acoustic output effect in a wider frequency range, thereby improving a listening experience of a user. To reduce the frequency range where the additional element 440 has the effect on the acoustic output device 400, as well as to enable the acoustic output device 400 to have a flat frequency response curve in a wider frequency band, in some embodiments, a ratio of a sum of the masses of the panel 421 and the element rigidly connected to the panel 421 to a sum of the masses of the shell 422 and the element fixedly connected to the shell 422, an elastic coefficient of the elastic element 450, etc., may be adjusted, so that the resonant frequency corresponding to the second resonant frequency lies within a specific low frequency range (also referred to as a target frequency range). In some embodiments, the target frequency range may be 20 Hz-800 Hz. Preferably, the target frequency range may be 100 Hz-600 Hz. Further preferably, the target frequency range may be 150 Hz-500 Hz. Further preferably, the target frequency range may be 200 Hz-400 Hz. Specifics on adjusting the resonant frequency can be found in FIG. 6 and its related descriptions.

In the resonant system formed by the panel 421 with a structure rigidly connected to the panel 421 (e.g., the coil 412) and the shell 422 with the additional element 440 and the structure rigidly connected to the shell 422 (e.g., the additional element 440) that are elastically connected through the elastic element 450, when the panel 421 does not vibrate substantially, the shell 422 continues to vibrate, at which point the acoustic output device 400 also generates a first resonant frequency whose resonant frequency lies in the target frequency range. In some embodiments, the first resonant frequency may be less than the second resonant frequency. Furthermore, the closer the corresponding frequencies of the first resonant frequency and the second resonant frequency are to each other, the less the effect on flatness of the frequency response curve of the acoustic output device 400 in an overall frequency band, and accordingly, the better the sound quality of the acoustic output device 400 in the overall frequency band. To make the frequency response curve of the acoustic output device 400 in the overall frequency band flatter, in some embodiments, a frequency difference between the frequency corresponding to the second resonant frequency and the frequency corresponding to the first resonant frequency is no greater than 300 Hz. Preferably, the frequency difference between the frequency corresponding to the second resonant frequency and the frequency corresponding to the first resonant frequency may be no greater than 200 Hz. Further preferably, the frequency difference between the frequency corresponding to the second resonant frequency and the frequency corresponding to the first resonant frequency may be no greater than 100 Hz.

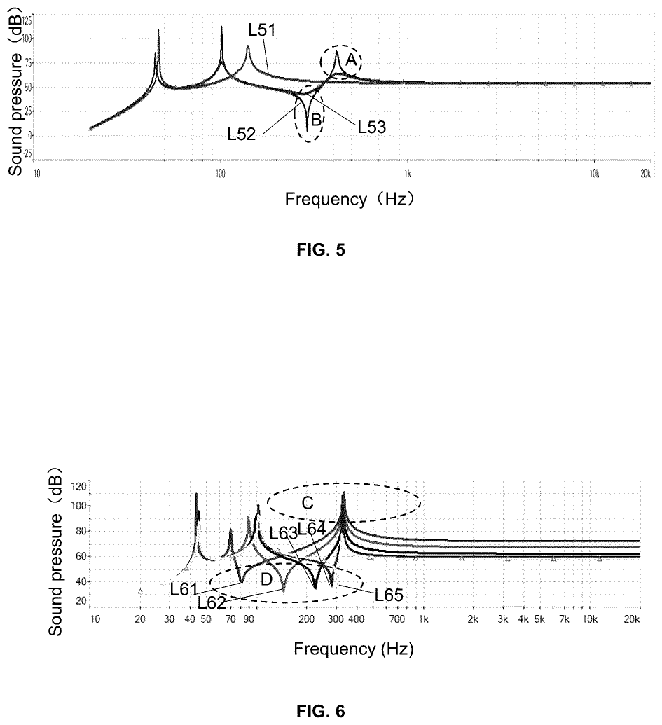

FIG. 5 is a curve diagram illustrating frequency response curves of acoustic output devices according to some embodiments of the present disclosure. FIG. 5 shows frequency response curves of the acoustic output device 100 and the acoustic output device 400. A horizontal coordinate indicates frequency (Hz), and a vertical coordinate indicates sound pressure (dB) corresponding to a speaker at different frequencies. Curve L51 is the frequency response curve of the acoustic output device 100, curve L52 is the frequency response curve of the acoustic output device 400, and curve L53 is the frequency response curve of the acoustic output device 400 after addition of damping. In the embodiment shown in FIG. 5, the frequency response curve of the acoustic output device 400 has a resonance valley at a first resonant frequency, and the frequency response curve of the acoustic output device 400 has a resonance peak at a second resonant frequency. It should be noted that in the present disclosure, for the convenience of description, only a solution where the frequency response curve of the acoustic output device has a significant resonance valley at the first resonant frequency, and a significant resonance peak at the second resonant frequency is described by way of example. It is appreciated that the frequency response curve of the acoustic output device in the present disclosure may also have no significant resonance valley at the first resonant frequency, and no significant resonance peak at the second resonant frequency. The resonance peak in region A is generated by the resonant system when a distance between the panel 421 and the shell 422 is at a maximum value, and the resonance valley in region B is generated by the resonant system when the panel 421 does not vibrate or when the vibration of the panel 421 is at a minimum value. According to curve L52, the acoustic output device 400 generates the resonance peak and the resonance valley in a frequency range of 200 Hz-600 Hz. The resonance peak is generated by the panel 421 and the additional element 440 vibrating in opposite directions, and the distance between the panel 421 and the additional element 440 reaches the maximum value. The resonance valley is generated when the panel 421 does not vibrate or when the vibration of the panel 421 is at the minimum value, and the shell 422 vibrates. Referring again to FIG. 3, in a frequency range of 200 Hz-8000 Hz, the sensitivity of the acoustic output device 100 without the additional element in FIG. 3 is generally greater than the sensitivity of the acoustic output device 200 with the additional element. In FIG. 5, referring to the curves L51, L52, and L53, the frequency response curves of the acoustic output device 400 and the acoustic output device 100 approximately overlap in a frequency range greater than the resonant frequency. As can be seen, the acoustic output device 400 (the additional element 440 is connected to the panel 421 through a vibration path including the elastic element 450) has a higher sensitivity in a specific frequency band (e.g., a frequency range greater than the resonant frequency corresponding to the resonance peak A) as compared to the acoustic output device 200 shown in FIG. 2 (the panel 21 is rigidly connected to the shell 22 with the additional element 40). Further, referring to the curves L51, L52, and L53, the curves L152, L153 and L151 substantially overlap and are relatively flat in the frequency range greater than the resonant frequency corresponding to the resonance peak. As can be seen, the frequency response curve of the acoustic output device 400 is flatter when the frequency is greater than the resonant frequency corresponding to the resonance peak, and the additional element 440 in the acoustic output device 400 (e.g., air conduction speakers, transducers, batteries, circuit boards, etc.) does not affect the sensitivity of the speaker 400 in the frequency range higher than the resonant frequency corresponding to the resonance peak. To enable the acoustic output device 400 to have a flat frequency response curve in a wider frequency band, in some embodiments, the resonant frequency corresponding to the resonance peak is made to lie within a specific frequency range (e.g., less than 2000 Hz, less than 1500 Hz, less than 800 Hz, less than 600 Hz). Specifics on adjusting the resonant frequency are found in FIG. 6 and the related descriptions.

In some embodiments, as can be seen from the curve L53, the steepness of the resonance peak and resonance valley decreases and becomes flatter when a damping is added to the acoustic output device 400, which allows the acoustic output device 400 to have a flatter frequency response curve in a wider frequency range, so as to enable the acoustic output device 400 to output a better sound quality in the wider frequency range. In some embodiments, a damping material is disposed in the elastic element 450 to increase the damping of the acoustic output device 400. In some embodiments, the damping material may include butyl, acrylate, polysulfide, nitrile, and silicone rubbers, urethanes, PVC, and epoxies, etc., or combinations thereof.

FIG. 6 is a curve diagram illustrating frequency response curves of acoustic output devices according to some embodiments of the present disclosure. FIG. 6 shows the frequency response curve of the acoustic output device 400 corresponding to when a mass of the panel 421 has different ratios to a sum of the masses of the shell 422 and the additional element 440. A horizontal coordinate indicates frequency (Hz), a vertical coordinate indicates sound pressure (dB) corresponding to a speaker at different frequencies. Curve L61 indicates the frequency response curve of the acoustic output device 400 when a ratio of the sum of the masses of the panel 421 and the element rigidly connected to the panel 421 (e.g., the coil 412) to the sum of the masses of the shell 422 and the element rigidly connected to the shell 422 (e.g., the additional element 440) is 0.16, and an elasticity coefficient is 588 N/m. Curve L62 is the frequency response curve of the acoustic output device 400 when the ratio of the sum of the masses of the panel 421 and the element rigidly connected to the panel 421 to the sum of the masses of the shell 422 and the element rigidly connected to the shell 422 is 0.36, and the elasticity coefficient is 2000 N/m. Curve L63 is the frequency response curve of the acoustic output device 400 when the ratio of the sum of the masses of the panel 421 and the element rigidly connected to the panel 421 to the sum of the masses of the shell 422 and the element rigidly connected to the shell 422 is 1.03. Curve L64 is the frequency response curve of the acoustic output device 400 when the ratio of the sum of the masses of the panel 421 and the element rigidly connected to the panel 421 to the sum of the masses of the shell 422 and the element rigidly connected to the shell 422 is 3.07. Curve L65 is the frequency response curve of the acoustic output device 400 when the ratio of the sum of the masses of the panel 421 and the element rigidly connected to the panel 421 to the sum of the masses of the shell 422 and the element rigidly connected to the shell 422 is 5.14. Resonance peaks in region C are the resonance peaks generated during a vibration of the resonant system formed by the panel 421, the additional element 440, and the elastic element 450. The resonance peaks of the curves L61 to L65 in region C overlap. The resonance valleys in region D are resonance valleys generated during the vibration of the resonant system formed by the panel 421, the additional element 440, and the elastic element 450.

In some embodiments, as can be seen in conjunction with the curves L61 to L65, the frequency response curve of the acoustic output device 400 is flatter in a frequency range higher than the resonant frequency corresponding to the resonance peak, which enables the acoustic output device 400 to output a better sound quality in the frequency range higher than the resonant frequency corresponding to the resonance peak.

Continuing to refer to FIG. 6, as the ratio of the sum of the masses of the panel 421 and the element rigidly connected to the panel 421 to the sum of the masses of the shell 422 and the element rigidly connected to the shell 422 increases, the frequency corresponding to the resonance valley consequently increases, and the smaller a difference between the frequency corresponding to the resonance valley and the frequency corresponding to the resonance peak. The smaller the difference between the resonance valley and the resonance peak, the smaller the effect of the additional element 440 on the frequency response of the acoustic output device 400, the flatter the frequency response curve of the acoustic output device 400, and the acoustic output device 400 has a better sound quality. Therefore, the effect of the additional element 440 on the frequency response of the acoustic output device 400 may be reduced by adjusting the ratio of the sum of the masses of the panel 421 and the elements rigidly connected to the panel 421 to the sum of the masses of the shell 422 and the elements rigidly connected to the case 422. In some embodiments, the ratio of the sum of the masses of the panel 421 and the elements rigidly connected to the panel 421 to the sum of the masses of the shell 422 and the elements rigidly connected to the shell 422 is in a range of 0.16-7. In some embodiments, the ratio of the sum of the masses of the panel 421 and the elements rigidly connected to the panel 421 to the sum of the masses of the shell 422 and the elements rigidly connected to the shell 422 is in a range of 0.36-6. In some embodiments, the ratio of the sum of the masses of the panel 421 and the elements rigidly connected to the panel 421 to the sum of the masses of the shell 422 and the additional element 440 is in a range of 1.03-5.14. In some embodiments, the ratio of the sum of the masses of the panel 421 and the elements rigidly connected to the panel 421 to the sum of the masses of the shell 422 and the elements rigidly connected to the shell 422 is in a range of 1.03-3.07.

As shown in FIG. 4, the acoustic output device 400 also includes a support structure 430 rigidly connected to the shell 422. For example, the support structure 430 is rigidly connected to a sidewall of the shell 422 opposite to the panel 421.

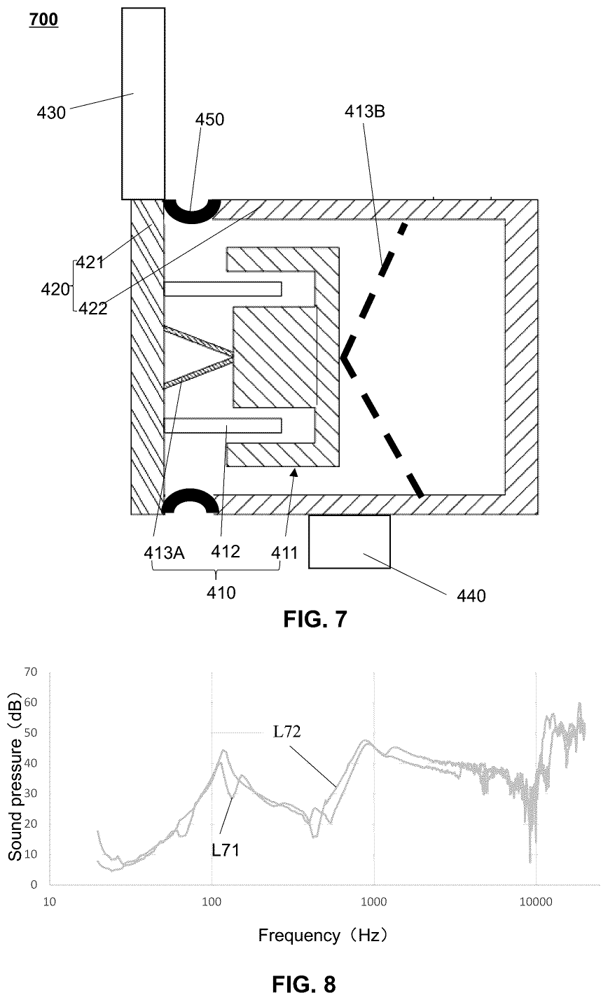

FIG. 7 is a schematic diagram illustrating a structure of an acoustic output device according to some embodiments of the present disclosure. As shown in FIG. 7, the support structure 430 in an acoustic output device 700 is rigidly connected to the panel 421.

In some embodiments, a connection between the support structure 430 and the panel 421, or the connection between the support structure 430 and the shell 422 has smaller effect on the frequency response of the acoustic output device. Taking the acoustic output device being a headset or a hearing aid as an example for illustration, the support structure 430 may be an ear-hook, which is typically made of a flexible material that has a better ability to undergo elastic deformation. Accordingly, the support structure 430 typically affects the vibration of a bone conduction speaker in a very low frequency band (e.g., near and below 20 Hz), and that frequency band is typically inaudible to a human ear. Specifics may be seen in FIG. 8 and the related descriptions. FIG. 8 is a curve diagram illustrating frequency response curves of different acoustic output devices according to some embodiments of the present disclosure.

FIG. 8 shows the frequency response curves of the acoustic output device 400 and the acoustic output device 700. A horizontal coordinate indicates frequency (Hz), a vertical coordinate indicates sound pressure (dB) corresponding to the acoustic output device 400 at different frequencies. Curve L71 indicates a frequency response curve of the acoustic output device 400 when the support structure 430 is rigidly connected to the shell 422, and curve L72 indicates a frequency response curve of the acoustic output device 700 when the support structure 430 is rigidly connected to the panel 421. As can be seen in conjunction with curves L71 and L72, it can be found that the support structure 430 rigidly connected to the panel 421 or rigidly connected to the shell 422 has little or no effect on the frequency response of the acoustic output device 400. Thus, in the acoustic output device 400 of the embodiment of the present disclosure, the support structure 430 is rigidly connected to the panel 421 or rigidly connected to the shell 422.

In the acoustic output device 400 or 700, a connection between the magnetic circuit assembly 411 and the panel 421 through the vibration transmission sheet 413A results in the magnetic circuit assembly 411 and the additional element 440 being attracted or repelled to each other, resulting in the magnetic circuit assembly undergoing a flip deformation, thereby affecting vibration stability of the transducer 410. To avoid the magnetic circuit assembly 411 and the additional element 440 from attracting or repelling each other and causing the magnetic circuit assembly to flip and deform, which affects the vibration stability of the transducer, in some embodiments, the vibration transmission sheet 413A between the magnetic circuit assembly 411 and the panel 421 is replaced with a vibration transmission sheet 413B (indicated by the dashed line in FIGS. 4 and 7). As an example, the vibration transmission sheet 413B is disposed between the magnetic circuit assembly 411 and a sidewall on the shell 422 opposite to the panel 421. A side of the vibration transmission sheet 413B is connected to one end of the magnetic circuit assembly 411 departs from the panel 421, and a circumferential side of the vibration transmission sheet 413B is connected to the sidewall of the shell 422 adjacent to the panel 421. Here, by disposing the vibration transmission sheet 413B between the magnetic circuit assembly 411 and the sidewall of the shell 422 opposite to the panel 421, the vibration transmission sheet 413B enhances a support effect of the magnetic circuit assembly 411 near the additional element 440, thereby improving the vibration stability of the transducer, especially of the magnetic circuit assembly 411. In some embodiments, to further improve the vibration stability of the transducer 410, both the vibration transmission sheet 413A and the vibration transmission sheet 413B are included in the acoustic output device 400 or 700.

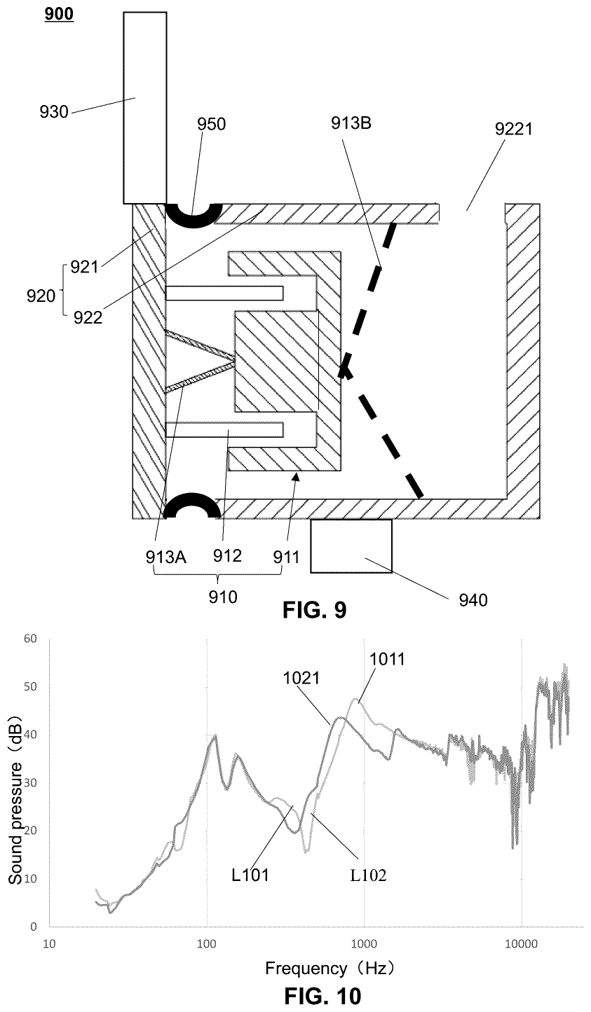

FIG. 9 is a schematic diagram illustrating a structure of an acoustic output device according to some embodiments of the present disclosure. The structures of a transducer 910 (including a magnetic circuit assembly 911, a coil 912, a vibration transmission sheet 913A, a vibration transmission sheet 913B), a housing 920 (including a panel 921), a support structure 930, an additional element 940, an elastic element 950, etc., illustrated in FIG. 9 are similar to the transducer 410 (including the magnetic circuit assembly 411, the coil 412, the vibration transmission sheet 413A, the vibration transmission sheet 413B), the housing 420 (including the panel 421), the support structure 430, the additional element 440, and the elastic element 450, respectively, which are not further described herein. A main difference between the acoustic output device 900 illustrated in FIG. 9 and the acoustic output device 700 illustrated in FIG. 7 is that, in the acoustic output device 900, the shell 922 includes one or more pressure relief holes 9221 for connecting air inside and outside the housing 920. In some embodiments, the pressure relief hole 9221 is opened on a sidewall of the shell 922 opposite and/or adjacent to the panel 921. In some embodiments, the pressure relief hole 9221 is disposed at the elastic element 950. For example, when the elastic element 950 is a ring structure with elasticity, the pressure relief hole 9221 is disposed at the ring structure. For another example, in some embodiments, the elastic element 950 is a reed or an elastic mesh with a through-hole, and instead of the pressure relief holes 9221, the through-hole or a slit in the elastic mesh is a pressure relief hole 9221 for connecting air inside and outside the shell 922. It should be noted that the pressure relief holes 9221 herein may also be applied in acoustic output devices disposed in other embodiments of the present disclosure, for example, acoustic output devices 300, 400, 700, 1200, 1300, 1500, 1700, 1800, 1900, 2000, 2200, 2400, 2500, 2600, 2700, 2900, 3000, 3100, etc.

In the acoustic output device 900, the magnetic circuit assembly 911 and the panel 921 are connected to each other through the vibration transmission sheet 913A, which results in the magnetic circuit assembly 911 and the additional element 940 being attracted or repelled to each other to cause the magnetic circuit assembly to undergo a flip deformation, thereby affecting the vibration stability of the transducer 910. To avoid the magnetic circuit assembly 911 and the additional element 940 attracting or repelling each other and causing the magnetic circuit assembly to flip and deform, which affects a vibration stability of the transducer, in some embodiments, the vibration transmission sheet 913A between the magnetic circuit assembly 911 and the panel 921 is replaced with the vibration transmission sheet 913B (indicated by the dashed line in FIG. 9). As an example, the vibration transmission sheet 913B is disposed between the magnetic circuit assembly 911 and a sidewall of the shell 922 that is positioned opposite to the position of the panel 921. A side of the vibration transmission sheet 913B is connected with the magnetic circuit assembly 911 depart from the side of the panel 921, and a circumferential side of the vibration transmission sheet 913B is connected to the sidewall of the shell 922 adjacent to the panel 921. Here, by disposing the vibration transmission sheet 913B between the magnetic circuit assembly 911 and the sidewall on the shell 922 opposite to the panel 921, the vibration transmission sheet 913B enhances the support effect for the magnetic circuit assembly 911 near the additional element 940, thereby improving the vibration stability of the transducer, especially the magnetic circuit assembly 911. In some embodiments, to further improve the vibration stability of the transducer 910, both the vibration transmission sheet 913A and the vibration transmission sheet 913B are included in the acoustic output device 900.

FIG. 10 is a curve diagram illustrating frequency response curves of acoustic output devices according to some embodiments of the present disclosure. FIG. 10 shows frequency response curves of the acoustic output device 700 and the acoustic output device 900. A horizontal coordinate indicates frequency (Hz), a vertical coordinate indicates sound pressure (dB) corresponding to the acoustic output device at different frequencies, curve L101 is a frequency response curve of the acoustic output device 700 with a resonance peak 1011, and curve L102 is a frequency response curve of the acoustic output device 900 with a resonance peak 1021. Referring to the curves L101 and the L102, it can be seen that a resonant frequency corresponding to the resonance peak 1011 is higher than a resonant frequency corresponding to the resonance peak 1021, and a frequency range in which the sensitivity of the acoustic output device 900 is not affected or less affected by an additional element (i.e., a frequency range greater than the resonant frequency corresponding to the resonance peak 1021) is wider than a frequency range in which the sensitivity of the acoustic output device 700 is not affected or less affected by the additional element (i.e., a frequency range greater than the resonant frequency corresponding to the resonance peak 1011). Thus, it can be seen that by providing one or more pressure relief holes on the housing, the resonant frequency corresponding to the resonance peak generated by the elastic element driving the additional element to vibrate with respect to the panel may be lowered, so as to widen the frequency range in which the sensitivity of the acoustic output device is not or less affected by the additional element. In addition, the vibration of the shell and/or the panel can drive the external air to vibrate and generate a sound leakage. By providing the pressure relief hole on the housing of the acoustic output device, the sound leakage of the acoustic output device is reduced. Specifically, the pressure relief hole exports sound generated by the vibration of the magnetic circuit assembly inside an accommodation cavity to the outside world to cancel the sound leakage generated by the vibration of the shell and/or the panel, thereby reducing the sound leakage volume of the acoustic output device.

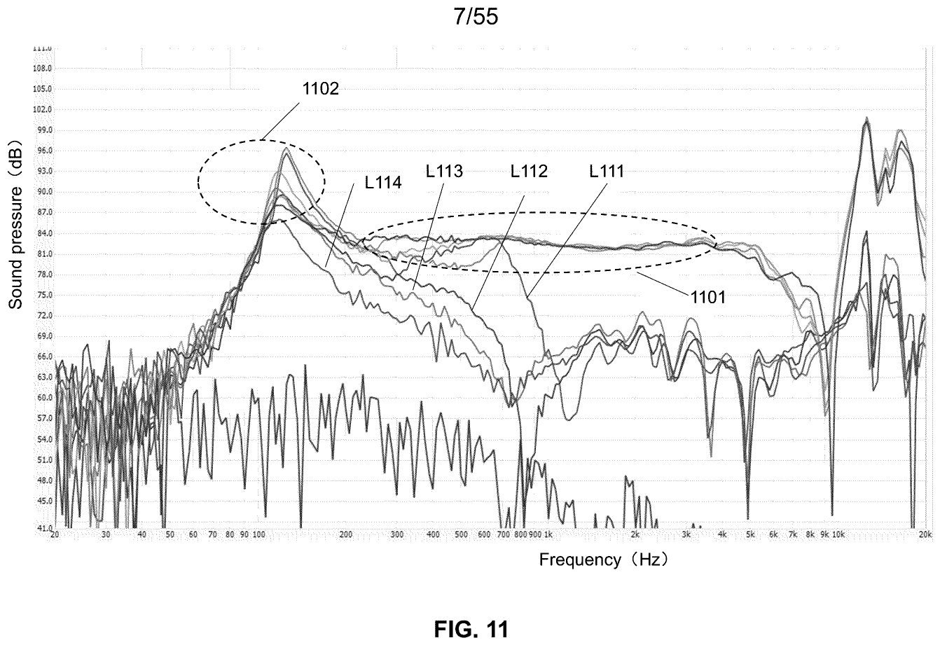

In some embodiments, the mass of the additional element is adjusted to reduce the volume of the sound leakage of the acoustic output device in a frequency range higher than the resonant frequency corresponding to the resonance peak described above. FIG. 11 is a curve diagram illustrating frequency response curves of acoustic output devices according to some embodiments of the present disclosure. FIG. 11 shows a sound leakage frequency response curve of a back plate side (i.e., a side of a sidewall of the shell 922 opposite to a position of the panel 921) of the acoustic output device 900 when an additional element has different masses and a frequency response curve of a side of the panel 921. A horizontal coordinate indicates frequency (Hz), a vertical coordinate indicates the corresponding sound pressure (dB) of the acoustic output device at different frequencies, curve L111 is a sound leakage frequency response curve of the acoustic output device 900 when the mass of the additional element is 0 g, curve L112 is a sound leakage frequency response curve of the acoustic output device 900 when the mass of the additional element is 0.7 g, curve L113 is a sound leakage frequency response curve of the acoustic output device 900 when the mass of the additional element is 1.4 g, and curve L114 is a sound leakage frequency response curve of the acoustic output device 900 when the mass of the additional element is 2.1 g. Region 1101 are frequency response curves of the acoustic output device 900 when there are additional elements with different masses, and region 1102 is a resonance peak region of the acoustic output device 900 when there are additional elements with different masses. In some embodiments, the sound leakage frequency response curve of the acoustic output device 900 is measured by collecting an air conduction sound on a side of a sidewall of the shell 922 opposite to the position of the panel 921, and the frequency response curve of the acoustic output device 900 is measured by collecting the air conduction sound on the side of the panel 921. As shown in FIG. 11, for the region 1101 and the region 1102, in a frequency range higher than the resonance frequency corresponding to the resonance peak region (region 1102) (including the frequency range corresponding to the region 1101), when the acoustic output device 900 has the additional elements of different masses, the sensitivity of the acoustic output device 900 is substantially the same, that is, the sensitivity of the acoustic output device 900 does not increase with the increase of the mass of the additional element. In some embodiments, in conjunction with the curves L111 to L114, it can be seen that as the mass of the additional element is increased, the resonant frequency corresponding to the resonance peak in the sound leakage frequency response curve of the acoustic output device 900 becomes smaller. In some embodiments, the mass of the additional element is adjusted, so that the resonant frequency corresponding to the resonance peak in the sound leakage frequency response curve of the acoustic output device is less than the resonant frequency corresponding to the resonance peak in the frequency response curve of the acoustic output device, and thus enabling the acoustic output device 900 generates, in a frequency range (e.g., 300 Hz-8000 Hz) where the sensitivity of the acoustic output device is unaffected by the mass of the additional element, a less volume of sound leakage. In some embodiments, the resonant frequency corresponding to the resonance peak in the sound leakage frequency response curve of the acoustic output device is not greater than 700 Hz. Preferably, the resonant frequency corresponding to the resonance peak in the sound leakage frequency response curve of the acoustic output device is not greater than 500 Hz. Further preferably, the resonant frequency corresponding to the resonance peak in the sound leakage frequency response curve of the acoustic output device is not greater than 300 Hz. Further preferably, the resonant frequency corresponding to the resonance peak in the sound leakage frequency response curve of the acoustic output device is not greater than 200 Hz.

It should be noted that the pressure relief holes and the solution for adjusting the mass of the additional element are not only applicable to the acoustic output device 900, but also to other acoustic output devices disposed by embodiments of the present disclosure (e.g., the acoustic output devices 400, 700, 1200, etc.).

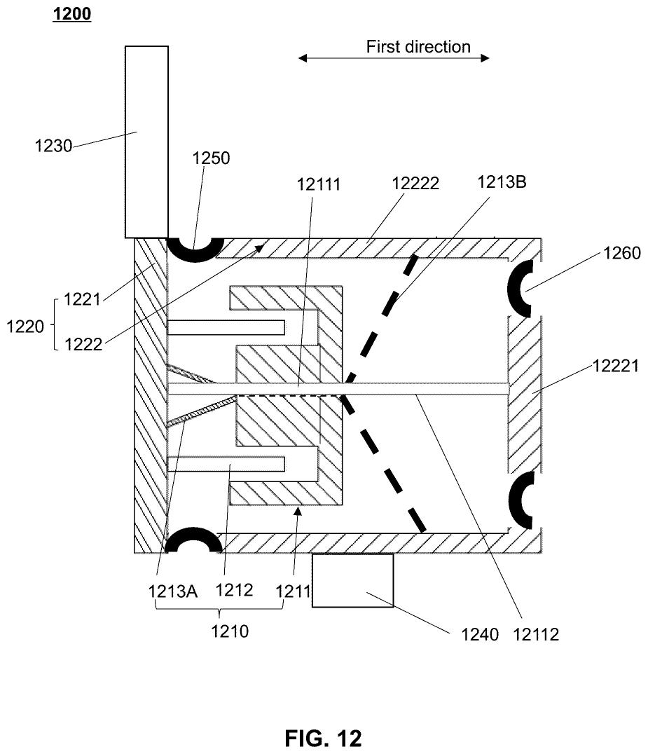

FIG. 12 is a schematic diagram illustrating a structure of an acoustic output device according to some embodiments of the present disclosure. As shown in FIG. 12, a transducer 1210 (including a magnetic circuit assembly 1211, a coil 1212, a vibration transmission sheet 1213A, a vibration transmission sheet 1213B), a housing 1220 (including a panel 1221), a support structure 1230, and an additional element 1240 in the acoustic output device 1200 are similar, respectively, to the transducer 410 (including the magnetic circuit assembly 411, the coil 412, the vibration transmission sheet 413A, the vibration transmission sheet 413B), the housing 420 (including the panel 421), the support structure 430, and the additional element 440 in the acoustic output device 700, which are not further described herein. A main difference between the acoustic output device 1200 and the acoustic output device 700 is that a sidewall of a shell 1222 of the acoustic output device 1200 opposite to the panel 1221 (also referred to as a back plate 12221) is connected to the other sidewalls of the shell 1222 (the sidewalls adjacent to the panel 1221, also referred to as a shell body 12222) through an elastic element 1260. In some embodiments, the elastic element 1260 is a ring structure, which is made of an elastic material, as shown in FIG. 12. As an example, in some embodiments, the shell 1222 includes the shell body 12222 and the back plate 12221. The shell body 12222 is a sidewall on the shell 1222 adjacent to the panel 1221. The back plate 12221 is a sidewall on the shell 1222 opposite to the panel 1221. The back plate 1221 is independently disposed with respect to the shell body, and a ring structure is disposed around a circumferential side of the back plate 12221, and the circumferential side of the ring structure is connected to the sidewall of the shell body 12222. It should be noted that the structure of the elastic element 1260 illustrated in FIG. 12 is only an example and is not intended to be limiting. In some embodiments, the elastic element 1260 is also a structure with other shapes (e.g., strips, sheets, plates, etc.) made of an elastic material. In some embodiments, the elastic material includes polycarbonate (PC), polyamides (PA), acrylonitrile butadiene styrene (ABS), polystyrene (PS), high impact polystyrene (HIPS), polypropylene (PP), polyethylene terephthalate (PET), polyvinyl chloride (PVC), polyurethanes (PU), polyethylene (PE), phenol formaldehyde (PF), urea-formaldehyde (UF), melamine-formaldehyde (MF), polyarylate (PAR), polyetherimide (PEI), polyimide (PI), polyethylene naphthalate two formic acid glycol ester (PEN), polyetheretherketone (PEEK), carbon fiber, graphene, silica gel, etc., or any one or combination thereof. In some embodiments, the elastic element 1260 is an elastic structure. The elastic structure refers to a structure that itself has elasticity, even if the material is hard, but due to the elasticity of the structure itself, the elastic element 1260 itself has elasticity. In some embodiments, the elastic structure includes a structure such as a reed structure, i.e., the elastic element 1260 is the reed structure. In some embodiments, the elastic element 1260 is a somewhat elastic glue used to bond the shell body 12222 to the back plate 12221. In some embodiments, the glue with a certain elasticity is a silicone bonding type of glue, a silicone glue, etc. In some embodiments, a connection between the shell body 12222 and the back plate 12221 is a sealed connection. In some embodiments, the connection between the shell body 12222 and the back plate 12221 is not the sealed connection, and a gap between the shell body 12222 and the back plate 12221 acts as a pressure relief hole to connect the air inside and outside the shell 1222 to reduce the resonant frequency corresponding to the resonance peak of the acoustic output device 1200, thereby making a frequency range in which the sensitivity of the acoustic output device 1200 is not affected by additional element (or the frequency range corresponding to the flat frequency response curve) wider.

The back plate 12221 in the acoustic output device 1200 is connected to the shell body 12222 through the elastic element 1260, and the back plate 12221 and the elastic element 1260 are equated into a mass-elastic module. The mass-elastic module plays an effect of vibration isolation, so that a high-frequency vibration generated by the transducer 1210 does not transmit to the back plate 12221, so as to avoid the high-frequency vibration of the back plate 12221 generating a high-frequency sound leakage.

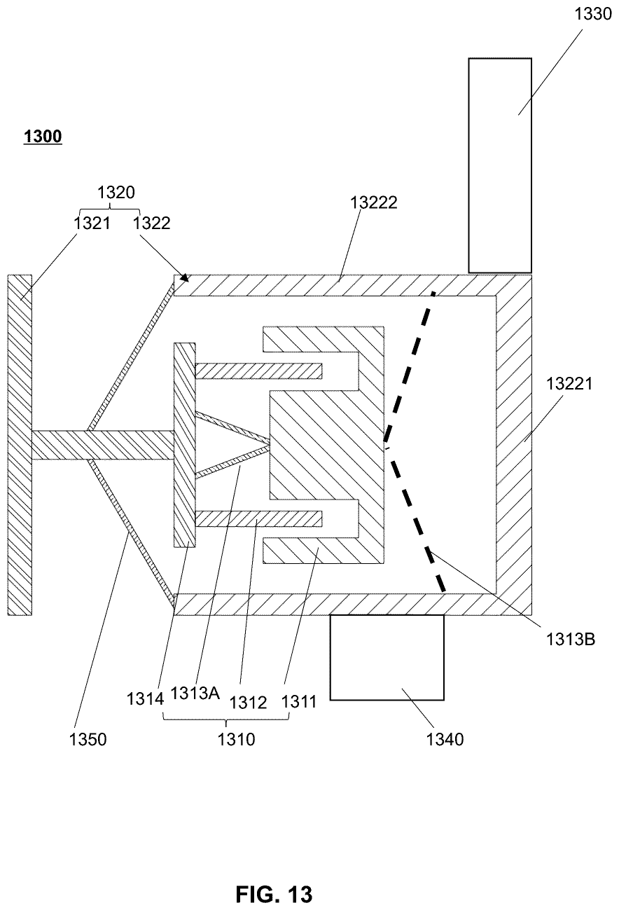

It should be noted that the back plate and the shell body in other acoustic output devices disposed by embodiments of the present disclosure (e.g., acoustic output device 400 shown in FIG. 4, acoustic output device 900 shown in FIG. 9, acoustic output device 1300 shown in FIG. 13, etc.) may also be connected to the shell body through an elastic element to avoid the acoustic output device from generating a high-frequency sound leakage on the back plate side.

In the acoustic output device 1200, the magnetic circuit assembly 1211 and the panel 1221 are connected to each other by the vibration transmission sheet 1213A, and a situation where the magnetic circuit assembly 1211 and the additional element 1240 are attracted to or repelled from each other and cause the magnetic circuit assembly to flip and deform may occur to affect vibration stability of the transducer 1210. To avoid the magnetic circuit assembly 1211 and the additional element 1240 attracting or repelling each other and causing the magnetic circuit assembly 1211 to flip and deform, which affects the vibration stability of the transducer 1210, in some embodiments, the vibration transmission sheet 1213A between the magnetic circuit assembly 1211 and the panel 1221 is replaced with the vibration transmission sheet 1213B (indicated by the dashed line in FIG. 12). As an example, the vibration transmission sheet 1213B is disposed between the magnetic circuit assembly 1211 and a sidewall on the shell 1222 opposite to the panel 1221. One end of the vibration transmission sheet 1213B is connected to the side of the magnetic circuit assembly 1211 departs from the panel 1221, and the circumferential side of the vibration transmission sheet 1213B is connected to the sidewall of the shell 1222 that is adjacent to the panel 421 (the shell body 12222). Here, the vibration transmission sheet 1213B is disposed between the magnetic circuit assembly 1211 and the sidewall of the shell 1222 opposite to the panel 1221, and the vibration transmission sheet 1213B is able to strengthen a support effect of the magnetic circuit assembly 1211 near the additional element 1240, so as to improve the vibration stability of the transducer, especially the magnetic circuit assembly. In some embodiments, to further improve the vibration stability of the transducer 1210, both the vibration transmission sheet 1213A and the vibration transmission sheet 1213B are included in the acoustic output device 1200.

In some embodiments, as shown in FIG. 12, the magnetic circuit assembly 1211 includes a hole portion 12111 and a positioning rod 12112. The hole portion 12111 runs through the magnetic circuit assembly 1211 along a vibration direction of the transducer 1210 (the first direction shown in FIG. 12), and the positioning rod 12112 is connected to the back plate 12221 at one end away from the panel 1221 and at the other end through the hole portion 12111 and connected to the panel 1221. In some embodiments, the other end of the positioning rod 12112 is connected to the panel 1221, so that the panel 1221 drives the back plate 12221 to vibrate together, thereby reducing the sound leakage generated due to an unsynchronized vibration of the panel 1221 and the back plate 12221. At the same time, cooperation between the positioning rod 12112 and the hole portion 12111 further increases the stability of the magnetic circuit assembly 1211 and reduces the risk of the magnetic circuit assembly 1211 being attracted or repelled by the additional element 1240 and flipping and deforming.

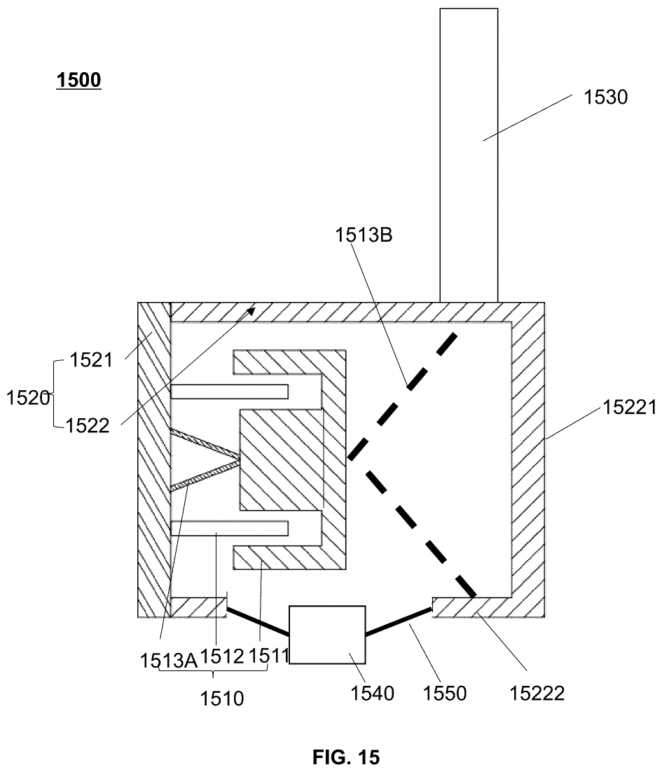

It should be noted that the magnetic circuit assembly including the hole portion 12111 and the positioning rod 12112 is also applicable to other acoustic output devices in the embodiments of the present disclosure, e.g., the acoustic output device 400 shown in FIG. 4, the acoustic output device 700 shown in FIG. 7, the acoustic output device 900 shown in FIG. 9, the acoustic output device 1300 shown in FIG. 13, the acoustic output device 1500 shown in FIG. 15, etc.

FIG. 13 is a schematic diagram illustrating a structure of an acoustic output device according to some embodiments of the present disclosure. As shown in FIG. 13, an acoustic output device 1300 includes a transducer 1310, a housing 1320, a support structure 1330, an additional element 1340, and an elastic element 1350. The transducer 1310 includes a magnetic circuit assembly 1311, a coil 1312, a vibration transmission sheet 1313A, and a vibration plate 1314. The vibration plate 1314 is elastically connected to the magnetic circuit assembly 1311 through a vibration transmission sheet 1313A. In some embodiments, the housing 1320 includes a panel 1321 and a shell 1322. In some embodiments, the shell 1322 includes a back plate 13221 positioned opposite to the panel 1321 and a shell body 13222 positioned adjacent to the panel 1321. The support structure 1330 is rigidly connected to the panel 1321 or rigidly connected to the shell 1322 (e.g., the back plate 13221 or the shell body 13222). In some embodiments, the elastic element 1350 is a damping sheet, the panel 1321 is elastically connected to the shell 1322 through the damping sheet, the additional element 1340 is rigidly connected to the shell 1322, the panel 1321 is rigidly connected to the vibration plate 1314, and the shell 1322 is rigidly connected to the vibration plate 1314 and the panel 1321 through the damping sheet. As an example, the vibration plate 1314 is connected to the coil 1312, and when the transducer 1310 is operating, the coil 1312 drives the vibration plate 1314 together with the panel 1321 to perform a mechanical vibration. The vibration plate 1314 is rigidly connected to the panel 1321 through a rigid member (e.g., a connecting rod member), and the rigid member is connected to the shell 1322 (a sidewall in the shell 1322 adjacent to the panel 1321) through the damping sheet, thereby realizing connections between the shell 1322, the vibration plate 1314, and the panel 1321. In some embodiments, the panel 1321 and structures rigidly connected to the panel (e.g., the vibration plate 1314, the coil 1312, etc.), the elastic element 1350, the shell 1322 and structures rigidly connected to the shell 1322 (e.g., the additional element 1340, the support structure 1330, etc.) form a resonant system. It should be noted that when there are other structures rigidly attached to the panel 1321 or the shell 1322, these structures are also considered to be a portion of the resonant system. The resonant system generates a resonance peak located within a target frequency range, and a vibration transmitted between the additional element 1340 and the panel 1321 is suppressed in a frequency range following a resonant frequency corresponding to the resonance peak. That is, the effect of the additional element 1340 on the vibration of the panel 1321 is reduced, thereby ensuring that the sensitivity of the resonant system is not or less affected by the additional element 1340 in the frequency range greater than the resonant frequency corresponding to the resonance peak. In some embodiments, by setting the resonant frequency corresponding to the resonance peak at a lower frequency position, the frequency range where the sensitivity of the acoustic output device 1300 decreases due to the additional element 1340 is reduced. In addition, in the frequency range that is greater than the resonant frequency corresponding to the resonance peak, a frequency response curve of the acoustic output device 1300 is flatter due to the less influence of the additional element 1340 on the vibration of the panel 1321, which ensures that the acoustic output device 1300 has a better acoustic output effect in a wider frequency range, thereby improving a listening experience of a user.

The shell 1322, the support structure 1330, the additional element 1340, the magnetic circuit assembly 1311, the coil 1312, and the vibration transmission sheet 1313A, etc., are similar to the shell 422, the support structure 430, the additional element 440, the magnetic circuit assembly 411, the coil 412, and the vibration transmission sheet 413A etc., respectively, which are not repeated herein.

In some embodiments, the damping sheet is a sheet-like structure made of an elastic material (e.g., a silicone, a polyurethane, etc.). In some embodiments, the damping sheet is an elastic structure (e.g., a reed structure) whose structure is inherently elastic. Due to the presence of the damping sheet, the mechanical vibration generated by the transducer 1310 is less or even not transmitted to the shell 1322, so that masses of the shell 1322 as well as the additional element 1340 do not cause an increase in a vibration loading mass of the transducer 1310 within the frequency range higher than the resonant frequency corresponding to the resonance peak. Therefore, it is ensured that the sensitivity of the acoustic output device 1300 in the frequency range greater than the resonant frequency corresponding to the resonance peak is not affected by the additional element 1340 and the shell 1322 (as well as related components disposed in the shell 1322, such as the support structure 1330, the battery, and the circuit board). The frequency response curve of the acoustic output device 1300 is relatively flat in the frequency range higher than the resonant frequency corresponding to the resonance peak, so as to ensure that the acoustic output device 1300 is capable of outputting better sound quality.

In some embodiments, to avoid the acoustic output device 1300 from generating a high frequency sound leakage on a side of the shell 1322 opposite to the panel 1321, a sidewall of the shell 1322 opposite to the position of the panel 1321 (i.e., the back plate 13221) is connected to other sidewalls of the shell 1322 (e.g., a main body of the shell 1322) through the elastic element. In some embodiments, a manner in which the shell body 12222 in the acoustic output device 1200 is connected to the back plate 12221 through the elastic element 1260, as illustrated in FIG. 12, also applies to the connection between the shell body 13222 and the back plate 13221 in the acoustic output device 1300.

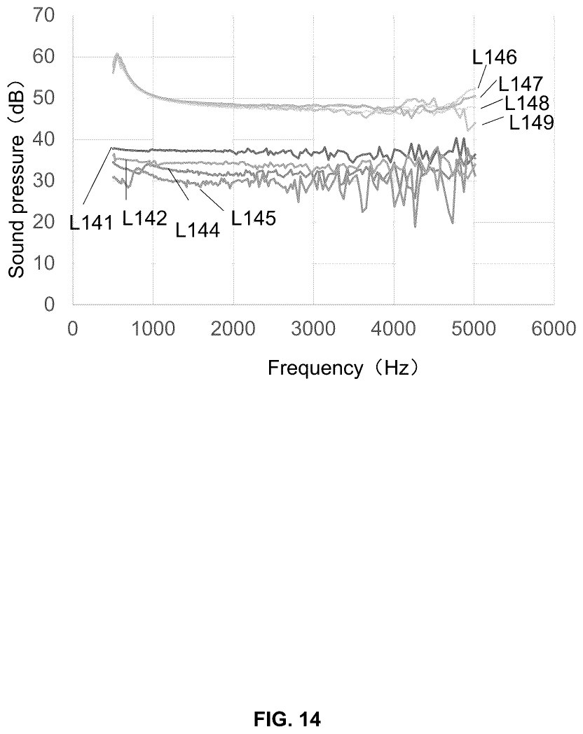

FIG. 14 is a curve diagram illustrating frequency response curves of acoustic output devices according to some embodiments of the present disclosure.

FIG. 14 shows frequency response curves of the acoustic output device 200 and the acoustic output device 1300 when additional elements have different masses. A horizontal coordinate is frequency (Hz), a vertical coordinate is sound pressures (dB) corresponding to the acoustic output devices at different frequencies, curve L141 is the frequency response curve of the acoustic output device 200 when the mass of the additional element 40 is 0 g, curve L142 is the frequency response curve of the acoustic output device 200 when the mass of the additional element 40 is 1 g, curve L144 is the frequency response curve of the acoustic output device 200 when the mass of the additional element 40 is 2 g, curve L145 is the frequency response curve of the acoustic output device 200 when the mass of the additional element 40 is 3 g, curve L146 is the frequency response curve of the acoustic output device 1300 when the mass of the additional element 1340 is 2 g, curve L147 is the frequency response curve of the acoustic output device 1300 when the mass of the additional element 1340 is 0 g, curve L148 is the frequency response curve of the acoustic output device 1300 when the mass of the additional element 1340 is 3 g, and curve L149 is the frequency response curve of the acoustic output device 1300 when the mass of the additional element 1340 is 1 g.

Referring to the frequency response curves of the acoustic output device 200 and the acoustic output device 1300, it can be seen that, in a frequency range of 500 Hz-5000 Hz, a sound pressure output by the acoustic output device 1300 is generally greater than the sound pressure output by the acoustic output device 200, that is, in the frequency range of 500 Hz-5000 Hz, the sensitivity of the acoustic output device 1300 is greater than the sensitivity of the acoustic output device 200. As a result, the acoustic output device 1300, relative to the acoustic output device 200, is able to solve a problem of a lower sensitivity caused by the installation of the additional element on the bone conduction acoustic output device. Additionally, according to the frequency response curve of the acoustic output device 200, it can be seen that in the frequency range of 500 Hz-5000 Hz, as the mass of the additional element 40 increases, the sound pressure of the acoustic output device 200 decreases generally, i.e., the sensitivity of the acoustic output device 200 decreases. Thus, it can be seen that the sensitivity of the acoustic output device 200 is affected by the mass of the additional element 40. According to the frequency response curve of the acoustic output device 1300, it can be seen that the frequency response curve of the acoustic output device 1500 is relatively flat in the frequency range of 500 Hz to 5000 Hz, and that the sound pressure of the acoustic output device 1300 is not changed generally as the mass of the additional element 1340 increases, i.e., the sensitivity of the acoustic output device 1300 does not change. It can be seen that the sensitivity of the acoustic output device 1300 is not changed by the mass of the additional element 1340 in the frequency range of 500 Hz-5000 Hz, so that the acoustic output device 1300 has a relatively flat frequency response curve in the frequency range of 500 Hz-5000 Hz, which ensures that the acoustic output device 1300 is able to output a better sound quality.

In the acoustic output device 1300, the magnetic circuit assembly 1311 and the vibration plate 1314 are connected to each other by the vibration transmission sheet 1313A, and it may occur that the magnetic circuit assembly 1311 and the additional element 1340 are attracted or repelled to each other, causing the magnetic circuit assembly to flip deform to affect vibration stability of the transducer 1310. To avoid the magnetic circuit assembly 1311 and the additional element 1340 from attracting or repelling each other and causing the magnetic circuit assembly 1311 to flip and deform and affect the vibration stability of the transducer 1310, in some embodiments, the vibration transmission sheet 1313A between the magnetic circuit assembly 1311 and the vibration plate 1314 is replaced with a vibration transmission sheet 1313B (shown as a dashed line in FIG. 13). As an example, the vibration transmission sheet 1313B is disposed between the magnetic circuit assembly 1311 and a sidewall on the shell 1322 opposite to the panel 1321. One side of the vibration transmission sheet 1313B is connected to the side of the magnetic circuit assembly 1311 departs from the panel 1321, and a circumferential side of the vibration transmission sheet 1313B is connected to the sidewall of the shell 1322 that is adjacent to the panel 1321 (the shell body 13222). Here, by disposing the vibration transmission sheet 1313B between the magnetic circuit assembly 1311 and the sidewall of the shell 1322 opposite to the panel 1321, the vibration transmission sheet 1313B is able to strengthen a support effect of the magnetic circuit assembly 1311 near the additional element 1340, thereby improving the vibration stability of the transducer, in particular, the vibration stability of the magnetic circuit assembly 1311. In some embodiments, to further improve the vibration stability of the transducer 1310, both the vibration transmission sheet 1313A and the vibration transmission sheet 1313B are included in the acoustic output device 1300.

FIG. 15 is a schematic diagram illustrating a structure of an acoustic output device according to some embodiments of the present disclosure.

As shown in FIG. 15, structures including a transducer 1510 (including a magnetic circuit assembly 1511, a coil 1512, a vibration transmission sheet 1513A), a panel 1521, a housing 1520 (including a panel 1521 and a shell 1522), a support structure 1530, an additional element 1540, etc., in the acoustic output device 1500 are similar to the structures of the acoustic output device 400, including the transducer 410 in the acoustic output device 400 (including the magnetic circuit assembly 411, the coil 412, the vibration transmission sheet 413A), the housing 420 (including the panel 421 and the shell 422), the support structure 430, the additional element 440, and other structures, which are not further elaborated herein. What distinguishes the acoustic output device 1500 from the acoustic output device 400 is that, in the acoustic output device 1500, the panel 1521 is rigidly connected to the shell 1522, the additional element 1540 is connected to a sidewall of the shell 1522 through the elastic element 1550, and the additional element 1540 and the elastic element 1550 are structured as at least a portion of the sidewall of the shell 1522. The sidewall of the shell 1522 includes a sidewall opposite to the panel 1521 (i.e., a back plate 15221) and a sidewall adjacent to the panel 1521 (i.e., a shell body 15222). In some embodiments, the elastic element 1550 is a ring structure with elasticity, and the additional element 1540 is connected to the sidewall of the shell 1522 through the ring structure. As an example, the sidewall of the shell 1522 is disposed with a hole or groove matching a shape of the additional element 1540. The ring structure is socketed to a circumferential side of the additional element 1540, and the additional element socketed with the ring structure 1540 is embedded within the hole or the groove in the sidewall of the shell 1522, so that the additional element 1540 and the elastic element 1550 are used as a portion of the sidewall. In some embodiments, instead of the ring structure with elasticity, an adhesive with elasticity is used to bond the circumferential side of the additional element 1540 to an inner wall of the hole or the groove in the sidewall of the shell 1522. In some embodiments, the elastic element 1550 is a reed structure. The additional element 1540 is connected to a surface of the reed structure, or embedded in the reed structure, and the circumferential side of the reed structure is connected to the panel 1521 and/or other sidewall of the shell 1522, so that the additional element 1540 and the elastic element 1550 are used entirely as one of the sidewalls of the shell 1522 or a portion thereof, at which point the elastic element 1550, the additional element 1540, the panel 1521, and the shell 1522 collectively enclose an accommodation cavity. In some embodiments, the reed structure is an elastic sheet-like structure made of a metallic material (e.g., iron, aluminum, copper, etc.) or a non-metallic material (e.g., rubber, urethane-like material, etc.). In some embodiments, the acoustic output device 1500 includes a support plate (not shown in FIG. 15), the additional element 1540 is disposed on the support plate. The support plate is connected to a sidewall of the shell 1522 through the elastic element 1550. The support plate is disposed on an inside or an outside of the shell 1522, or the elastic element 1550 and the support plate are disposed as one of the sidewalls or a portion of the sidewall.

In some embodiments, the panel 1521, the shell 1522, structures rigidly connected to the panel 1521 or shell 1522 (e.g., the coil 1512, the support structure 1530, etc.), and the additional element 1540 are elastically connected to each other by the elastic element 1550 to form a resonant system. It should be noted that when there are other structures rigidly attached to the panel 1521 or the shell 1522, these structures are also considered to be a portion of the resonant system. The resonant system generates a resonance peak in a target frequency range, and a vibration transmitted between the additional element 1540 and the panel 1521 is suppressed in a frequency range after the resonant frequency corresponding to the resonance peak. That is to say, the effect of the additional element 1540 on the vibration of the panel 1521 is reduced, thereby ensuring that the sensitivity of the resonant system is not or less affected by the additional element 1540 in the frequency range greater than the resonant frequency corresponding to the resonance peak. In some embodiments, by setting the resonant frequency corresponding to the resonance peak at a lower frequency position, the frequency range in which the sensitivity of the acoustic output device 1500 decreases due to the additional element 1540 is reduced. In addition, in the frequency range that is greater than the resonant frequency corresponding to the resonance peak, the frequency response curve of the acoustic output device 1500 is flatter due to the less effect of the additional element 1540 on the vibration of the panel 1521, so as to ensure that the acoustic output device 1500 has a better acoustic output effect in a wider frequency range, and to improve a listening experience of a user. In some embodiments, the elastic element 1550 is able to drive the additional element 1540 to vibrate with respect to the panel 1521 to generate a resonance valley in the target frequency range. In some embodiments, the target frequency range is 20 Hz-800 Hz. Preferably, the target frequency range is 100 Hz-600 Hz. Further preferably, the target frequency range is 150 Hz-500 Hz. Further preferably, the target frequency range is 200 Hz-400 Hz. In some embodiments, the frequency corresponding to the resonance valley is smaller than the frequency corresponding to the resonance peak. In some embodiments, a frequency difference between the frequency corresponding to the resonance peak and the frequency corresponding to the resonance valley is no greater than 300 Hz. In some embodiments, the frequency difference between the frequency corresponding to the resonance peak and the frequency corresponding to the resonance valley is no greater than 200 Hz. In some embodiments, the frequency difference between the frequency corresponding to the resonance peak and the frequency corresponding to the resonance valley is no greater than 100 Hz. In some embodiments, a difference between the resonance peak and the resonance valley is in a range of 20 dB-100 dB. In some embodiments, the difference between the resonance peak and the resonance valley is in a range of 20 dB-60 dB. In some embodiments, the difference between the resonance peak and the resonance valley is in a range of 20 dB-40 dB.

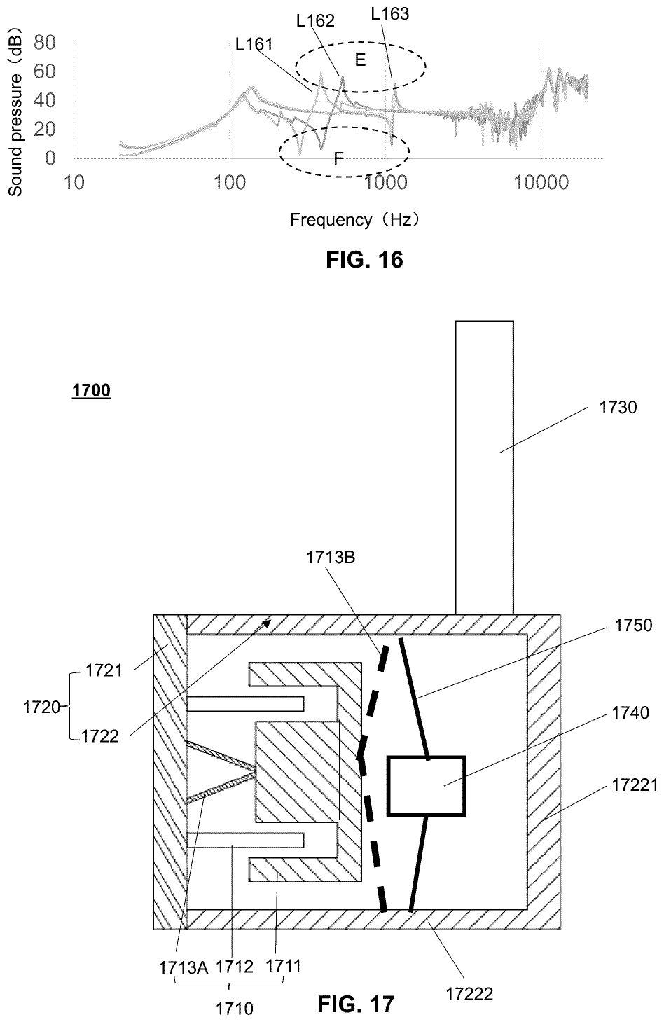

In some embodiments, the resonance peak in the target frequency range is made to lie in a specific frequency range by adjusting the elasticity coefficient of the elastic element 1550 and the mass of the additional element 1540, so that the acoustic output device 1500 reduces the frequency range in which the additional element 440 affects the acoustic output device 400, as well as has a flat frequency response curve in a wider frequency band to output a better sound quality. At the same time, it can ensure that the sensitivity of the acoustic output device 1500 is not affected by the additional element 1540 in the wider frequency band, as shown in FIG. 16.

FIG. 16 is a curve diagram illustrating frequency response curves of acoustic output devices according to some embodiments of the present disclosure.

FIG. 16 shows frequency response curves when the elastic element 1550 in the acoustic output device 1500 has different elastic coefficients and the additional element 1540 has different masses. A horizontal coordinate indicates frequency (Hz), a vertical coordinate indicates corresponding sound pressure (dB) of the acoustic output device at different frequencies, curve L161 is the frequency response curve of the acoustic output device 1500 when the elasticity coefficient of the elastic element 1550 is 8800 N/m and the mass of the additional element 1540 is 2 g, and curve L162 is the frequency response curve of the acoustic output device 1500 when the elasticity coefficient of the elastic element 1550 is 16500 N/m and the mass of the additional element 1540 is 2 g. Curve L163 is the frequency response curve of the acoustic output device 1500 when the elasticity coefficient of the elastic element 1550 is 16,500 N/m, and the mass of the additional element 1540 is 0.3 g. The resonance peaks in region E are resonance peaks located in a target frequency range generated by the elastic element 1550 driving the additional element 1540 to vibrate relative to the panel 1521. The resonance valleys in region F are resonance valleys located in the target frequency range generated by the elastic element 1550 driving the additional element 1540 to vibrate relative to the panel 1521. Referring to curves L161 and L162, it can be seen that as the elasticity coefficient of the elastic element 1550 increases, the resonant frequency corresponding to the resonance peak increases, and the frequency range in which the sensitivity of the acoustic output device 1500 is not affected by the additional element 1540 becomes narrower. Referring to curves L162 and L163, it can be seen that as the mass of the additional element 1540 increases, the resonant frequency corresponding to the resonance peak decreases, and the frequency range in which the sensitivity of the acoustic output device 1500 is not affected by the additional element 1540 becomes wider. In some embodiments, by adjusting the elasticity coefficient of the elastic element 1550 and/or the mass of the additional element 1540, the resonant frequency is made to be within the target frequency range to widen the frequency range in which the sensitivity of the acoustic output device 1500 is not affected by the additional element 1540. In some embodiments, the target frequency range is no greater than 700 Hz. Preferably, the target frequency range is no greater than 500 Hz. Further preferably, the target frequency range is no greater than 500 Hz. Further preferably, the target frequency range is no greater than 300 Hz. More preferably, the target frequency range is no greater than 200 Hz, etc.

In the acoustic output device 1500, the magnetic circuit assembly 1511 and the panel 1521 are connected to each other through the vibration transmission sheet 1513A, and it is likely to occur that the magnetic circuit assembly 1511 and the additional element 1540 are attracted to or repelled from each other and cause the magnetic circuit assembly to flip and deform to affect the vibration stability of the transducer 1510. To avoid the magnetic circuit assembly 1511 and the additional element 1540 attracting or repelling each other and causing the magnetic circuit assembly 1511 to flip and deform, which affects the vibration stability of the transducer 1510, in some embodiments, the vibration transmission sheet 1513A connected between the magnetic circuit assembly 1511 and the panel 1221 can be replaced by a vibration transmission sheet 1513B (shown as the dashed line in FIG. 15). As an example, the vibration transmission sheet 1513B is disposed between the magnetic circuit assembly 1211 and a sidewall of the shell 1222 opposite to the panel 1221. One side of the vibration transmission sheet 1513B is connected to the side of the magnetic circuit assembly 1511 that departs from the panel 1521, and a circumferential side of the vibration transmission sheet 1513B is connected to the sidewall of the shell 1522 that is adjacent to the panel 1521 (the shell body 1522). Here, by disposing the vibration transmission sheet 1513B between the magnetic circuit assembly 1511 and the sidewall of the shell 1522 opposite to the panel 1521, the vibration transmission sheet 1513B is able to strengthen the support effect of the magnetic circuit assembly 1511 near the additional element 1540, thereby improving the vibration stability of the transducer, especially the magnetic circuit assembly 1511. In some embodiments, to further improve the vibration stability of the transducer 1510, the acoustic output device 1500 contains both the vibration transmission sheet 1513A and the vibration transmission sheet 1513B.

FIG. 17 is a schematic diagram illustrating a structure of an acoustic output device according to some embodiments of the present disclosure.

As shown in FIG. 17, the structures of a transducer 1710 (including a magnetic circuit assembly 1711, a coil 1712, a vibration transmission sheet 1713A), a panel 1721 in a housing 1720, a support structure 1730, an additional element 1740, etc., in an acoustic output device 1700 are similar to the structures of the transducer 1510 (including the magnetic circuit assembly 1511, the coil 1512, the vibration transmission sheet 1513A), the panel 1521 in the housing 1520, the support structure 1530, the additional element 1540 and other structures in the acoustic output device 1500 shown in FIG. 15, which are not further described herein. The acoustic output device 1700 differs from the acoustic output device 200 in that the additional element 1740 is disposed independently with respect to the housing 1720, and the additional element 1740 is connected to the shell 1722 through the elastic element 1750. In some embodiments, the additional element 1740 is independently disposed outside of the housing 1720. In some embodiments, the additional element 1740 is independently disposed on an interior of the housing 1720, as shown in FIG. 17. In some embodiments, the elastic element 1750 is a reed structure. One end of the reed structure is connected to the additional element 1740, and the other end is connected to a sidewall of the shell 1722 (the shell body 17222 and/or the back plate 17221). In some embodiments, the elastic element 1750 is a ring structure with elasticity. As an example, the additional element 1740 is disposed within and independent from the shell 1722, an inner contour of the ring structure is connected to a circumferential side of the additional element 1740, and an outer contour of the ring structure is connected to the circumferential side of the shell body 17222. It is noted that the additional component 1740 herein may be a battery, a circuit board, or a sensor that is not sensitive to the vibration direction (e.g., a temperature sensor and a humidity sensor), etc.

In the acoustic output device 1700, the magnetic circuit assembly 1711 and the panel 1721 are connected to each other by the vibration transmission sheet 1713A, and it is likely to occur that the magnetic circuit assembly 1711 and the additional element 1740 are attracted to or repelled from each other and cause the magnetic circuit assembly to flip and deform to affect vibration stability of the transducer 1710. To avoid the magnetic circuit assembly 1711 and the additional element 1740 from attracting or repelling each other and causing the magnetic circuit assembly 1711 to flip and deform, which affects the vibration stability of the transducer 1710, in some embodiments, the vibration transmission sheet 1713A between the magnetic circuit assembly 1711 and the panel 1721 is replaced with a vibration transmission sheet 1713B (shown as a dashed line in FIG. 17). As an example, the vibration transmission sheet 1713B is disposed between the magnetic circuit assembly 1711 and the sidewall of the shell 1722 opposite to the panel 1721. One side of the vibration transmission sheet 1713B is connected to the side of the magnetic circuit assembly 1711 departs from the panel 1721, and the circumferential side of the vibration transmission sheet 1713B is connected to the sidewall of the shell 1722 that is adjacent to the panel 1721 (the shell body 17222). Here, by disposing the vibration transmission sheet 1713B between the magnetic circuit assembly 1711 and the sidewall on the shell 1722 opposite to the panel 1721, the vibration transmission sheet 1713B is able to strengthen a support effect of the magnetic circuit assembly 1711 near the additional element 1740, thereby improving vibration stability of the transducer, especially the magnetic circuit assembly 1711. In some embodiments, to further improve the vibration stability of the transducer 1710, both the vibration transmission sheet 1713A and the vibration transmission sheet 1713B are included in the acoustic output device 1700.

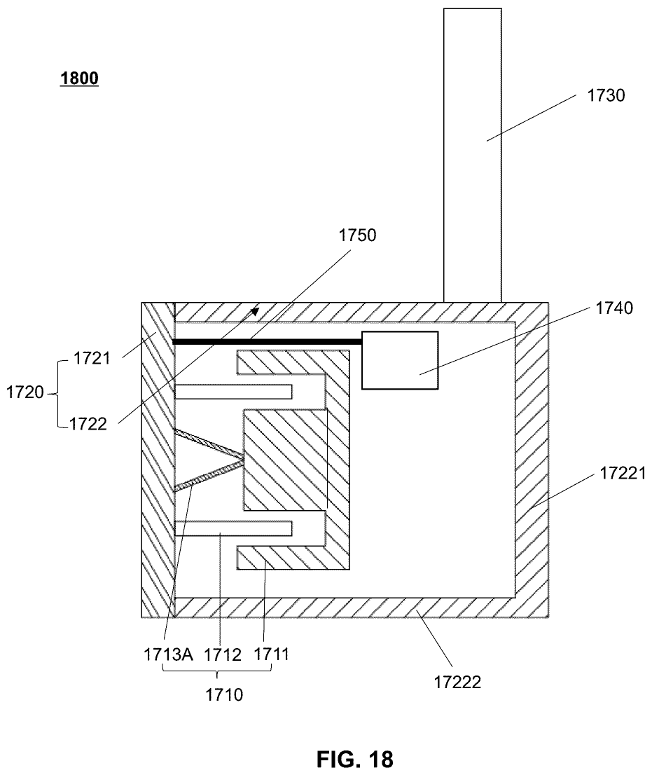

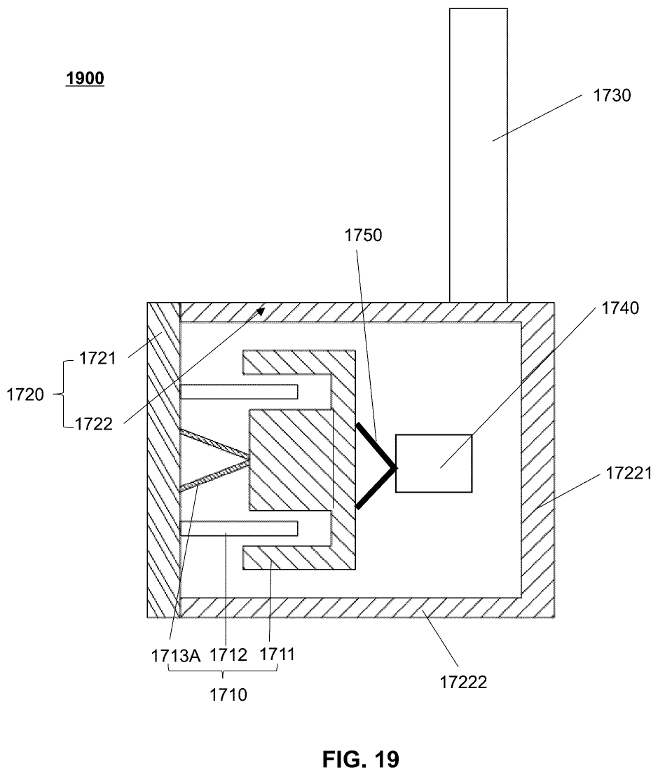

FIGS. 18 and 19 are schematic diagrams illustrating structures of acoustic output devices according to some embodiments of the present disclosure.

In some embodiments, as shown in FIG. 18, the additional element 1740 in an acoustic output device 1800 is elastically connected to the panel 1721 through the elastic element 1750. In some embodiments, as shown in FIG. 19, the additional element 1740 in an acoustic output device 1900 is elastically connected to the transducer 1710 through the elastic element 1750. It is noted that the additional elements 1740 shown in FIGS. 18 and 19 may be batteries, circuit boards, or sensors that are not sensitive to a vibration direction (e.g., temperature sensors and humidity sensors), etc. It is noted that the additional element 1740 is also bonded directly to the shell 1722 through glue, for example, the additional element 1740 is bonded to the shell body 17222 through the glue. After solidification, the glue has a certain degree of elasticity and serves the same function as the elastic element 1750. In some embodiments, the glue includes, but is not limited to, a gel type, an organosilicon type, an acrylic type, a urethane type, a rubber type, an epoxy type, a hot-melt type, a light-curing type, etc., and preferably, the glue is an organosilicon bonding type glue, or an organosilicon class glue.

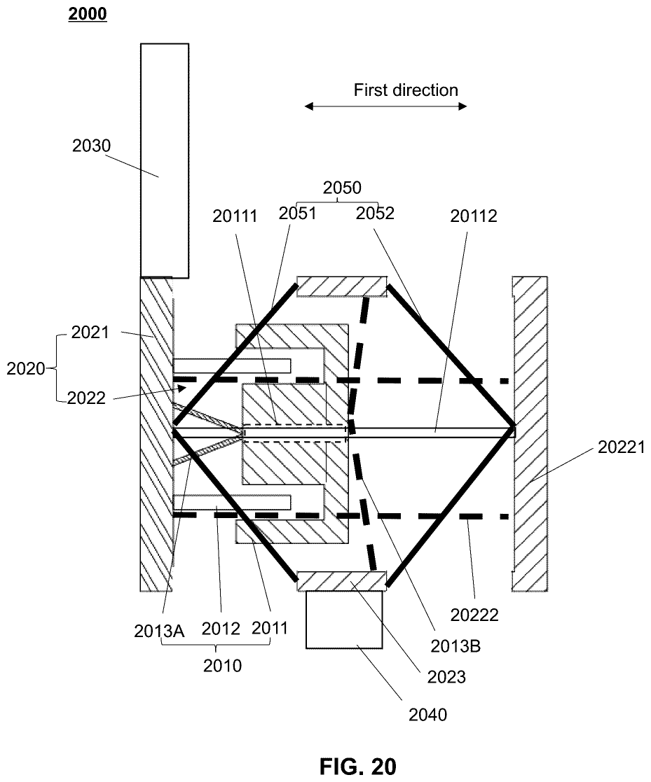

FIG. 20 is a schematic diagram illustrating a structure of an acoustic output device according to some embodiments of the present disclosure.

As shown in FIG. 20, an acoustic output device 2000 includes a transducer 2010, a housing 2020, a support structure 2030, and an additional element 2040. The housing 2020 includes a panel 2021, a shell 2022, and a support member 2023. In some embodiments, the shell 2022 includes a back plate 20221 and a shell body 20222 (shown in dashed lines in the figure). In some embodiments, the shell body 20222 is a columnar structure that is internally hollow and has openings at both ends, and the panel 2021 and the back plate 20221 are disposed at both ends of the shell body 20222 that has the openings and realize rigidly connection through the shell body 20222. In some embodiments, the shell 2022 is an integrated structure, for example, the shell 2022 is a structure that is internally hollow with the opening at one end, and the panel 2021 is located at the end of the shell 2022 with the opening. In some embodiments, the support member 2023 is disposed independently outside the shell 2022 or independently inside the shell 2022. In some embodiments, the support member 2023 is a cylindrical structure, and the cylindrical structure is disposed around a sidewall (also referred to as the shell body 20222 or a connection member) on the shell 2022 adjacent to the panel 2021. In some embodiments, the shell body 20222 is a columnar body structure with openings at both ends, and the cylindrical structure is disposed around the shell body 20222. In some embodiments, the support member 2023 is independently disposed with respect to the shell 2022, the panel 2021 is rigidly connected to the shell 2022, the additional element 2040 is rigidly connected to the support member 2023, and the support member 2023 is connected to the shell 2022 or the panel 2021 through an elastic element 2050, so as to realize that the elastic element 2050 is in a vibration path where the additional element 2040 is connected to the panel 2021. The structures of the transducer 2010 (including the magnetic circuit assembly 2011, the coil 2012, and the vibration transmission sheet 2013A), the support structure 2030, the additional element 2040, etc., in the acoustic output device 2000 are similar to the structures of the transducer 10 (including the magnetic circuit assembly 11, the coil 12, and the vibration transmission sheet 13), the support structure 30, and the additional element 40, etc., in the acoustic output device 200, respectively, which are not described herein.

In some embodiments, the magnetic circuit assembly 2011 includes a hole portion 20111 and a positioning rod 20112. The hole portion 20111 runs through the magnetic circuit assembly 20111 along a vibration direction of the transducer 2010 (the first direction shown in FIG. 20), and one end of the positioning rod 20112 away from the panel 2021 is connected to the back plate 20221 in the shell 2022 that is opposite to the panel 2021, and the other end passes through the hole portion 20111 and is connected to the panel 2021. It should be noted that the positioning rod 20112 also plays a role in fixing the panel 2021 and the back plate 20221, and at this time, the shell body 20222 can be omitted, or the panel 2021 and the back plate 20221 can be connected to the shell body 20222 without being fixed. In some embodiments, the positioning rod 20112 and the shell body 20222 are also both disposed. For more descriptions of the hole portion 20111 and the positioning rod 20112, reference is made to the relevant descriptions of the hole portion 12111 and the positioning rod 12112 illustrated in FIG. 12, which are not repeated herein.

In some embodiments, the elastic element 2050 includes a first elastic element 2051 and a second elastic element 2052. One end of the support member 2023 is connected to the panel 2021 through the first elastic element 2051, and the other end of the support member 2023 is connected to the sidewall (or the back plate 20221) in the shell 2022 that is positioned opposite to the panel 2021 through the second elastic element. In this way, a resonant system is formed by the first elastic element 2051, the second elastic element 2052, the support member 2023 and the additional element 2040 attached thereto, the panel 2021, the shell 2022, and structures rigidly connected to the panel 2021 or the shell 2022 (e.g., the coil 2012, the support structure 2030, etc.). It should be noted that when there are other structures rigidly attached to the panel 2021 or the shell 2022, and when there are other structures rigidly attached to the support member 2023, these structures are also considered to be a portion of the resonant system. The resonant system generates a resonance peak and a resonance valley in a target frequency range. In a frequency range greater than the resonant frequency corresponding to the resonance peak, the vibration transmitted between the additional element 2040 and the panel 2021 is suppressed, which means the effect of the additional element 2040 on the vibration of the panel 2021 is reduced, thereby ensuring that the sensitivity of the resonant system is not or less affected by the additional element 2040 in the frequency range greater than the resonant frequency corresponding to the resonance peak. In some embodiments, by setting the resonant frequency corresponding to the resonance peak at a lower frequency, the frequency range where the sensitivity of the acoustic output device 2000 decreases due to the additional element 2040 is reduced. In addition, in the frequency range greater than the resonant frequency corresponding to the resonance peak, the frequency response curve of the acoustic output device 2000 is flatter due to the less effect of the additional element 2040 on the vibration of the panel 2021, so as to ensure that the acoustic output device 400 has a better acoustic output effect in a wider frequency range, and improve a listening experience of a user. Moreover, by disposing the first elastic element 2051, the second elastic element 2052, and the support member 2023, a stable support for the additional element 2040 is realized, so as to reduce a swaying of the additional element 2040, and thereby avoiding an effect on the sensitivity of the acoustic output device 200. It should be noted that in some embodiments, it is also possible to have only the first elastic element 2051 or the second elastic element 2052.

In some embodiments, the shell body 20222 is a plate-like structure or a rod-like structure, and two ends of the shell body 20222 are rigidly connected to the panel 2021 and the back plate 20221, respectively. For example, the shell body 20222 has two plate-like structures, and the two ends of the two plate-like structures are rigidly connected to the panel 2021 and the back plate 20221, respectively.

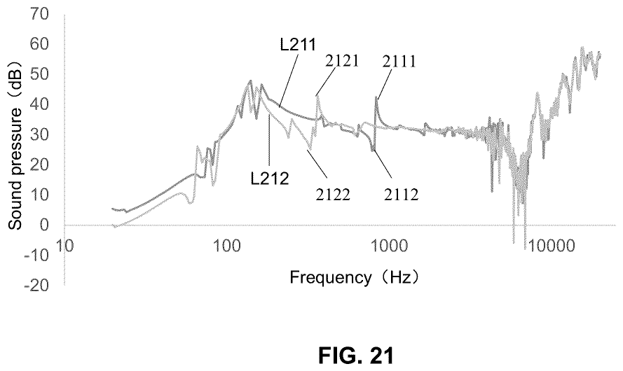

FIG. 21 is a curve diagram illustrating frequency response curves of acoustic output devices according to some embodiments of the present disclosure.

As shown in FIG. 21, a horizontal coordinate is frequency (Hz), a vertical coordinate is sound pressure (dB) corresponding to the acoustic output device at different frequencies. Curve L211 is a frequency response curve of the acoustic output device 2000 when a mass of the additional element 2040 in the acoustic output device 2000 is 0 (equivalent to the acoustic output device 2000 does not include the additional element 2040). In a frequency range of 200 Hz-2000 Hz, curve L211 has a resonance peak 2111 and a resonance valley 2112. Curve L212 is the frequency response curve of the acoustic output device 2000 when the additional element 2040 of the acoustic output device 2000 has a certain mass. In a frequency range of 200 Hz-2000 Hz, the curve L212 has a resonance peak 2121 and a resonance valley 2122. Referring to the curves L211 and L212, it can be seen that, in the frequency range higher than the resonant frequency corresponding to the resonance peak, the acoustic output device 2000 has a relatively flat frequency response curve, at which time the acoustic output device 2000 is capable of outputting better sound quality. In addition to this, from the resonant frequency corresponding to the resonance peak 2121 is smaller than the resonant frequency corresponding to the resonance peak 2111, it can be seen that the resonant frequency of the acoustic output device is negatively correlated with the mass of the additional element, i.e., as the mass of the additional element 2040 increases, the resonant frequency corresponding to the resonance peak of the acoustic output device 2000 becomes lower (the closer it is to the lower frequency). In some embodiments, the acoustic output device 2000 is able to have a flat frequency response curve in a wider frequency range by adjusting the mass of the additional element 2040 (e.g., increasing the mass of the additional element 2040).

In some embodiments, as shown in FIG. 20, the first elastic element 2051 and the second elastic element 2052 each has a reed structure. The first elastic element 2051 and the second elastic element 2052 are disposed on both sides of the transducer 2010 along its vibration direction, respectively. A side of the first elastic element 2051 facing the panel 2021 is connected to the panel 2021, and a circumferential side of the first elastic element 2051 is connected to one end of the support member 2023. The side of the second elastic element 2051 depart from the transducer 2010 is connected to a sidewall (the back plate 20221) of the shell 2022 opposite to the panel 2021. In some embodiments, the support structure 2030 is rigidly connected to the support member 2023, or rigidly connected to the panel 2021 or the back plate 20221.

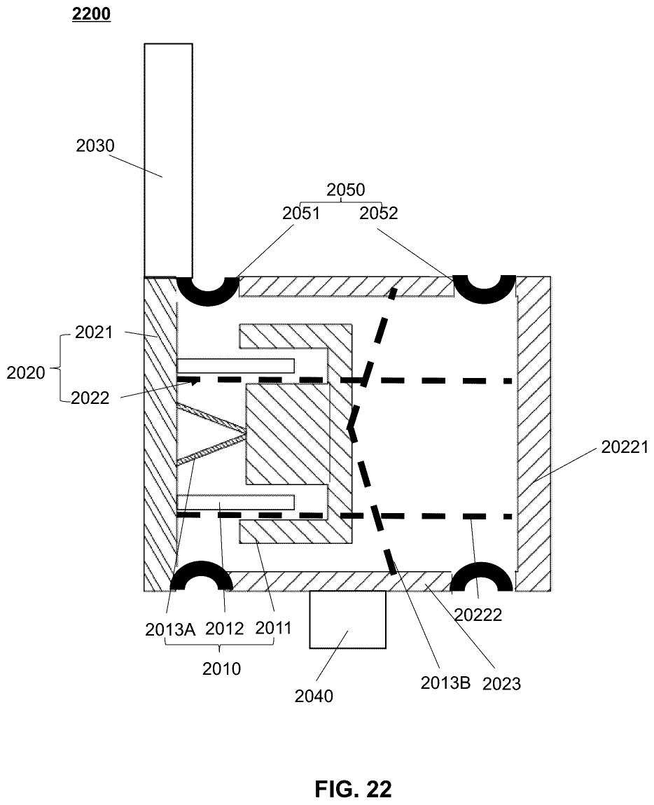

FIG. 22 is a schematic diagram illustrating a structure of an acoustic output device according to some embodiments of the present disclosure.

In some embodiments, as shown in FIG. 22, the first elastic element 2051 and the second elastic element 2052 in the acoustic output device 2200 each has a ring structure with elasticity. The first elastic element 2051 and the second elastic element 2052 are disposed at each end of the support member 2023. One end of the support member 2023 is connected to the panel through the first elastic element 2051, and the other end of the support member 2023 is connected to a sidewall (or the back plate 20221) of the shell 2022 opposite to the panel 2021 through the second elastic element. As an example, the support member 2023 is a structure (e.g., a sleeve structure) that is internally hollow and has openings at both ends. An inner contour of the ring structure is connected to the panel 2021 as well as a circumferential side of the back plate 20221, and an outer contour of the ring structure is connected to the openings at both ends of the support member 2023. In some embodiments, the ring structure is made of an elastic material such as a silicone, a polyurethane, etc.

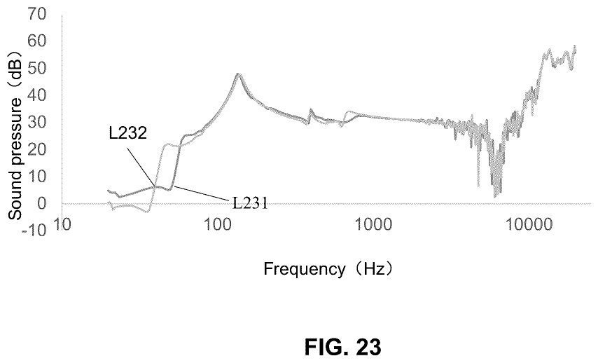

FIG. 23 is a curve diagram illustrating frequency response curves of acoustic output devices according to some embodiments of the present disclosure.

As shown in FIG. 23, a horizontal coordinate is frequency (Hz), a vertical coordinate is sound pressure (dB) corresponding to the acoustic output device at different frequencies, curve L231 is the frequency response curve of the acoustic output device 2200 when a mass of the additional element 2040 is 2 g, and curve L232 is the frequency response curve of the acoustic output device 2200 when the mass of the additional element 2040 is 3.5 g. Referring to curves L231 and L232, it can be seen that a portion of curve L231 in a frequency range of 1000 Hz-5000 Hz and the portion of the curve L232 in the frequency range of 1000 Hz-5000 Hz are relatively flat and basically overlap. It can be seen that the sensitivity of the acoustic output device 2200 is not affected by the mass of the additional element 2040 in the frequency range of 1000 Hz to 5000 Hz.

In some embodiments, the first elastic element 2051 and the second elastic element 2052 are elastic glues. The first elastic element 2051 bonds one end of the support member 2023 to the panel 2021, and the second elastic element 2052 bonds the other end of the support member 2023 to the back plate 20221. In some embodiments, the glue includes, but is not limited to, a gel type, an organosilicon type, an acrylic type, a urethane type, a rubber type, an epoxy type, a hot-melt type, a light-curing type, etc., and preferably, is a silicone bonding type glue, organosilicon type glue.

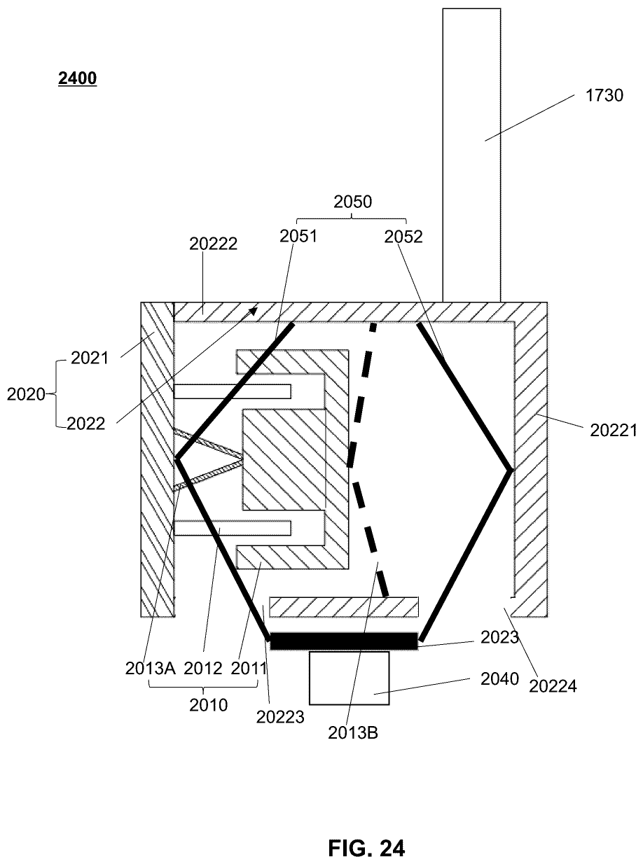

FIG. 24 is a schematic diagram illustrating a structure of an acoustic output device according to some embodiments of the present disclosure. As shown in FIG. 24, in some embodiments, the support member 2023 in an acoustic output device 2400 is a plate-like structure, and the plate-like structure is disposed independently with respect to the shell 2022. The additional element 2040 is rigidly connected to the plate-like structure. One end of the plate-like structure is connected to the panel 2021 through the first elastic element 2051, and the other end of the plate-like structure is connected to a sidewall (the back plate 20221) of the shell 2022 opposite to the panel 2021 through the second elastic element 2052. In some embodiments, the first elastic element 2051 and the second elastic element 2052 in the acoustic output device 2400 each has a reed structure, as shown in FIG. 24. As an example, when the support member 2023 is independently disposed on an outer side of the shell 2022, a sidewall in the shell body 20222 facing the support member 2023 is disposed with a first gap 20223 and a second gap 20224 for the reed structures to pass through. One end of the first elastic element 2051 proximate to the panel 2021 is connected to the panel 2021, a circumferential side of the first elastic element 2051 disposed within the shell 2022 is connected to other sidewalls of the shell body 20222, and the circumferential side of the first elastic element 2051 is connected to one end of the support member 2023 through the first gap 20223. A side of the second elastic element 2052 departs from the transducer 2010 is connected to the back plate 20221, the circumferential side of the second elastic element 2052 within the shell 2022 is connected to other sidewalls of the shell body 20222, and the circumferential side of the second elastic element 2052 is connected to the other end of the support member 2023 through the second gap 20224. In some embodiments, when the support member 2023 is disposed independently in the inner side of the shell 2022, the first gap 20223 and the second gap 20224 for a reed structure to pass through are not disposed on the sidewall of the shell body 20222 that faces the support member 2023. In other embodiments, a notch for placing the support member 2023 is disposed at the shell body 20222. The support member 2023 is elastically connected to the shell 2022 or the panel 2021 through the first elastic element 2051 and second elastic element 2052, or connected to the shell body 20222 through the elastic element or the glue. For example, the support member 2023 is disposed with the elastic element (e.g., a reed, a ring structure with elasticity) on the circumferential side of the support member 2023, and the support member 2023 is elastically connected to the shell body 20222 through the elastic element. For another example, the circumferential side of the support member 2020 and the shell body 20222 are bonded by glue, with a cured glue acting as the elastic element.

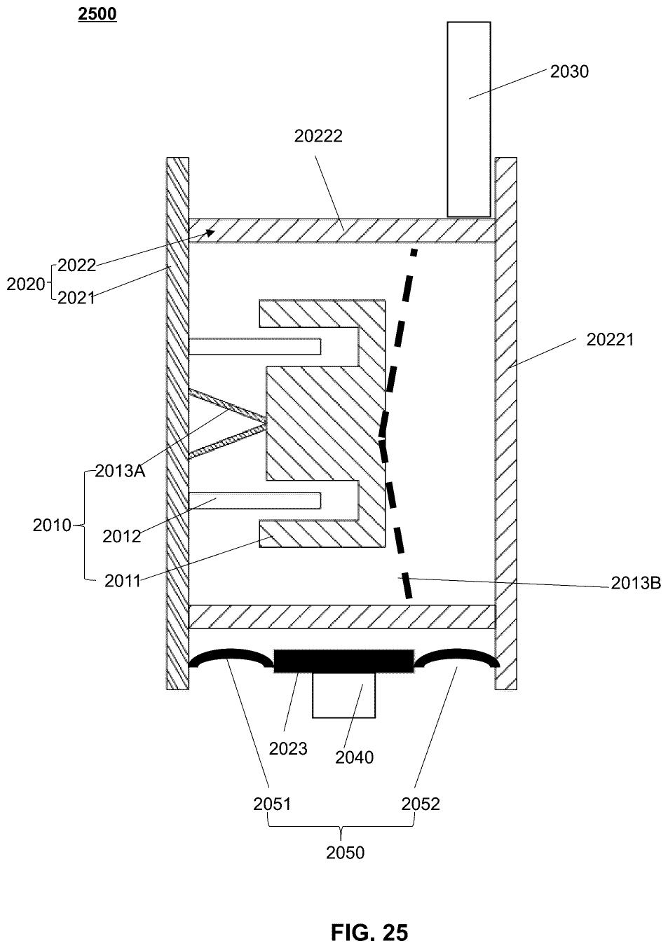

FIG. 25 is a schematic diagram illustrating a structure of an acoustic output device according to some embodiments of the present disclosure.

As shown in FIG. 25, in some embodiments, the support member 2023 in the acoustic output device 2500 is a plate-like structure, and the first elastic element 2051 and the second elastic element 2052 are springs, reeds, film structures, etc. As an example, the first elastic element 2051 and the second elastic element 2052 are respectively disposed at both ends of the plate-like structure. One end of the plate-like structure is connected to the panel 2021 through the first elastic element 2051, and the other end of the plate-like structure is connected to the back plate 20221 through the second elastic element 2052. In some other embodiments, a notch for placing the support member 2023 is disposed at the shell body 20222, and the support member 2023 is elastically connected to the shell 2022 or the panel 2021 through the first elastic element 2051 and the second elastic element 2052, or the support member 2023 is connected to the shell body 20222 through an elastic element or a glue. For example, the support member 2023 is disposed with the elastic element (e.g., the reed, the ring structure with elasticity) on a circumferential side of the support member 2023, and the support member 2023 is elastically connected to the shell body 20222 through the elastic element. For another example, the circumferential side of the support member 2023 and the shell body 20222 are bonded by glue, with the cured glue acting as the elastic element.

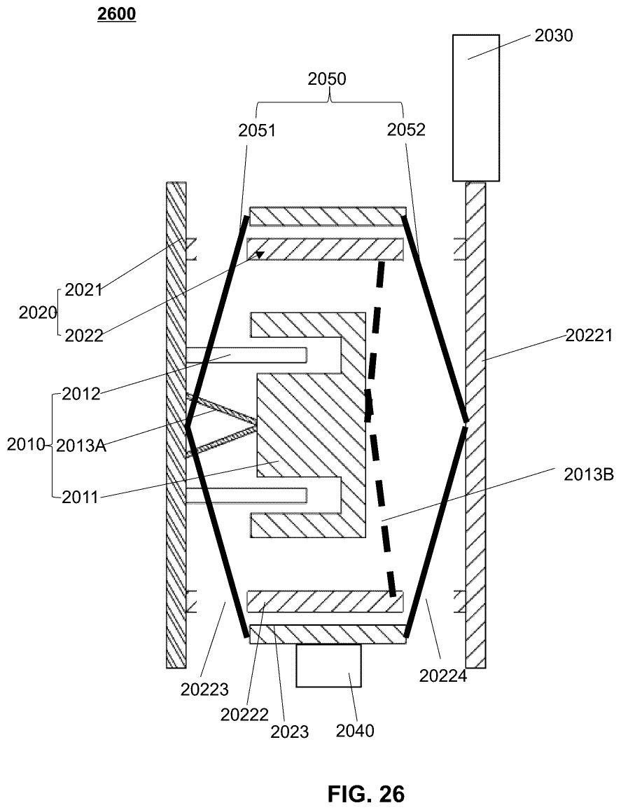

FIG. 26 is a schematic diagram illustrating a structure of an acoustic output device according to some embodiments of the present disclosure. As shown in FIG. 26, in some embodiments, the support member 2023 in an acoustic output device 2600 is a cylindrical structure, and the cylindrical structure is socketed to an exterior of the shell body 20222. The additional element 2040 is rigidly connected to the cylindrical structure. One end of the cylindrical structure is connected to the panel 2021 through the first elastic element 2051, and the other end of the cylindrical structure is connected to the back plate 20221 through the second elastic element 2052. In some embodiments, as shown in FIG. 26, the first elastic element 2051 and the second elastic element 2052 in the acoustic output device 2600 each has a reed structure. As an example, when the cylindrical structure is socketed on the outside of the shell body 20222, the shell body 20222 is disposed with a first gap 20223 and a second gap 20224 for the reed structure to pass through. A side of the first elastic element 2051 proximate to the panel 2021 is connected to the panel 2021, and a circumferential side of the first elastic element 2051 passes through the first gap 20223 to be connected to the support member 2023. A side of the second elastic element 2052 departing from the transducer 2010 is connected to the back plate 20221, and the circumferential side of the second elastic element 2052 is connected to the other end of the support member 2023 through the second gap 20224. In some embodiments, when the sleeve structure is disposed on the inner side of the shell 2022, the first gap 20223 and the second gap 20224 for the reed structure to pass through are not disposed on the shell body 20222.

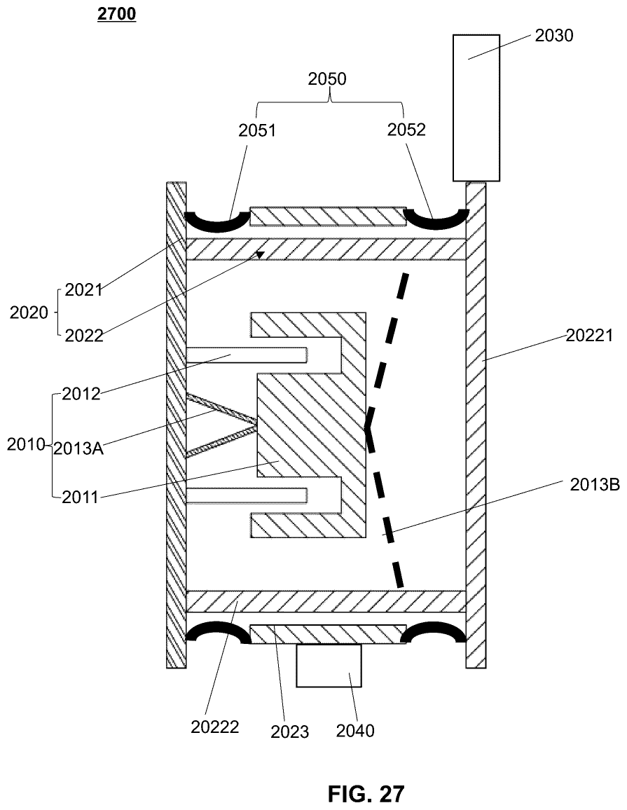

FIG. 27 is a schematic diagram illustrating a structure of an acoustic output device according to some embodiments of the present disclosure. As shown in FIG. 27, in some embodiments, the support member 2023 in the acoustic output device 2700 is a cylindrical structure, and the first elastic element 2051 and the second elastic element 2052 each has a ring structure with elasticity. As an example, the first elastic element 2051 and the second elastic element 2052 are respectively disposed at two ends of the cylindrical structure. An inner contour of the first elastic element 2051 is connected to a circumferential side of the panel 2021. An outer contour of the first elastic element 2051 is connected to one end of the cylindrical structure, the inner contour of the second elastic element 2052 is connected to the circumferential side of the back plate 20221, and the outer contour of the second elastic element 2052 is connected to the other end of the cylindrical structure.

In some embodiments, a vibration transmission layer is covered on an outer sidewall of the panel 2021 or the shell 2022 in the acoustic output device 2700. The vibration transmission layer is used to contact a skin of a user, i.e., the outer sidewall of the panel 2021 or the shell contacts the skin of the user through the vibration transmission layer. In some embodiments, the Shore hardness of the vibration transmission layer is less than the Shore hardness of the outer sidewall of the panel 2021 or the shell 2022, i.e., the vibration transmission layer is softer than the outer sidewall of the panel 2021 or the shell 2022. In some embodiments, the vibration transmission layer is made of a soft material such as silicone, and the outer sidewall of the panel 2021 or the shell 2022 is made of a hard material such as a polycarbonate, a fiberglass reinforced plastic. In this way, the wearing comfort of the acoustic output device 2700 is improved, and the acoustic output device 2700 fits more closely to the skin of the user, which in turn improves the sound quality of the acoustic output device 2700. In some embodiments, the vibration transmission layer is removably connected to the outer sidewall of the panel 2021 or the shell 2022 to for user replacement. It should be noted that covering the vibration transmission layer on the outer sidewall of the panel or the shell is applicable not only to the acoustic output device 2700, but also to the acoustic output devices in other embodiments of the present disclosure, for example, the acoustic output device 400 shown in FIG. 4, the acoustic output device 700 shown in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

In the acoustic output devices 2000, 2200, 2400, 2500, 2600, and 2700, the magnetic circuit assembly 2011 and the panel 2021 are connected to each other by the vibration transmission sheet 2013A, which may cause a situation that the magnetic circuit assembly 2011 and the additional element 2040 attract or repel each other and cause the magnetic circuit assembly to flip and deform, thereby affecting the vibration stability of the transducer 2010. To avoid the magnetic circuit assembly 2011 and the additional element 2040 attracting or repelling each other and causing the magnetic circuit assembly 2011 to flip and deform, which affects a vibration stability of the transducer 2010, in some embodiments, the vibration transmission sheet 2013A between the magnetic circuit assembly 2011 and the panel 2021 is replaced with the vibration transmission sheet 2013B (shown as dotted lines in FIGS. 20, 22, 24, 25, 26, and 27), or in some embodiments of the present disclosure, both the vibration transmission sheets 2013A and 2013B are included in the acoustic output devices 2000, 2200, 2400, 2500, 2600, and 2700, through the support of the vibration transmission sheets 2013A and 2031 B to the magnetic circuit assembly 2011, the vibration of the transducer 2010 is more stable. In some embodiments, the vibration transmission sheet 2013A and the vibration transmission sheet 2013B each include a center region and a plurality of support rods. The plurality of support rods are spaced apart along a circumferential side of the center region. The center region is connected to a side of the magnetic circuit assembly away from the panel, and an end of each support rod away from the center region is connected to the shell. Merely by way of example, there are four support rods, at which point structures of the vibration transmission sheet 2013A and the vibration transmission sheet 2013B are approximately regarded as an “X structure”. The X structure provides elasticity on a vibration direction of the transducer. In addition, the plurality of support rods have high structural strengths in a direction perpendicular to the vibration direction of the transducer, which provides a high support effect for the magnetic circuit assembly 2011, thereby ensuring that the transducer flips and deforms when vibrating. In some embodiments, the vibration transmission sheet plate 2013A and vibration transmission sheet plate 2013B further include an edge region. The edge region is connected to an end of the support rod away from the center region, and the circumferential side of the edge region is connected with the shell. Regarding the specific structure of the vibration transmission sheet, reference is made elsewhere in the present disclosure, for example, to FIG. 46 and FIG. 47 and their related descriptions.

As an example, as shown in FIGS. 24 and 25, the support member 2023 is a plate-like structure, the vibration transmission sheet 2013B is disposed between the magnetic circuit assembly 2011 and the sidewall (i.e., the back plate 20221) of the shell 2022 opposite to the panel 2021. One side of the vibration transmission sheet 2013B is connected to the side of the magnetic circuit assembly 2011 departs from the panel 2021, and the vibration transmission sheet 2013B is connected to the shell body 20222 through the circumferential side of the vibration transmission sheet 2013B. As shown in FIGS. 26 and 27, when the support member 2032 is the cylindrical structure, one side of the vibration transmission sheet 2013B is connected to the side of the magnetic circuit assembly 2011 departs from the panel 2021, and the circumferential side of the vibration transmission sheet 2013B is connected to the shell body 20222. Here, the vibration transmission sheet 2013B is disposed between the magnetic circuit assembly 2011 and the sidewall on the shell 2022 opposite to the panel 2021, and the vibration transmission sheet 2013B connects to the sidewall with the additional element 2040, thereby providing support for the magnetic circuit assembly 2011 and the additional element 2040 in a direction of a relative movement of the magnetic circuit assembly 2011 and the additional element 2040. The vibration transmission sheet 2013B strengthens the support effect on the position of the magnetic circuit assembly 2011 close to the additional element 2040, and improves the vibration stability of the transducer, in particular of the magnetic circuit assembly 2011. To further improve the vibration stability of the energy transducer 2010, the acoustic output devices 2000, 2200, 2400, 2500, 2600, or 2700 include both the vibration transmission sheet 2013A and the vibration transmission sheet 2013B.

It should be noted that the two ends of the support member 2023 shown in FIG. 20 or FIG. 22 are rigidly connected to the panel 2021 and the back plate 20221 respectively, and the additional element 2040 is connected to the support member 2023 by glue. The glue, after solidifying, has a certain degree of elasticity and plays the same role as the elastic element 2050. In some embodiments, the glue includes, but is not limited to, a gel type, an organosilicon type, an acrylic type, a urethane type, a rubber type, an epoxy type, a hot-melt type, a light-curing type, etc., and preferably, is an organosilicon bonding type glue, an organosilicon class glue.

In the acoustic output device disposed by the embodiments of the present disclosure, the additional element is connected to the panel through a vibration path including at least one elastic element, so as to solve the problem of a decrease in the sensitivity of a bone conduction acoustic output device due to the additional element mounted on the acoustic output device. However, when the additional element disposed on the basis of the bone conduction speaker is an air conduction speaker, sound leakage of the acoustic output device is also increased. Specifically, when the additional element is the air conduction speaker, a mechanical vibration generated by the transducer drives a diaphragm inside the air conduction speaker to vibrate so that the sound leakage generated by the acoustic output device comes not only from an air vibration outside the acoustic output device driven by the shell, but also from the vibration generated by the vibration of the diaphragm in the air conduction speaker caused by the transducer, which increases an overall sound leakage of the speaker, and results in a reduced listening experience of the user. The effect of the acoustic output device 200 when the additional element 40 is the air conduction speaker on the sound leakage is described in detail below combining the sound leakage frequency response curves of the bone conduction acoustic output device 100 and the acoustic output device 200 when the additional element 40 is the air conduction speaker.

FIG. 28 is a curve diagram illustrating sound leakage frequency response curves of acoustic output devices according to some embodiments of the present disclosure. As shown in FIG. 28, a horizontal coordinate indicates frequency (Hz), a vertical coordinate indicates sound leakage pressure (dB) of the acoustic output device at different frequencies. Curve L281 is a sound leakage frequency response curve of the acoustic output device 200 measured at a sidewall of the shell 22 adjacent to the panel 21. Curve L282 is a sound leakage frequency response curve of the acoustic output device 200 measured at the sidewall of the shell 22 adjacent to the panel 21 when the additional element 140 is the air conduction speaker and the vibration direction of a diaphragm of the air conduction speaker is parallel to the vibration direction of the transducer 10. Curve L283 is a sound leakage frequency response curve of the acoustic output device 200 measured at the sidewall of the shell 22 adjacent to the panel 21 when the additional element 140 is the air conduction speaker and the vibration direction of a diaphragm of the air conduction speaker is approximately perpendicular to the vibration direction of the transducer 10. The sound leakage frequency response curves of the acoustic output device 100 as well as the acoustic output device 200 are measured by detecting the air conduction sound at the sidewall of the shell adjacent to the panel 21 of the acoustic output device 100 or the acoustic output device 200, which is also applied to a collection of the sound leakage frequency response curves for other speakers in embodiments of the present disclosure. Referring to curves L281 and L282, it can be seen that when the vibration direction of the diaphragm in the air conduction speaker is parallel to the vibration direction of the transducer 10, the sound pressure of the sound leakage of the speaker 200 is overall higher than that of the bone conduction speaker 100 in a medium-high frequency band (5000 Hz-10000 Hz). It can be seen that when an air conduction speaker is disposed on the basis of the bone conduction speaker, if the vibration direction of the diaphragm in the air conduction speaker is parallel to the vibration direction of the transducer, the sound leakage of the acoustic output device is increased. Referring to the curve L281, the curve L282, and the curve L283, it can be seen that when the vibration direction of the diaphragm in the air conduction speaker is approximately perpendicular to the vibration direction of the transducer 10, the sound leakage pressure of the acoustic output device 200 is lower than the sound leakage pressure of the bone conduction acoustic output device 100 in the medium-high frequency band (500 Hz to 10,000 Hz) or the same as the sound leakage pressure of the bone conduction speaker 100. It can be seen that when the air conduction speaker is disposed on the basis of the bone conduction speaker, it is beneficial to reduce the sound leakage of the acoustic output device if the vibration direction of the diaphragm of the air conduction speaker is approximately perpendicular to the vibration direction of the transducer.

Based on the above problem that setting the air conduction speaker on the basis of the bone conduction speaker can increase the sound leakage of the acoustic output device, embodiments of the present disclosure provide an acoustic output device. The vibration direction of the transducer in the acoustic output device is approximately perpendicular to the vibration direction of the diaphragm of the air conduction speaker. The approximate perpendicular is interpreted as an angle formed between the vibration direction of the transducer and the vibration direction of the diaphragm of the air conduction speaker being in a range of 75°-100°, which effectively reduces the sound leakage of the acoustic output device and ensures that the user has a better listening experience. The following will provide a specific explanation in conjunction with the acoustic output device 400 shown in FIG. 4.

As shown in FIG. 4, the additional element in the acoustic output device 400 is an air conduction speaker. The air conduction speaker includes the diaphragm 441, and the diaphragm 441 vibrates driven by the transducer in the air conduction speaker to drive the air to vibrate so that the user hears the air conduction sound. A second direction shown in FIG. 4 is the vibration direction of the transducer 410, and a first direction is the vibration direction of the diaphragm 441. To prevent the air conduction speaker from increasing the sound leakage of the acoustic output device 400, in some embodiments, an angle a formed by the first direction and the second direction is in a range of 75°-100°. Preferably, the angle a formed by the first direction and the second direction is in a range of 80°-95°. For example, the angle a formed by the first direction and the second direction is 90°.

As shown in FIG. 4, in some embodiments, the air conduction speaker is disposed on the sidewall of the shell 422 adjacent to the panel 421 (also referred to as the shell body).

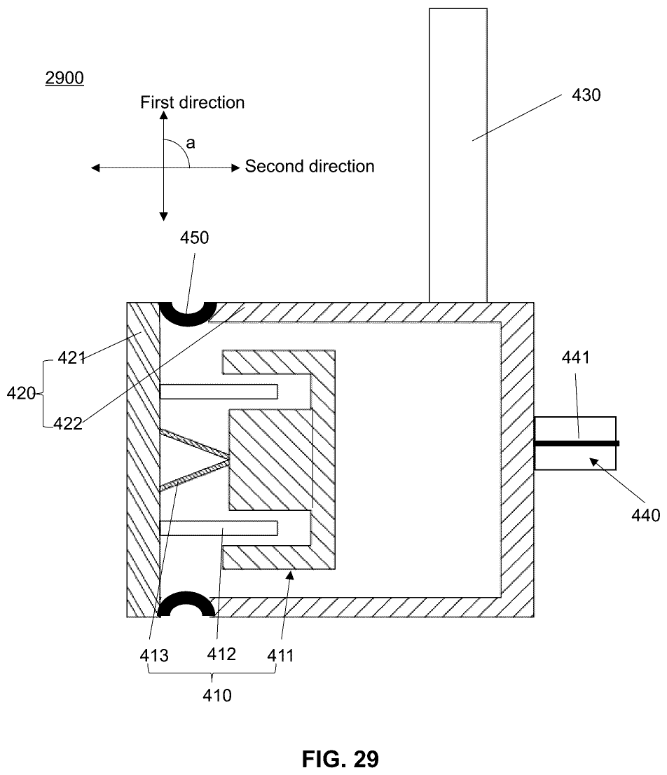

FIG. 29 is a schematic diagram illustrating a structure of an acoustic output device according to some embodiments of the present disclosure. As shown in FIG. 29, in some embodiments, an air conduction speaker in an acoustic output device 2900 is disposed at a sidewall (or referred to as a back plate) of the shell 422 opposite to the panel.

It should be noted that when the additional element is an air conduction speaker, a certain angle is formed between a vibration direction of a diaphragm of the air conduction speaker and the vibration direction of a transducer to reduce a sound leakage of the acoustic output device, which is applied not only to the acoustic output device 400, but also to other acoustic output devices disposed in the embodiments of the present disclosure. For example, the acoustic output device 700 shown in FIG. 7, the acoustic output device 900 shown in FIG. 9, the acoustic output device 1200 shown in FIG. 12, the acoustic output device 1300 shown in FIG. 13, and the acoustic output device 1500 shown in FIG. 15, etc. In addition, when the additional element is a device such as a vibration sensor, an inertial acceleration sensor, a microphone, etc., that is sensitive to a certain vibration direction, it is possible to make the vibration direction to which the device is sensitive and the vibration direction of the transducer have a certain angle (e.g., 75°-100°), so as to avoid that an operation of the device to be affected by the vibration of the transducer of the acoustic output device. Also, in some embodiments, the additional element is other components or structures that is insensitive to the vibration direction, such as a circuit board, a battery, etc., which is disposed at any position of the shell.

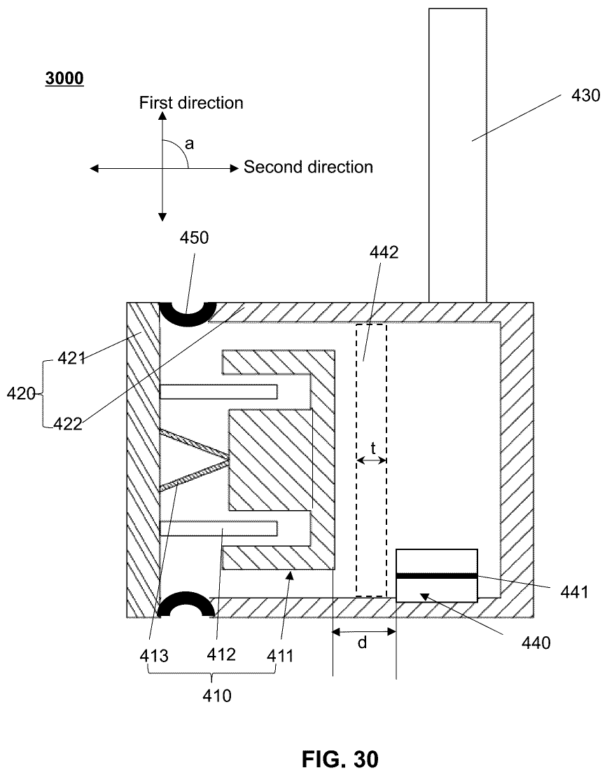

FIG. 30 is a schematic diagram illustrating a structure of an acoustic output device according to some embodiments of the present disclosure. To reduce the overall volume of an acoustic output device 3000, the additional element is disposed inside the shell 422, as shown in FIG. 30. When the additional element is disposed inside the shell 422, the additional element is rigidly connected to an inside of a sidewall of the shell 422 that is adjacent to or opposite to the panel 421. In some embodiments, when the additional element is an air conduction speaker, the shell 422 is disposed with a sound conduction hole (not shown in the figure), and the sound conduction hole outputs a sound generated by the air conduction speaker to an external environment.

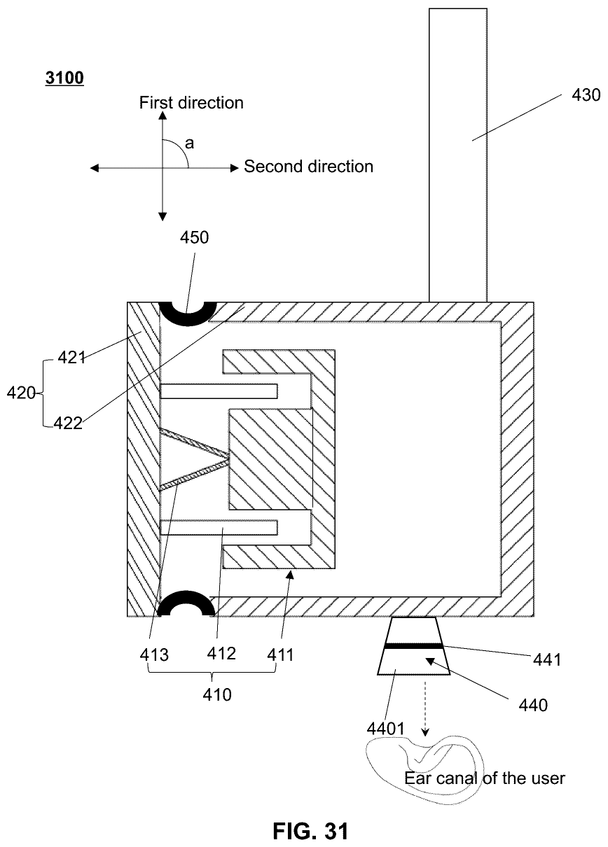

A magnetic circuit assembly of the transducer 410 is a magnet. When the additional element is a component that is sensitive to a vibration direction (e.g., an air conduction speaker, an air conduction microphone, etc.), and when the air conduction speaker is disposed in the shell 422 and is close to the transducer, a problem that the air conduction speaker and a magnetic field of the transducer 410 interfere with each other occurs. Here, the air conduction speaker is illustrated by way of example, and as shown in FIG. 31, in some embodiments, there is a spacing d between the air conduction speaker and the transducer 410 along the vibration direction of the diaphragm 441 in the air conduction speaker. In some embodiments, the greater the spacing d is, the smaller the magnetic field between the air conduction speaker and the transducer 410 interferes with each other. In some embodiments, the spacing d is no less than 0.8 mm. In some embodiments, the spacing d is no less than 1 mm. In some embodiments, the spacing d is no less than 1.2 mm.

To avoid the problem that the magnetic field of the air conduction speaker and the transducer 410 interfere with each other, in some embodiments, there is a separator 442 between the air conduction speaker and the transducer 410. The air conduction speaker and the transducer 410 are disposed on each side of the separator 442. In some embodiments, the separator 442 is a plate-like structure. The greater the thickness t of the separator 442, the less the magnetic fields between the air conduction speaker and the transducer 410 interfere with each other. In some embodiments, the thickness t of the separator 442 is no less than 0.8 mm. In some embodiments, the thickness t of the separator 442 is no less than 1 mm. In some embodiments, the thickness t of the separator 442 is no less than 1.2 mm. In some embodiments, to further reduce an overall size of the acoustic output device 3100, other components (e.g., batteries, circuit boards, etc.) in the acoustic output device 3000 is also disposed as the separator 442 between the transducer 410 and the air conduction speaker.

It should be noted that the air conduction speaker is disposed inside the shell so that there is a certain distance between the air conduction speaker and the transducer in the vibration direction of the diaphragm and/or a separator is disposed between the air conduction speaker and the transducer is also applicable to the acoustic output devices in other embodiments of the present disclosure. For example, the acoustic output device 700 shown in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

FIG. 31 is a schematic diagram illustrating a structure of an acoustic output device according to some embodiments of the present disclosure. As shown in FIG. 31, when a user wears an acoustic output device 3100, a sound outlet 4401 of an air conduction speaker faces an ear canal of a user. In this way, it is possible to enable the air conduction sound output from the air conduction speaker to transmit directly into the ear canal of the user, so as to ensure that the sound output from the air conduction speaker has a sufficient volume to be heard by the user.

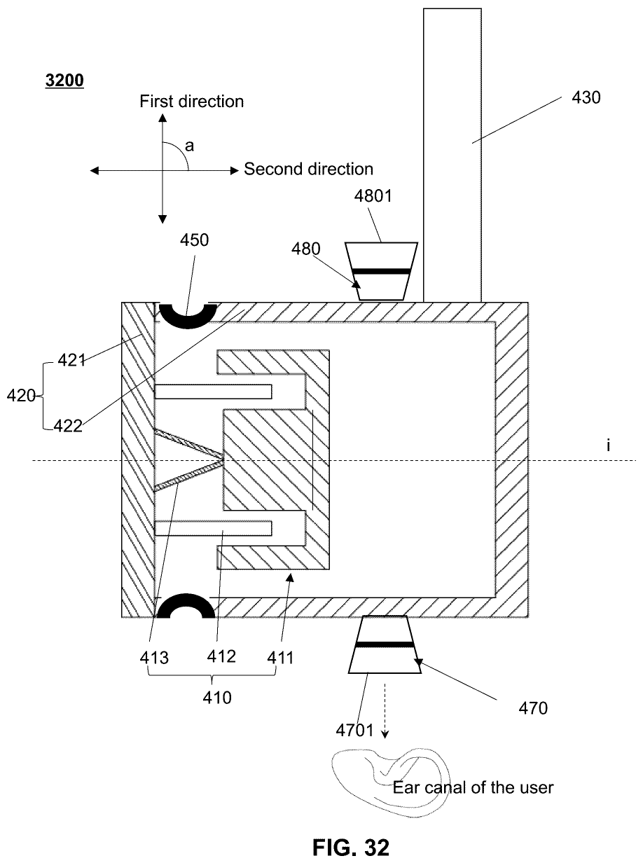

FIG. 32 is a schematic diagram illustrating a structure of an acoustic output device according to some embodiments of the present disclosure. As shown in FIG. 32, in an acoustic output device 3200, the air conduction speaker includes a first air conduction speaker 470 and a second air conduction speaker 480. The first air conduction speaker 470 and the second air conduction 480 are distributed on two sides of the shell 422, and the first air conduction speaker 470 and the second air conduction speaker 480 are disposed approximately symmetrically about an axis of symmetry i of the transducer 410, which avoids causing the acoustic output device 3200 to sway due to an asymmetry of the additional masses and affects a sound quality of the acoustic output device 3200. In some embodiments, when a user wears the acoustic output device 3200, a sound outlet 4701 of the first air conduction speaker 470 faces an ear canal of a user, and a sound outlet 4801 of the second air conduction speaker 480 departs from the ear canal of the user. In this way, the air conduction sound output from the first air conduction speaker 470 is directly transmitted to the ear canal of the user, so as to avoid the sound output from the second air conduction speaker 480 from interfering with the air conduction sound output from the first air conduction speaker 470, and enable the sound output from the first air conduction speaker 470 to have a sufficient volume to be heard by the user. In some embodiments, phases of sound waves output from the first air conduction speaker 470 and the sound waves output from the second air conduction speaker 480 satisfy a particular condition (e.g., opposite or nearly opposite). The sound waves output from the sound outlet 4701 of the first air conduction speaker 470 and the sound waves output from the sound outlet 4801 of the second air conduction speaker 480 are approximately considered to be two-point sound sources. At a position away from an ear canal opening of a human body, the sound waves output from the second air conduction speaker 480 can be cancelled out with the sound waves output from the first air conduction speaker 470 to reduce a volume of sound leakage from the acoustic output device 400 in a far field. In some embodiments, the second air conduction speaker 480 is replaced by other additional components such as batteries, circuit boards, transducers, etc., which, along with the first air conduction speaker 470, are approximately symmetrical about an axis of symmetry of the transducer 410.

It should be noted that the air conduction speaker including the first air conduction speaker 470 and the second air conduction speaker 480 are equally applicable to the acoustic output device in other embodiments of the present disclosure, e.g., the acoustic output device 700 illustrated in FIG. 7, The acoustic output device 900 shown in FIG. 9, the acoustic output device 1200 shown in FIG. 12, the acoustic output device 1300 shown in FIG. 13, the acoustic output device 1500 shown in FIG. 15, etc.

In conjunction with FIG. 5, it is shown that the acoustic output device 400 is capable of having a flat frequency response curve in a medium-high frequency band (in a frequency range above the resonant frequency corresponding to the resonance peak), i.e., the bone conduction sound output by the acoustic output device 400 in the medium-high frequency band has a good sound quality. Thus, to ensure that the acoustic output device 400 has a better acoustic output effect in a full frequency band, the additional element in the acoustic output device 400 is an air conduction acoustic output device, and a low frequency sound is output by the air conduction speaker. Furthermore, the acoustic output device 400 also includes a frequency division module. The frequency division module performs a frequency division process on an initial electrical signal based on a frequency division point to generate a medium-high frequency signal and a low frequency signal. The electrical signal with a frequency less than the frequency division point is a low frequency signal, and the electrical signal with a frequency higher than the frequency division point is a medium-high frequency signal. In some embodiments, the frequency division point is in a range of 200 Hz-800 Hz. Preferably, the frequency division point is in a range of 200 Hz-700 Hz. Further preferably, the frequency division point is in a range of 200 Hz-600 Hz. More preferably, the frequency division point is in a range of 300 Hz-500 Hz. The transducer 410 in the acoustic output device 400 outputs the bone conduction sound based on the medium high frequency signal, and the air conduction speaker outputs the air conduction sound based on the low frequency signal. Further, the transducer 410 generates a medium-high frequency vibration based on the electrical signal to drive the panel 421 to vibrate at the medium-high frequency. The panel 421 is able to transmit the medium-high frequency vibration to auditory nerves of the user through a bone conduction path by fitting with the user, so that the user can hear the bone conduction sound of the medium-high frequency. The transducer in the air conduction speaker is able to drive the diaphragm 441 to vibrate based on the low frequency signal. The diaphragm 441 drives the air to vibrate so that the user hears a low frequency air conduction sound. The low frequency air conduction sound and the medium-high frequency bone conduction sound enable the acoustic output device 400 to have a better acoustic output in the full frequency range. In some embodiments, the frequency division point corresponds to a frequency that is not less than a maximum value within a target frequency range. In some embodiments, the frequency corresponding to the frequency division point is not less than a resonant frequency corresponding to a resonance peak within the target frequency range. When the frequency division point is greater than the resonant frequency, the effect of the additional element (the air conduction speaker) on the sensitivity of the bone conduction speaker is small, which makes the bone conduction speaker to have a better acoustic output in the medium-high frequency band. At the same time, the air conduction speaker outputs the air conduction sound based on a low frequency signal to make up for an ineffective output of the bone conduction speaker at the low frequency band. In some embodiments, to enable the bone conduction speaker to have high sensitivity in a full sounding frequency band, a difference between the frequency division point and the resonant frequency is not less than 100 Hz. Preferably, the difference between the frequency division point and the resonant frequency is not less than 200 Hz. At this point, the sounds of the bone conduction speaker and the air conduction speaker also have overlap on a frequency domain. The frequency domain of the overlap portion is able to cover the resonant frequency corresponding to the resonance peak within the above target frequency range. At this point, although an introduction of the additional element reduces the sensitivity of the bone conduction speaker in a vicinity of the resonant frequency, the air conduction sound output by the air conduction acoustic output device in the vicinity of the resonant frequency is able to compensate for a shortcoming of the low sensitivity of the bone conduction speaker. With the combination of the bone conduction sound and the air conduction sound, the user is still able to significantly hear the sound near the resonant frequency.

It should be noted that the frequency division module is also applicable to the acoustic output devices in other embodiments of the present disclosure, such as the acoustic output device 700 shown in FIG. 7, the acoustic output device 900 shown in FIG. 9, the acoustic output device 1200 shown in FIG. 12, the acoustic output device 1300 shown in FIG. 13, the acoustic output device 1500 shown in FIG. 15, etc.

To solve the problem that when the additional element is disposed on the basis of the bone conduction speaker, the sensitivity of the acoustic output device decreases, and the magnetic circuit assembly in the transducer is subjected to attraction or repulsion of the additional element to flip and deform, resulting in a decrease in the vibration stability of the transducer, the embodiments of the present disclosure also provide an acoustic output device. In some embodiments, the acoustic output device includes a transducer, a housing, and an additional element. The transducer generates mechanical vibrations based on an electrical signal. The transducer includes a magnetic circuit assembly, a coil, and a vibration transmission sheet. The housing is used to accommodate the transducer, and the housing includes a panel and a shell. The transducer transmits the mechanical vibration to a user through the panel. In the acoustic output device disposed by embodiments of the present disclosure, the vibration transmission sheet has elasticity, the magnetic circuit assembly is elastically connected to the housing through the vibration transmission sheet, and the additional element is connected to the magnetic circuit assembly to remain elastically connected to the panel. For example, the magnetic circuit assembly is elastically connected to the panel through the vibration transmission sheet, so that the additional element can remain elastic connection with the panel when connected to the magnetic circuit assembly. For another example, the magnetic circuit assembly is connected to a sidewall (or referred to as a back plate) in the shell opposite to the panel through the vibration transmission sheet. For another example, there are a plurality of vibration transmission sheets, and the plurality of vibration transmission sheets include a first vibration transmission sheet and a second vibration transmission sheet. The magnetic circuit assembly is connected to the panel and the back plate through the first vibration transmission sheet and the second vibration transmission sheet, respectively, so that the additional element remains elastic connection with the panel when connected to the magnetic circuit assembly. The additional element is connected to the magnetic circuit assembly directly or indirectly. For example, the additional element is directly rigidly connected to the magnetic circuit assembly. For another example, both the additional element and the magnetic circuit assembly are rigidly connected to the shell. For another example, the acoustic output device further includes a support member. The additional element is rigidly connected to the support member, and the support member is rigidly connected to the magnetic circuit assembly. In the acoustic output device disposed in the embodiments of the present disclosure, the additional element is connected to the magnetic circuit assembly, so as to prevent the additional element and the magnetic circuit assembly from being attracted to each other or repelled by each other, causing the magnetic circuit assembly to flip and deform and affect the vibration stability of the transducer. In the acoustic output device disposed in the embodiment of the present disclosure, the additional element and the magnetic circuit assembly vibrate with respect to the panel to generate a resonance peak located within a target frequency range, which ensures that the sensitivity of the acoustic output device is not affected by the additional element in a range greater than the frequency corresponding to the resonance peak, so as to ensure that the sensitivity of the acoustic output device with the additional element is not affected by the additional element in a frequency range greater than the resonant frequency, thereby avoiding the decrease of the sensitivity of the bone conduction acoustic output device due to the additional element disposed on the bone conduction speaker. In addition, the acoustic output device provided in the embodiments of the present disclosure has a flatter frequency response curve in a frequency range greater than the resonant frequency corresponding to the resonance peak, which ensures that the acoustic output device has a better acoustic output effect, thereby improving the listening experience of the user. Further, when the transducer generates a low frequency (a frequency range below the resonant frequency corresponding to the resonance peak) mechanical vibration, the low frequency vibration of the panel (the vibration in a frequency range below the resonant frequency corresponding to the resonance peak) is transmitted to the additional element to drive the additional element to vibrate together, and the mass of the additional element increases the mass of a vibration load of the transducer, which affects the sensitivity of acoustic output device in the frequency range below the resonant frequency corresponding to the resonance peak (similar to the acoustic output device 200). When the transducer generates a high frequency (a range higher than the resonant frequency corresponding to the resonance peak) mechanical vibration, the high frequency vibration of the panel hardly vibrates the additional element due to the elastic connection (e.g., the presence of the vibration transmission sheet) between the additional element and the panel, and the elastic connection between the magnetic circuit assembly and the panel. The mass of the additional element has no effect on the vibration load mass of the transducer, thus ensuring that the sensitivity of the acoustic output device is not affected by the additional element in the frequency range above the resonant frequency corresponding to the resonance peak.

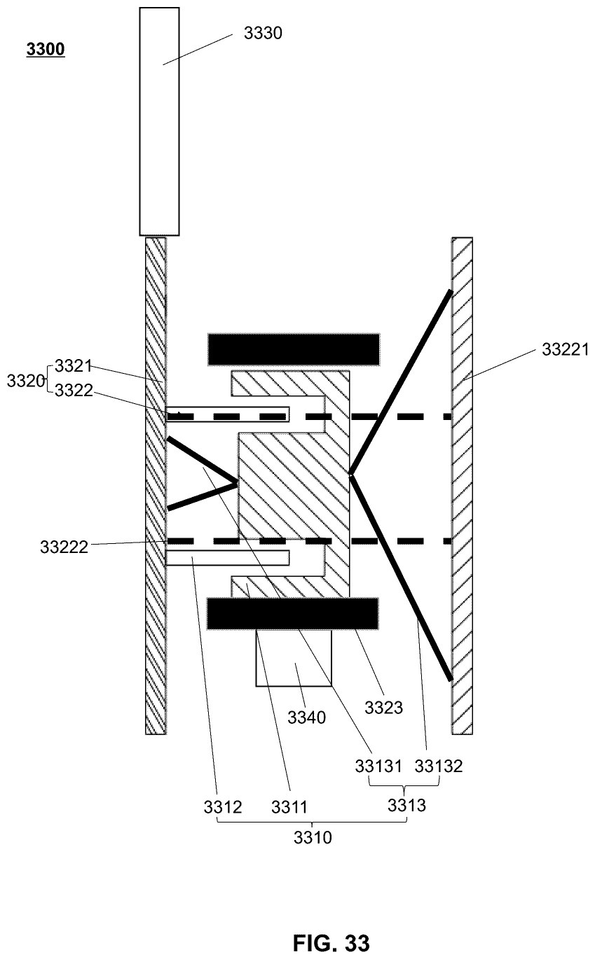

The acoustic output device disposed by the embodiments of the present disclosure is described in detail in the following combining FIGS. 33-46.

FIG. 33 is a schematic diagram illustrating a structure of an acoustic output device according to some embodiments of the present disclosure. As shown in FIG. 33, an acoustic output device 3300 includes a transducer 3310, a housing 3320, a support structure 3330, and an additional element 3340. The transducer 3310 includes a magnetic circuit assembly 3311, a coil 3312, and a vibration transmission sheet 3313. The coil 3312 is disposed in the magnetic circuit assembly 3311. The housing 3320 includes a panel 3321 and a shell 3322. The panel 3321 and the shell 3322 form an accommodation cavity for accommodating the transducer 3310, and the coil 3312 is connected to the panel 3321. Further, the shell 3322 includes a back plate 33221 positioned opposite to the panel 3321 and a shell body 33222 positioned adjacent to the panel 3321. The support structure 3330 is rigidly connected to the panel 3321. Structures of the magnetic circuit assembly 3311, the coil 3312, the panel 3321, the shell 3322 (including the back plate 33221 and the shell body 33222), the support member 3323, the support structure 3330, and the additional element 3340, etc., are similar to the structures of the magnetic circuit assembly 2011, the coil 2012, the panel 2021, the shell 2022 (including the back plate 20221 and the shell body 20222), the support member 2023, the support structure 2030, and the additional element 2040, respectively, of the acoustic output device 2000, which are not repeated herein.

In some embodiments, as shown in FIG. 33, the panel 3321 and the back plate 33221 are disposed at two ends of the shell body 33222 respectively, and are rigidly connected to the shell body 33222, so that the panel 3321 and the back plate 33221 vibrate together to reduce the generation of sound leakage. In some embodiments, the shell body 33222 is a columnar structure that is internally hollow and has openings at both ends. The panel 3321 and the back plate 33221 are located at both ends of the shell body 33222 with openings, and are rigidly connected through the shell body 33222. In some embodiments, the shell 3322 is an integrated structure, for example, the shell 3322 is a structure that is internally hollow and has the opening at one end. The panel 3321 is disposed at one end of the shell 3322 with the opening. In some embodiments, a notch (not shown in FIG. 33) is included at the shell body 33222, and a circumferential side of the magnetic circuit assembly 3311 protrudes from the notch to outside the shell body 3322 and is rigidly connected to the support member 3323, and the additional element 3340 is rigidly connected to the support member 3323. In this way, it is possible to make the support member 3323 have a better supporting effect on the magnetic circuit assembly 3311, so as to avoid that the magnetic circuit assembly 3311 is attracted to or repelled by the additional element 3340 and is subjected to flip and deformation, which affects the vibration stability of the transducer 3310.

The vibration transmission sheet 3313 includes a first vibration transmission sheet 33131 and a second vibration transmission sheet 33132. The first vibration transmission sheet 33131 is disposed between the magnetic circuit assembly 3311 and the panel 3321, and elastically connects the magnetic circuit assembly 3311 to the panel 3321. The second vibration transmission sheet 33132 is disposed between the magnetic circuit assembly 3311 and the back plate 33221, and elastically connects the magnetic circuit assembly 3311 to the back plate 33221. As an example, a side of the magnetic circuit assembly 3311 proximate to the panel 3321 is elastically connected to the panel 3321 through the first vibration transmission sheet 33131, and a side of the magnetic circuit assembly 3311 proximate to the back plate 3321 is elastically connected to the back plate 33221 through the second vibration transmission sheet 33132. In some embodiments, there is one vibration transmission sheet. For example, the vibration transmission sheet 3313 includes the first vibration transmission sheet 33131, and the magnetic circuit assembly 3311 is elastically connected to the panel 3321 through the first vibration transmission sheet 33131. For another example, the vibration transmission sheet 3313 includes a second vibration transmission sheet 33132, and the magnetic circuit assembly 3311 is elastically connected to the back plate 33221 through the second vibration transmission sheet 33132. In some embodiments, each of the first vibration transmission sheet 33131 and the second vibration transmission sheet 33132 includes a center region and a plurality of support rods. The plurality of support rods are spaced apart along a circumferential side of the center region. The center region is connected to a side of the magnetic circuit assembly 3311 away from the panel, and ends of the support rods away from the center region are connected to the shell. Merely by way of example, there are four support rods. At this point, structures of the first vibration transmission sheet 33131 and the second vibration transmission sheet 33132 are approximated as an “X”-shaped structure. The “X”-shaped structure provides an elasticity in a vibration direction of the transducer. In addition, the plurality of support rods have a higher structural strength in a direction perpendicular to the vibration direction of the transducer, which provides a high support effect for the magnetic circuit assembly 3311 to ensure that the transducer undergoes the flip deformation during the vibration thereof. In some embodiments, each of the first vibration transmission sheet 33131 and the second vibration transmission sheet 33132 further include an edge region. The edge region is connected to an end of the support rod away from the center region, and a circumferential side of the edge region is connected to the shell. For a specific structure of the vibration transmission sheet, reference may be made elsewhere in the present disclosure, for example, to FIG. 46 and FIG. 47 and their related descriptions.

In some embodiments, the additional element 3340 and the magnetic circuit assembly 3311 vibrate with respect to the panel 3321, so as to produce a resonance peak located within a target frequency range. In the frequency range after the resonant frequency corresponding to the resonance peak, the vibration transmitted between the additional element 3340 and the panel 3321 is suppressed, meaning that the effect of the additional element 3340 on the vibration of the panel 3321 is reduced, thereby ensuring that the sensitivity of the acoustic output device 3300 is not or less affected by the additional element 3340 in a frequency range greater than the resonant frequency corresponding to the resonance peak. In some embodiments, the sensitivity of the acoustic output device 3300 is unaffected by the additional element 3340 in a frequency range that is greater than the resonant frequency corresponding to the resonance peak. In some embodiments, the lower the resonant frequency corresponding to the resonance peak in the target frequency range, the wider the frequency band in which the acoustic output device 3300 has a flat frequency response curve. In some embodiments, reducing the frequency range in which the additional element 3340 affects the acoustic output device 3300, as well as making it possible to have a flat frequency response curve in a wider frequency band may be achieved by adjusting an elasticity coefficient of the vibration transmission sheet 33131 and/or the second vibration transmission sheet 33132, and a mass of the additional element 3340, to adjust the resonant frequency corresponding to the resonance peak. In some embodiments, the target frequency range is 20 Hz-800 Hz. Preferably, the target frequency range is 100 Hz-600 Hz. Further preferably, the target frequency range is 150 Hz-500 Hz. Further preferably, the target frequency range is 200 Hz-400 Hz.

In some embodiments, the additional element 3340 and the magnetic circuit assembly 3311 vibrate with respect to the panel 3321 to produce a resonance valley located in the target frequency range. Furthermore, the closer the corresponding frequencies of the resonance peak and the resonance valley are to each other, the less the effect on a flatness of the frequency response curve in the overall frequency band of the acoustic output device 3300. To make the frequency response curve of the acoustic output device 43300 flatter in an overall frequency band, in some embodiments, the frequency corresponding to the resonance valley is smaller than the frequency corresponding to the resonance peak. In some embodiments, a frequency difference between the frequency corresponding to the resonance peak and the frequency corresponding to the resonance valley is no greater than 300 Hz. In some embodiments, the frequency difference between the frequency corresponding to the resonance peak and the frequency corresponding to the resonance valley is no greater than 200 Hz. In some embodiments, the frequency difference between the frequency corresponding to the resonance peak and the frequency corresponding to the resonance valley is no greater than 100 Hz. The difference between the resonance peak and the resonance valley also has an effect on the flatness of the frequency response curve of the acoustic output device 3300. For example, the smaller the difference between the resonance peak and the resonance valley, the flatter the frequency response curve of the acoustic output device 3300 in the overall frequency band. To make the frequency response curve of the acoustic output device 3300 in the overall frequency band flatter, in some embodiments, the difference between the resonance peak and the resonance valley is in a range of 20 dB-100 dB. In some embodiments, the difference between the resonance peak and the resonance valley is in a range of 20 dB-60 dB. In some embodiments, the difference between the resonance peak and the resonance valley is in a range of 20 dB-40 dB.

In some embodiments, an elastic element is connected between one end of the support member 3323 and the panel 3321, and an elastic element is connected between the other end of the support member 3323 and the backplate 33221, so as to seal gaps among the ends of the support member 3323, the panel 3321 and the back plate 33221 through the elastic elements. Alternatively, the gaps among the ends of the support member 3323, the panel 3321 and the back plate 33221 are disposed with a filler material or connected with the elastic elements to form the housing 3320 of the acoustic output device 3300. In some embodiments, the filler material or the elastic element is an elastic material such as silicone, polyurethane, etc., such that the vibration transmission from the panel 3321 and the back plate 33221 to the additional element 3340 can be further minimized, thereby further reducing the effect of the mass of the additional element on the vibration load mass of the transducer, thereby reducing the effect of the additional element on the sensitivity of the acoustic output device 3300.

In some embodiments, the shell body 33222 is also a plate-like structure or a rod-like structure, and the two ends of the shell body 33222 are rigidly connected to the panel 3321 and the back plate 33221, respectively. For example, the shell body 33222 are two plate-like structures, and the ends of the two plate-like structures are rigidly connected to the panel 3321 and the back plate 33221, respectively.

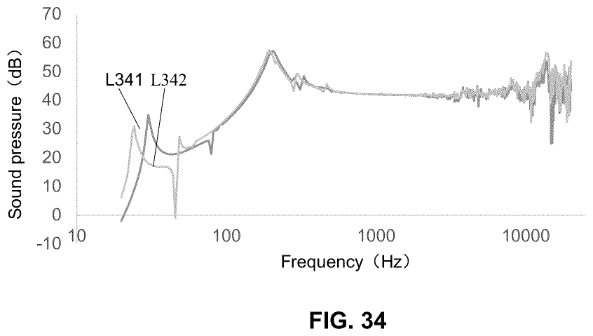

FIG. 34 is a curve diagram illustrating frequency response curves of acoustic output devices according to some embodiments of the present disclosure.

As shown in FIG. 34, a horizontal coordinate is frequency (Hz), and a vertical coordinate is sound pressure (dB) corresponding to the acoustic output device at different frequencies. Curve L341 is a frequency response curve of the acoustic output device 3300 without the additional element 3340, and curve L342 is the frequency response curve of the acoustic output device 3300 with the additional element 3340. Referring to the curves L341 and L342, it can be seen that the acoustic output device 3300 generates a resonance peak in a frequency range of 10 Hz-100 Hz. In a range higher than the resonant frequency corresponding to the resonance peak, the curves L341 and the curve L342 tend to overlap and have relatively flat frequency response curves in a frequency range of 200 Hz-10000 Hz. As can be seen, the sensitivity of the acoustic output device 3300 is unaffected by a mass of the additional element 3340 in the range higher than the resonant frequency corresponding to the resonance peak, which has a flatter frequency response curve, so as to ensure that the acoustic output device has a better acoustic output effect.

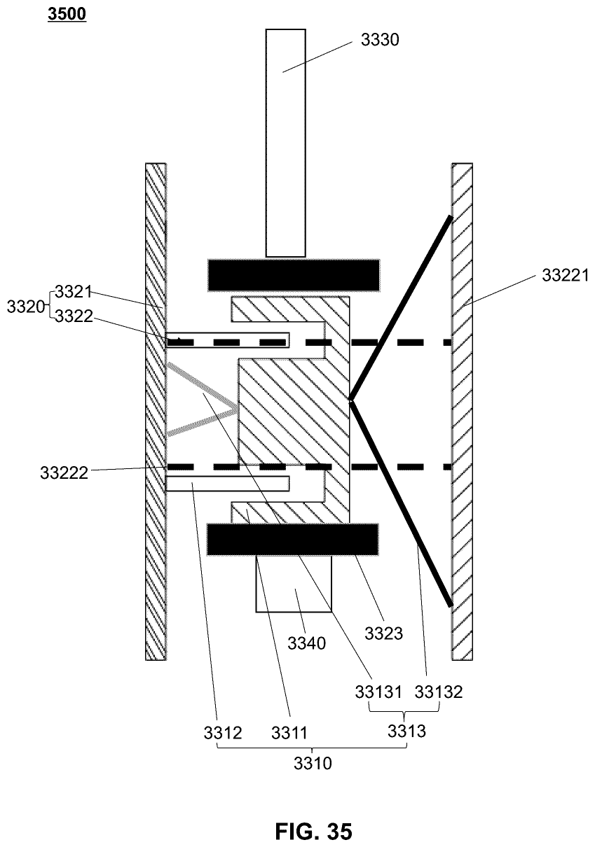

FIG. 35 is a schematic diagram illustrating a structure of an acoustic output device according to some embodiments of the present disclosure. FIG. 35 shows an acoustic output device 3500 that differs from the acoustic output device 3300 shown in FIG. 33 in that the support structure 3330 in the acoustic output device 3500 is rigidly connected to the support member 3323.

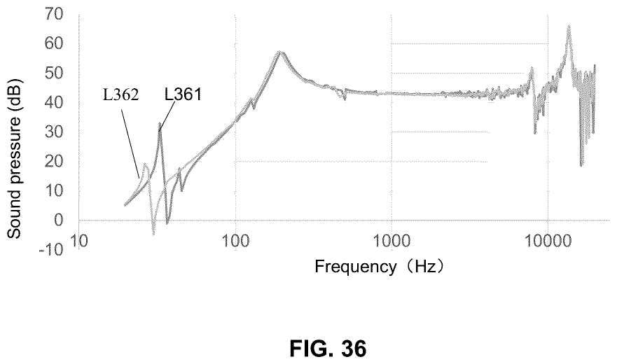

FIG. 36 is a curve diagram illustrating frequency response curves of acoustic output devices according to some embodiments of the present disclosure. As shown in FIG. 36, a horizontal coordinate indicates frequency (Hz), a vertical coordinate indicates sound pressure (dB) corresponding to the acoustic output device at different frequencies. Curve L361 is a frequency response curve of the acoustic output device 3500 when a mass of the additional element 3340 is 0; and curve L362 is the frequency response curve of the acoustic output device 3500 when the additional element 3340 has a certain mass (the mass is not 0). Referring to the curves L361 and L362, it can be seen that the acoustic output device 3300 generates a resonance peak in a frequency range of 10 Hz-100 Hz. In a range higher than the resonant frequency corresponding to the resonance peak, the curves L361 and the curve L362 tend to overlap, and have a relatively flat frequency response curve in a frequency range of 200 Hz-10000 Hz. As can be seen, the sensitivity of the acoustic output device 3500 is unaffected by the mass of the additional element 3340 in the range higher than the resonant frequency corresponding to the resonance peak, and the acoustic output device has a flatter frequency response curve, so as to ensure that the acoustic output device has a better acoustic output effect. In some embodiments, the support structure 3330 is rigidly connected to the back plate 33221.

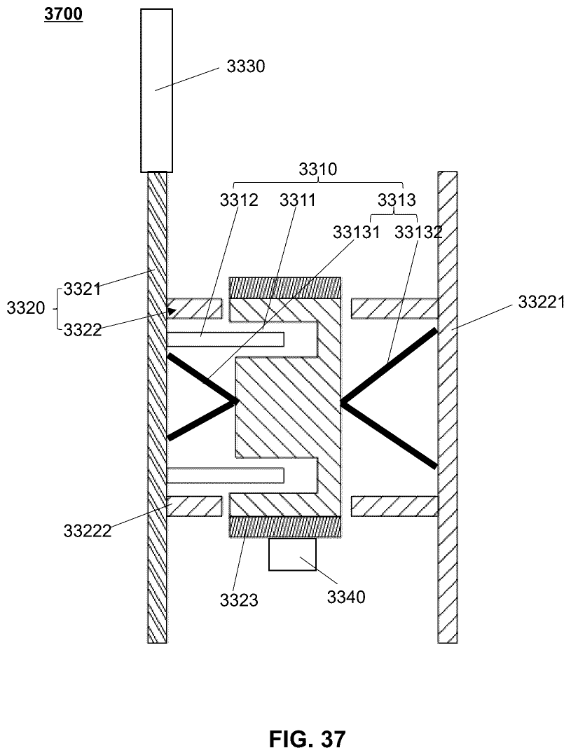

FIG. 37 is a schematic diagram illustrating a structure of an acoustic output device according to some embodiments of the present disclosure. As shown in FIG. 37, the support member 3323 in the acoustic output device 3700 is a cylindrical structure, and the cylindrical structure surrounds the circumferential side of the magnetic circuit assembly 3311 along the circumferential side of the shell body 33222. The circumferential side of the magnetic circuit assembly 3311 is rigidly connected to an inner surface of the cylindrical structure, and the additional element 3340 is rigidly connected to the cylindrical structure. As an example, when the support member 3023 is disposed on an outer side of the shell 3022, the circumferential side of the magnetic circuit assembly 3311 extends through a notch disposed on the shell body 33222 to the outside of the shell 3022 and is rigidly connected to the support member 3323. In some embodiments, the support member 3323 is disposed on an inner side of the shell 3322, and the circumferential side of the magnetic circuit assembly 3311 is rigidly connected to the support member 3323 without passing through the shell body 33222. In some embodiments, an elastic element is connected between one of the two ends of the support member 3323 or one of the two ends of the magnetic circuit assembly 3311 and the panel 3021, and an elastic element is connected between the other one of the two ends of the support member 3323 or the other one of the two ends of the magnetic circuit assembly 3311 and the backplate 33221. Through the elastic elements, gaps among the two ends of the support member 3323, the panel 3321 and the back plate 33221 are sealed. Alternatively, the gaps among the two ends of the support 3323, the panel 3321 and the back plate 33221 are disposed between a filler material or connected with the elastic element, so as to form the housing 3320 of the acoustic output device 3320. In some embodiments, the filler material or the elastic element is an elastic material such as silicone, polyurethane, etc., which further reduces a vibration transmission from the panel 3321 and the back plate 33221 to the additional element 3340, thereby further reducing an effect of a mass of the additional element on a vibration load mass of the transducer, thereby reducing the effect of the additional element on the sensitivity of the acoustic output device 3300.

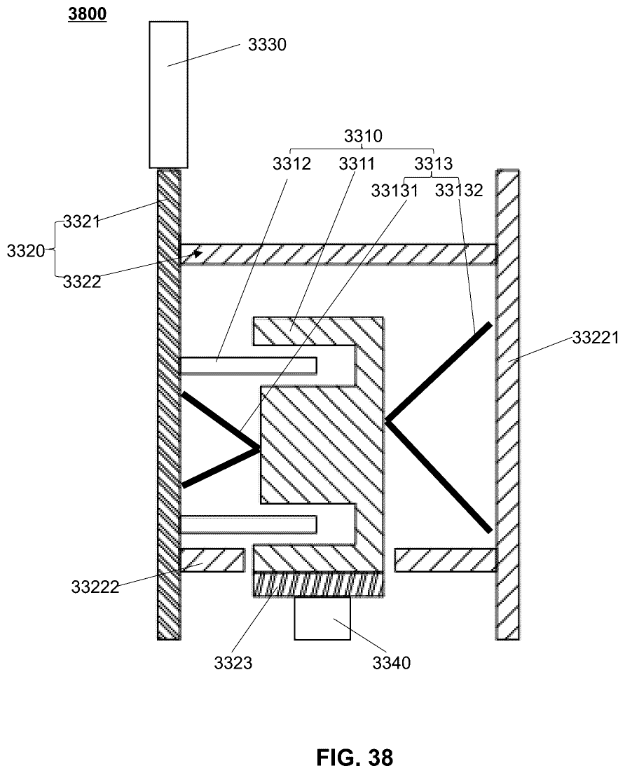

FIG. 38 is a schematic diagram illustrating a structure of an acoustic output device according to some embodiments of the present disclosure.

As shown in FIG. 38, the support member 3323 in the acoustic output device 3800 is a plate-like structure disposed on one side of the shell body 33222, and two ends of the magnetic circuit assembly 3311 are respectively elastically connected to the panel 33222 and the back plate 33221 through an elastic element. The magnetic circuit assembly 3311 is rigidly connected to the plate-like structure, and the additional element 3340 is rigidly connected to the plate-like structure. In the embodiments of the present disclosure, the elastic element may be a spring, a vibration transmission sheet, or other structures with elasticity. In the embodiments of the present disclosure, the elastic element includes a first vibration transmission sheet 33131 and a second vibration transmission sheet 33132 disposed on both sides of the magnetic circuit assembly 3311. The first vibration transmission sheet 33131 and the second vibration transmission sheet 33132 respectively connect the magnetic circuit assembly 3311 and the panel 33222 as well as the magnetic circuit assembly 3311 and the back plate 33221. As an example, when the panel structure is disposed on an outer side of the shell 3022, a side of the magnetic circuit assembly 3311 facing the shell body 33222 can extend to the outside of the shell 3322 through a notch disposed on the shell body 33222 and is rigidly connected to the plate-like structure. In some embodiments, the plate-like structure is disposed on the inside of the shell 3322, and the side of the magnetic circuit assembly 3311 is connected to the plate-like structure without passing through the shell body 33222. In some embodiments, the plate-like structure is disposed in the notch, and the ends of the plate-like structure are connected to the shell body 3322 through the elastic elements or filled with elastic materials to achieve elastic connection between the plate-like structure and the shell body 3322. It should be noted that the support structure 3300 in FIG. 38 is not limited to being rigidly connected to the panel 3321, but also rigidly connected to the shell body 33222 or the back plate 33221. Furthermore, a number of plate-like structures is not limited to one as shown in FIG. 38, but may also be two, three, or more.

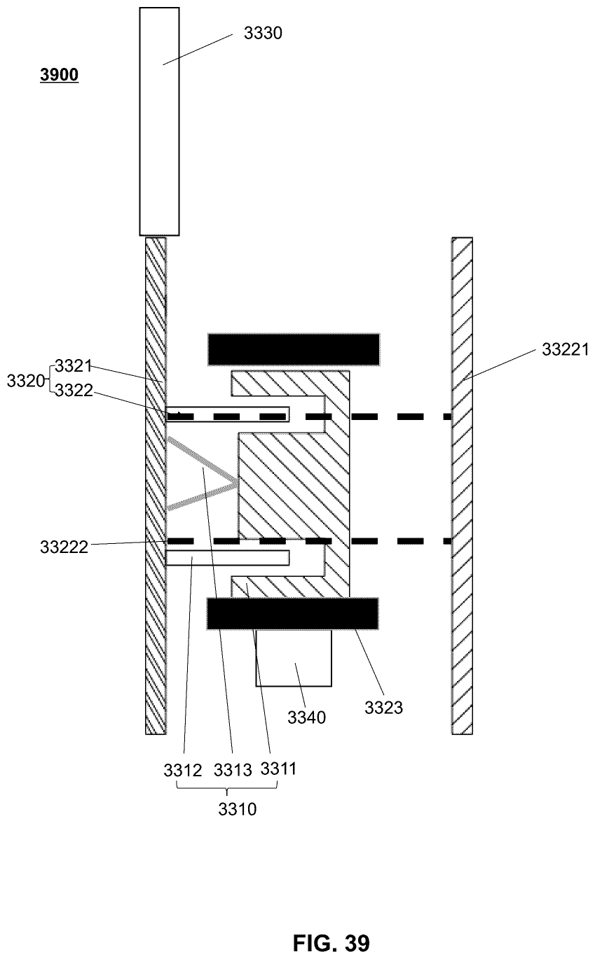

FIG. 39 is a schematic diagram illustrating a structure of an acoustic output device according to some embodiments of the present disclosure.

As shown in FIG. 39, an acoustic output device 3900 differs from the acoustic output device 3300 shown in FIG. 33 in that the vibration transmission sheet 3313 in the acoustic output device 3900 includes only one vibration transmission sheet (which, for ease of description, is still denoted in FIG. 39 by the term vibration transmission sheet 3313). The vibration transmission sheet 3313 is disposed between the magnetic circuit assembly 3311 and the panel 3321, and elastically connects the magnetic circuit assembly 3311 to the panel 3321. It should be noted that the support structure 3300 in FIG. 39 is not limited to be rigidly connected to the panel 3321, but also rigidly connected to the shell body 33222 or the back plate 33221.

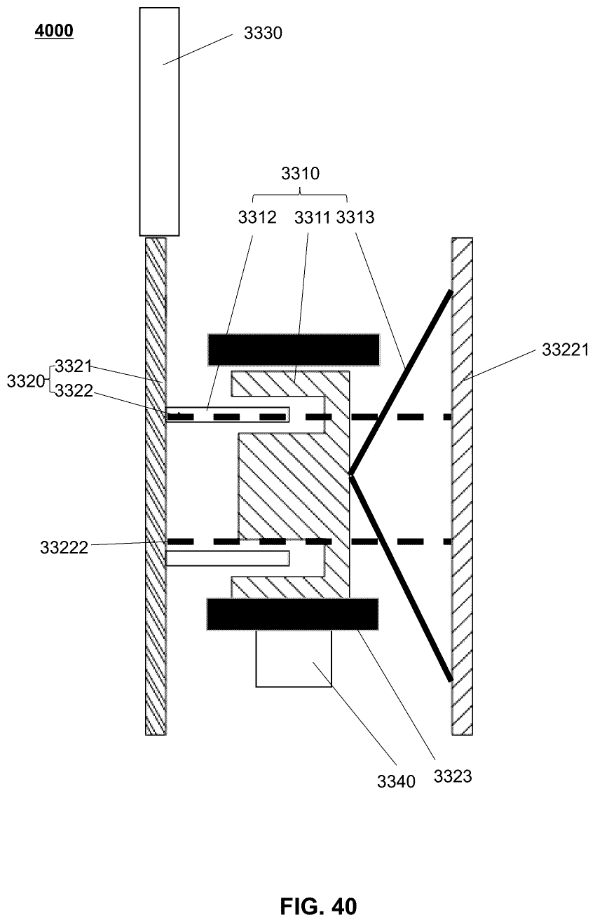

FIG. 40 is a schematic diagram illustrating a structure of an acoustic output device according to some embodiments of the present disclosure.

As shown in FIG. 40, an acoustic output device 4000 differs from the acoustic output device 3300 shown in FIG. 33 in that the vibration transmission sheet 3313 in the acoustic output device 4000 includes only one vibration transmission sheet (which, for ease of description, is still denoted in FIG. 39 by the term vibration transmission sheet 3313). The vibration transmission sheet 3313 is disposed between the magnetic circuit assembly 3311 and the back plate 33221, and elastically connects the magnetic circuit assembly 3311 to the back plate 33221.

It is to be noted that the support member being a cylindrical structure or a plate structure is equally applicable to the support members 3323 in the acoustic output devices 3900 and 4000. For specifics, please refer to the acoustic output device 3700 shown in FIG. 37 or the acoustic output device 3800 shown in FIG. 38, which are not repeated herein. In addition, the support structure 3300 in FIG. 40 is not limited to be rigidly connected to the panel 3321, but is rigidly connected to the shell body 33222 or the back plate 33221.

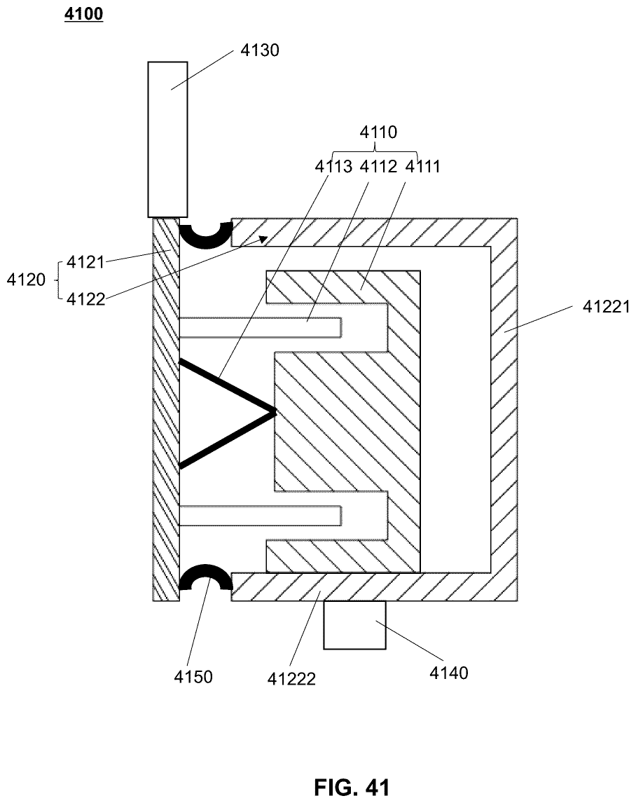

FIG. 41 is a schematic diagram illustrating a structure of an acoustic output device according to some embodiments of the present disclosure.

As shown in FIG. 41, structures of a transducer 4110 (including a magnetic circuit assembly 4111, a coil 4112, and a vibration transmission sheet 4113), a housing 4120 (including a panel 4121 and a shell 4122), a support structure 4130, and an additional element 4140, etc., of the acoustic output device 4100 are similar to the structures of the transducer 400 (including the magnetic circuit assembly 411, the coil 412, and the vibration transmission sheet 413A), the support structure 430, and the additional element 440, etc., of the acoustic output device 3900, respectively. A main difference between the acoustic output device 4100 and the acoustic output device 400 is that the additional element 4140 in the acoustic output device 4100 is rigidly connected to a sidewall in the shell 4122 adjacent to the panel 4121 (i.e., a shell body 41222), the magnetic circuit assembly 4111 is rigidly connected to the shell body 41222. In this way, the shell body 41222 is made to have a better support effect on the magnetic circuit assembly 4111, thereby preventing the magnetic circuit assembly 4111 from being attracted or repelled by the additional element 4140 and being flipped and deformed, which affects vibration stability of the transducer 4110.

In some embodiments, the shell 4122 is viewed as a structure that is internally hollow and has an opening facing the panel 4121, as shown in FIG. 41. Further, the shell 4122 includes a back plate 41221 (a sidewall on the shell 4122 opposite to the panel) and the shell body 41222 (the sidewall on the shell 4122 adjacent the panel 4121). The panel 4121 and the back plate 41221 are located at each end of the shell body 41222. The vibration transmission sheet 4113 is disposed between the panel 4121 and the magnetic circuit assembly 412 and elastically connects the magnetic circuit assembly 4111 to the panel 4121.

In some embodiments, an elastic element 4450 is adopted to connect between the panel 4121 and one end of the shell body 41222, as shown in FIG. 41. As a result of the presence of the vibration transmission sheet 4113 and the elastic element 4150, the additional element 4140 and the magnetic circuit assembly 4111 vibrate with respect to the panel 4221 to generate a resonance peak in a target frequency range. Further, the vibration transmission sheet 4113 and the elastic element 4150 reduce or prevent the panel 4121 from transmitting vibrations to the additional element 4140 in a frequency range higher than a resonant frequency corresponding to a resonance peak, allowing the a mass of the additional element has no effect on a vibration load mass of the transducer in the frequency range above the resonant frequency corresponding to the resonance peak, thereby ensuring that the sensitivity of the acoustic output device is not affected by the additional element in the frequency range above the resonant frequency corresponding to the resonance peak. It should be noted that the elastic element being a reed structure, a ring structure with elasticity, or a glue with elasticity is equally applicable to the elastic element 4150 in the acoustic output device 4100, as shown in FIG. 4 of the acoustic output device 400.

It should be noted that the support structure 4100 of FIG. 41 is not limited to being rigidly connected to the panel 4121, but is rigidly connected to the shell body 41222 or the back plate 41221.

It is to be noted that, in the acoustic output device 900 illustrated in FIG. 9, the solution of providing the pressure relief hole 9221 in the shell 922 to reduce the resonant frequency corresponding to the resonance peak generated by the vibration of the additional element driven by the elastic element with respect to the panel, so as to widen the frequency range in which the sensitivity of the acoustic output device is not or less affected by the additional element, and the solution of elastically connect the back plate of the acoustic output device 1200 to the sidewall adjacent to the panel on the shell to reduce the high frequency sound leakage, are also applicable to the acoustic output device 4100.

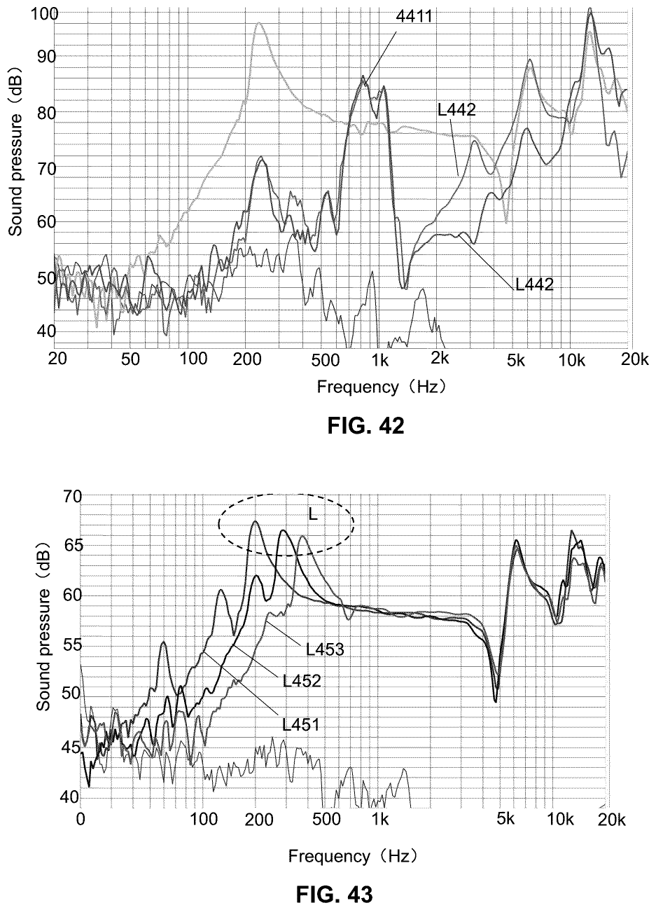

Because of the existence of a certain mass of the additional element, a centroid of the entire acoustic output device is made to be at a certain distance from a direction of a driving force of the magnetic circuit assembly in the transducer, which leads to a vibration shaking of the magnetic circuit assembly in the transducer, which not only affects a vibration stability of the transducer, but also increases a sound leakage. The effect of the additional element on the sound leakage of the acoustic output device is explained in the following in conjunction with FIG. 42.

FIG. 42 is a curve diagram illustrating frequency response curves of acoustic output device according to some embodiments of the present disclosure.

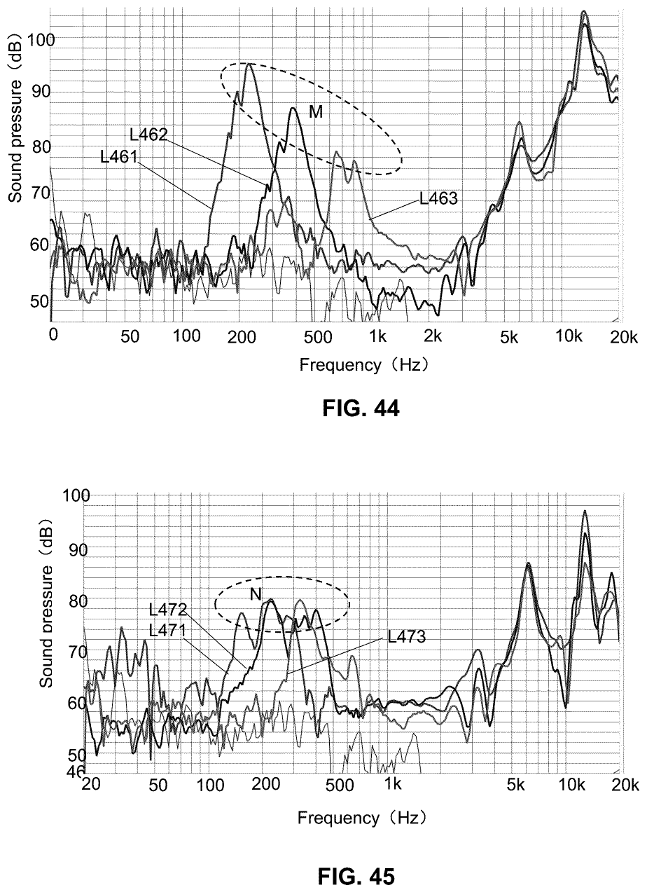

As shown in FIG. 42, curve L441 is a sound leakage frequency response curve corresponding to a side where the additional element is disposed on the shell body 33222 of the acoustic output device 3300, and curve L442 is a sound leakage frequency response curve corresponding to a side departs from the side where the additional element is disposed on the shell body 33222 of the acoustic output device 3300. The sound leakage frequency response curves L441 and L442 are measured by collecting an air conduction sound on a side of the shell body 33222 in the acoustic output device 3300. From the curves L441 and L442, it can be seen that the acoustic output device 3300 generates a sound leakage resonance peak 4411 in a frequency range of 500 Hz-2000 Hz. In this case, the sound leakage resonance peak 4411 is generated by the magnetic circuit assembly 3311 when there is a vibration sway. Due to the presence of the sound leakage resonance peak 4411, the acoustic output device 3300 may produce a significant sound leakage in an operating frequency band (e.g., within a range of 500 Hz-2000 Hz). Accordingly, in some embodiments, by adjusting a position of the sound leakage resonance peak 4411, the resonant frequency corresponding to the sound leakage resonance peak is as far as possible from the operating frequency band, so that the acoustic output device does not have a greeter sound leakage in the operating frequency band. In some embodiments, the resonant frequency corresponding to the sound leakage resonance peak is adjusted by adjusting an elasticity coefficient of the first vibration transmission sheet 33131 and/or the second vibration transmission sheet 33132. For example, the elasticity coefficient of the vibration transmission sheet, or a position of a connection point between a reed and other structures is adjusted to reduce an ease degree of the reed from flipping and deformation. Currently, the most effective way is to adjust the elasticity coefficient of the vibration transmission sheet, and thus adjust a flip stiffness of the vibration transmission sheet (the ease degree for the flip deformation). By designing the X-shaped vibration transmission sheet, a greater flip stiffness is better obtained, and at the same time, the elasticity coefficient of the vibration transmission sheet (deform along the vibration direction) is maintained as much as possible. For descriptions on how to adjust the resonant frequency corresponding to the resonance peak of the sound leakage, please refer to FIGS. 44-45 and the related descriptions.

FIG. 43 is a curve diagram illustrating frequency response curves of acoustic output devices according to some embodiments of the present disclosure. The frequency response curves in FIG. 43 are measured by collecting air conduction sounds on a side of panel 3321 of the acoustic output device. As shown in FIG. 43, L451 is a frequency response curve of the acoustic output device 3300 when elasticity coefficients of the first vibration transmission sheet 33131 and the second vibration transmission sheet 33132 are K1; L452 is a frequency response curve of the acoustic output device 3300 when elasticity coefficients of the first vibration transmission sheet 33131 and the second vibration transmission sheet 33132 are K2; L453 is is a frequency response curve of the acoustic output device 3300 when elasticity coefficients of the first vibration transmission sheet 33131 and the second vibration transmission sheet 33132 are K3, where K1<K2<K3. Resonance peaks in a region L are the resonance peaks generated in the acoustic output device 3300 by the additional element 3340 and the magnetic circuit assembly 3311 with respect to the panel 3321 in a target frequency range. Referring to the curves L451, L452, and L453, it can be seen that in a range higher than the resonant frequency corresponding to the resonance peak, the acoustic output device 3300 has a relatively flat frequency response curve, with a better acoustic output effect. As the elasticity coefficients of the first vibration transmission sheet 33131 and the second vibration transmission sheet 33132 increase, the resonant frequency corresponding to the resonance peak increases. To allow for a flatter frequency response curve in a wider frequency range, in some embodiments, by adjusting the elasticity coefficients of the first vibration transmission sheet 33131 and the second vibration transmission sheet 33132, and/or the mass of an additional element, so that the resonant frequency corresponding to the resonance peak is within a target frequency range. In some embodiments, the target frequency range is no greater than 800 Hz. Preferably, the target frequency range is no greater than 700 Hz. Further preferably, the target frequency range is no greater than 500 Hz. More preferably, the target frequency range is no greater than 300 Hz. More preferably, the target frequency range is no greater than 200 Hz.

FIG. 44 is a curve diagram illustrating sound leakage frequency response curves of acoustic output devices according to some embodiments of the present disclosure. The sound leakage frequency response curves in FIG. 44 are measured by collecting air conduction sounds on a side of the shell 3322 opposite to the additional element 3340 in the acoustic output device 3300. As shown in FIG. 44, L461 is a sound leakage frequency response curve of the acoustic output device 3300 when elasticity coefficients of the first vibration transmission sheet 33131 and the second vibration transmission sheet 33132 are K1; L462 is a sound leakage frequency response curve of the acoustic output device 3300 when elasticity coefficients of the first vibration transmission sheet 33131 and the second vibration transmission sheet 33132 are K2; and L463 is a sound leakage frequency response curve of the acoustic output device 3300 when the elasticity coefficients of the first vibration transmission sheet 33131 and the second vibration transmission sheet 33132 are K3, where K1<K2<K3. Sound leakage resonance peaks in region M are the sound leakage resonance peaks on each leakage frequency response curve. Referring to the curves L461, L462, and L463, it can be seen that as the elasticity coefficients of the first vibration transmission sheet 33131 and the second vibration transmission sheet 33132 increase, the resonant frequencies corresponding to the sound leakage resonance peaks increase. In some embodiments, by adjusting the elasticity coefficients of the first vibration transmission sheet 33131 and the second vibration transmission sheet 33132, the resonant frequency corresponding to the resonant of the sound leakage resonance curve is made smaller than the response frequency of the acoustic output device, so that a side of the shell 3322 opposite to the additional element 3340 in the acoustic output device 3300 has a smaller sound leakage.

In some embodiments, the resonant frequency corresponding to the resonant of the sound leakage frequency response curve is less than 700 Hz. Preferably, the resonant frequency corresponding to the resonant of the sound leakage frequency response curve is less than 500 Hz. Further preferably, the resonant frequency corresponding to the resonant of the sound leakage frequency response curve is less than 300 Hz. Further preferably, the resonant frequency corresponding to the resonant of the sound leakage frequency response curve is less than 200 Hz.

FIG. 45 is a curve diagram illustrating sound leakage frequency response curves of acoustic output devices according to some embodiments of the present disclosure. The sound leakage frequency response curves in FIG. 45 are measured by collecting air conduction sounds on a side of the shell 3322 of the acoustic output device 3300 where the additional element 3340 is located.

As shown in FIG. 45, L471 is a sound leakage frequency response curve of the acoustic output device 3300 when the elasticity coefficients of the first vibration transmission sheet 33131 and the second vibration transmission sheet 33132 are K1; L472 is a sound leakage frequency response curve of the acoustic output device 3300 when the elasticity coefficients of the first vibration transmission sheet 33131 and the second vibration transmission sheet 33132 are K2; L473 is a sound leakage frequency response curve of the acoustic output device 3300 when the elasticity coefficients of the first vibration transmission sheet 33131 and the second vibration transmission sheet 33132 are K3, where K1<K2<K3. The sound leakage resonance peaks in the region N are the sound leakage resonance peaks on the leakage frequency response curves respectively. Referring to the curves L471, L472, and L473, it can be seen that as the elasticity coefficients of the first vibration transmission sheet 33131 and the second vibration transmission sheet 33132 increase, the resonant frequency corresponding to the sound leakage resonance peak increases. In some embodiments, by adjusting the elasticity coefficients of the first vibration transmission sheet 33131 and the second vibration transmission sheet 33132, the resonant frequency corresponding to the resonant of the sound leakage resonance curve is made smaller than the response frequency of the acoustic output device, so that a side of the shell 3322 opposite to the additional element 3340 in the acoustic output device 3300 has a smaller sound leakage. In some embodiments, the resonant frequency corresponding to the resonant of the sound leakage frequency response curve is less than 700 Hz. Preferably, the resonant frequency corresponding to the resonant of the sound leakage frequency response curve is less than 500 Hz. Further preferably, the resonant frequency corresponding to the resonant of the sound leakage frequency response curve is less than 300 Hz. Further preferably, the resonant frequency corresponding to the resonant of the sound leakage frequency response curve is less than 200 Hz. In some embodiments, the elasticity coefficients of the first vibration transmission sheet 33131 and the second vibration transmission sheet 33132 are related to their structures, and by designing the structures of the first vibration transmission sheet 33131 and the second vibration transmission sheet 33132, it is possible to make the first vibration transmission sheet 33131 and the second vibration transmission sheet 33132 have greater elasticity coefficients, so as to make the sound leakage resonance peak of the acoustic output device 3300 have a resonant frequency away from an operating frequency band. In some embodiments, when the first vibration transmission sheet 33131 and the second vibration transmission sheet 33132 adopt the structure of a vibration transmission sheet 4800 as shown in FIG. 46, the first vibration transmission sheet 33131 and the second vibration transmission sheet 33132 have greater elasticity coefficients, and the acoustic output device 3300 has a smaller sound leakage in a wider operating frequency band. The structure of the vibration transmission sheet is described in detail below in connection with FIG. 46.

FIG. 46 is a schematic structure diagram illustrating a top view of a vibration transmission sheet according to some embodiments of the present disclosure. FIG. 47 is a schematic diagram illustrating a three-dimensional (3D) structure of a vibration transmission sheet according to some embodiments of the present disclosure.

As shown in FIG. 46 and FIG. 47, the vibration transmission sheet 4800 includes a center region 4810, an edge region 4820, and a plurality of support rods 4830 connecting the center region 4810 and the edge region 4820. When the vibration transmission sheet 4800 is used to connect a magnetic circuit assembly in an acoustic output device to a housing (e.g., a panel or a back plate), the center region 4820 of the vibration transmission sheet 4800 is connected to the magnetic circuit assembly, and the edge region 4820 of the vibration transmission sheet 4800 is connected to the housing. As an example, when the first vibration transmission sheet 33131 in the acoustic output device 3300 is the vibration transmission sheet 4800, the center region 4810 of the vibration transmission sheet 4800 is connected to a side of the magnetic circuit assembly 3311 close to the panel 3321, and the edge region 4820 of the vibration transmission sheet 4800 is connected to the panel 3321. When the second vibration transmission sheet 33132 in the acoustic output device 3300 is the vibration transmission sheet 4800, the center region 4810 of the vibration transmission sheet 4800 is connected to the side of the magnetic circuit assembly 3311 proximate to the back plate 33221, and the edge region 4820 of the vibration transmission sheet 4800 is connected to the back plate 33221.

In some embodiments, in a natural state of the vibration transmission sheet 4800, the edge region 4820 of the vibration transmission sheet 4800 is not coplanar with the center region 4810 of the vibration transmission sheet 4800. In this way, it is possible to generate a retightening force when the magnetic circuit assembly in the acoustic output device is connected to the panel and/or the back plate. The presence of the retightening force makes the vibration transmission sheet 4800 not to have an elastic force of zero during the vibration of the transducer, which is beneficial for improving a stability of the vibration of the transducer in the acoustic output device. The natural state of the vibration transmission sheet 4800 refers to a structural state in which the vibration transmission sheet 4800 is assembled in the transducer of the acoustic output device and no excitation signal is input to the transducer without generating mechanical vibration. It should be noted that the edge region 4820, the center region 4810 of the vibration transmission sheet 4800, and the support rod 4830 are in the same plane.

In some embodiments, as shown in FIG. 46 and FIG. 47, there are four support rods 4830 in the vibration transmission sheet 4800, and the four support rods 4830 are spaced apart along a circumference side of the center region 4810 of the vibration transmission sheet 4800, and symmetrically distributed about a centerline of the center region 4810, which is beneficial for increasing an overall elasticity coefficient of the vibration transmission sheet 4800.

To further increase the overall elasticity coefficient of the vibration transmission sheet 4800, in some embodiments, as illustrated in FIG. 46 and FIG. 47, the support rod 4830 includes one or more meandering bending structures 4831 disposed in an extension direction of the support rod 4830.

In some embodiments, as shown in FIG. 47, the center region 4810 of the vibration transmission sheet 4800 is disposed with through holes 4811, and the through holes 4811 are used for inserting convex pillars on the magnetic circuit assembly, and thereby, through corporations between the convex pillars and the through holes, a fixed connection between the center region 4810 and the magnetic circuit assembly is implemented.

When the additional element has a metal material or a magnet inside, the additional element attracts the magnetic circuit assembly of the transducer. To reduce a magnetic attraction effect of the additional element on the magnetic circuit assembly and avoid the magnetic circuit assembly in the transducer from being deviated, the vibration transmission sheet 4800 has a stiffness greater than a stiffness threshold in any direction (hereinafter referred to as a radial direction) in a plane perpendicular to a vibration direction. For example, based on a width of a magnetic gap and a magnetic attraction force between the magnetic circuit assembly and the additional element, it is determined that an equivalent stiffness on a radial direction of the vibration transmission sheet 4800 is greater than 4.7×10⁴ N/m. For example, the equivalent stiffness in the radial direction of the vibration transmission sheet 4800 is greater than 6.4×10⁴ N/m. By optimizing the stiffness of the vibration transmission sheet 4800 with elasticity in the length and the width directions in a plane perpendicular to the vibration direction, the magnetic attraction force between the magnetic circuit assembly and the additional element can be resisted. As a result, the magnetic circuit assembly in the transducer is not deviated, so as to ensure the stability during vibration.

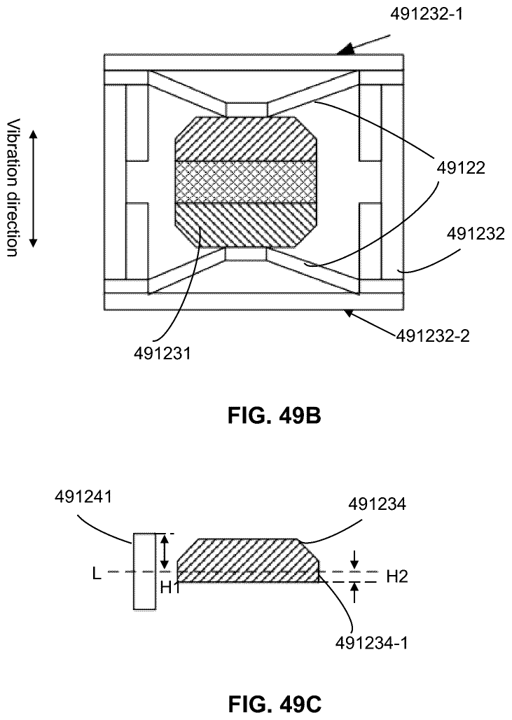

Referring to FIG. 49B, FIG. 49B is a schematic diagram illustrating a structure of a magnetic circuit assembly according to some other embodiments of the present disclosure. In some embodiments of the present disclosure, a magnetic circuit assembly 49123 further includes a magnet assembly 491231, a magnetic conductive shield 491232 (not shown in the figure), and at least one vibration transmission sheet 49122. The vibration transmission sheet 49122 is connected between the magnetic conductive shield 491232 and the magnet assembly 491231 for elastically supporting the magnet assembly 49123 within the magnetic conductive shield 491232. In the embodiment of the present disclosure, the transducer includes two vibration transmission sheets, namely, a first vibration transmission sheet and a second vibration transmission sheet. The first vibration transmission sheet and the second vibration transmission sheet are respectively disposed on two sides of the magnet assembly along a vibration direction of the magnet assembly and are used to elastically support the magnet assembly. In some embodiments, the vibration transmission sheet and the magnetic circuit assembly 49123 are arranged along the vibration direction, and a side of the vibration transmission sheet perpendicular to the vibration direction is connected to an end of the magnetic conductive shield perpendicular to the vibration direction to realize a fixation of the magnet assembly. In some embodiments, by setting a specific stiffness for the vibration transmission sheet, the vibration transmission sheet also resists the magnetic attraction force between the magnet assembly and the magnetic conductive shield, thereby preventing the magnet assembly in the transducer to be deviated. In some embodiments, the equivalent stiffness in the radial direction of at least one vibration transmission sheet is greater than 4.7×10⁴ N/m. For example, the transducer only includes one vibration transmission sheet. For another example, the transducer includes at least two vibration transmission sheets 4800, e.g., the first vibration transmission sheet and the second vibration transmission sheet. The equivalent stiffness in the radial direction of each of the first and second vibration transmission sheets is greater than 4.7×10⁴ N/m.

In some embodiments, size data related to the vibration transmission sheet 4800 is determined based on a requirement of the equivalent stiffness in the radial direction of the vibration transmission sheet 4800. In some embodiments, along a length direction of the vibration transmission sheet 4800, a ratio of a distance between a starting point and an ending point of the support rod 4830 to the length of the support rod 4830 itself is in a range of 0-1.2. The distance between the starting point and the ending point of the support rod 4830 in the length direction of the vibration transmission sheet 4800 refers to a distance between the connection point between the support rod 4830 and the center region 4810 of the vibration transmission sheet and the connection point between the support rod 4830 and the edge region 4820 of the vibration transmission sheet along the length direction of the vibration transmission sheet 4800. For example, in (b) of FIG. 47, along the length direction of the vibration transmission sheet 4800, a ratio of a distance SE between the starting point S and the ending point E of the support rod 4830 to a total length of the curved support rod 4830 is in a range of 0.7-0.85. In some embodiments, along the width direction of the vibration transmission sheet 4800, a ratio of a distance between the starting point and the ending point of the support rod 4830 to the length of the support rod 4830 itself is in a range of 0-0.5. The distance between the starting point and the ending point of the support rod 4830 in the width direction of the vibration transmission sheet 4800 refers to the distance between the connection point between the support rod 4830 and the center region 4810 of the vibration transmission sheet and the connection point between the support rod 4830 and the edge region of the vibration transmission sheet along the width direction of the vibration transmission sheet 4830. For example, as shown in (b) of FIG. 47, along the width direction of the vibration transmission sheet 4800, the ratio of a distance S‘E’ between the starting point S and the ending point E of the support rod 4830 to the total length of the curved support rod 4830 is in a range of 0.15-0.35.

In some embodiments, the length of the support rod 4830 is in a range of 7 mm-25 mm. In some embodiments, a thickness of the support rod along an axial direction of the transducer (i.e., the thickness of the vibration transmission sheet) is in a range of 0.1 mm-0.2 mm. In some embodiments, a ratio of the thickness of the vibration transmission sheet along the axial direction of the transducer to the width of any one of the support rods 4830 along a radial plane of the transducer is in a range of 0.16-0.75. Exemplary ranges of thickness-to-width ratios include, for example, 0.2-0.7, 0.26-0.65, 0.3-0.6, 0.36-0.55, or 0.4-0.5. In some embodiments, the thickness of the vibration transmission sheet 4800 is in a range of 0.1 mm-0.2 mm, and the width of the support rod 4830 is in a range of 0.25 mm-0.5 mm. For example, the thickness of the vibration transmission sheet 4800 is in a range of 0.1 mm-0.15 mm, and the width of the support rod 4830 is in a range of 0.4 mm-0.48 mm.

It should be noted that the structure of the vibration transmission sheet 4800 illustrated in FIG. 46 and FIG. 47 are applicable to the vibration transmission sheets in any of the acoustic output devices disposed in the embodiments of the present disclosure, for example, the first vibration transmission sheet 33131 and the second vibration transmission sheet 33132 in the acoustic output device 3300, the vibration transmission sheet 3313 in the acoustic output devices 3900 and 4000, the vibration transmission sheet 413A and the vibration transmission sheet 413B in acoustic output devices 400 and 700, the vibration transmission sheet 913A and the vibration transmission sheet 913B in the acoustic output device 900, the vibration transmission sheet 1213A and the vibration transmission sheet 1213B in the acoustic output device 1200, the vibration transmission sheet 2013A and the vibration transmission sheet 2013B in the acoustic output devices 2000, 2200, 2400, 2500, 2600, 2700, etc.

Embodiments of the present disclosure describe an acoustic output device 4900. In some embodiments, the acoustic output device 4900 includes an acoustic output unit 4910 and a support structure 4920, and the acoustic output unit 4910 and the support structure 4920 are connected to each other. The support structure 4920 is used to support the acoustic output unit 4910 to be worn to a wearing position. In some embodiments, the wearing position is a specific position on a head of a user. For example, the wearing position includes an ear, a mastoid, a temporal bone, a parietal bone, a frontal bone, etc. For another example, the wearing position includes a position on a left or right side of the head and on a sagittal axis of a human body on an anterior side of the ear of the user. In some embodiments, the acoustic output unit 4910 includes a transducer used to convert an electrical signal into a mechanical vibration so that the user hears a sound through the acoustic output device 4900. Specifically, the mechanical vibration generated by the acoustic output unit 4910 is transmitted primarily through a medium such as a skull of the user (also known as a bone conduction) to form a bone conduction sound, or is transmitted primarily through a medium such as air (also known as an air conduction) to form an air conduction sound, or adopts a combination of bone and air to transmit sound. Further descriptions of the acoustic output unit 4910 can be found elsewhere in the present disclosure, for example, FIG. 49A to FIG. 51 and the related descriptions.

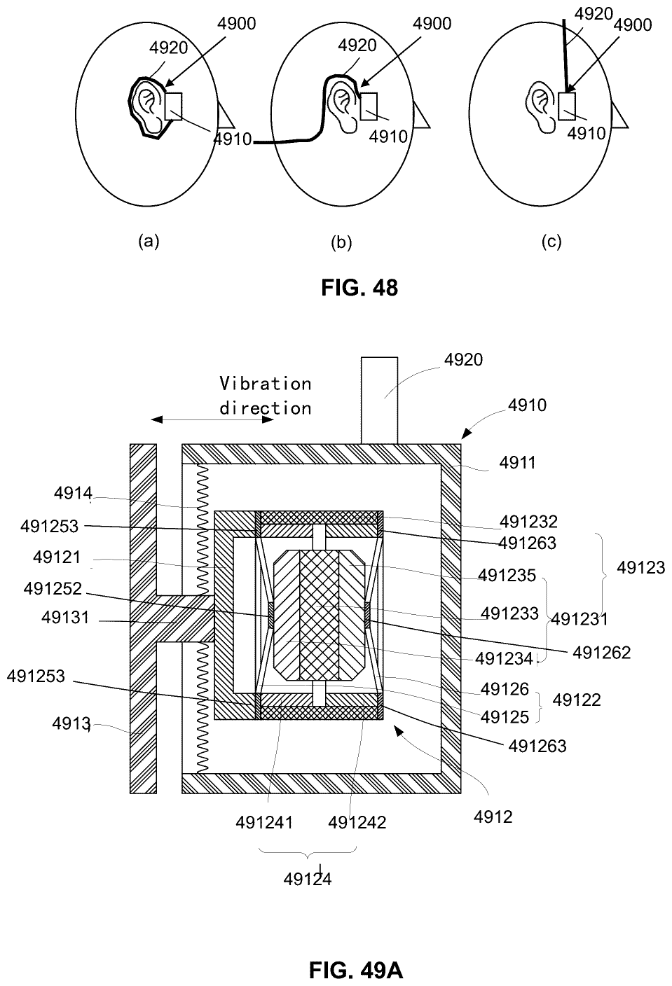

In some embodiments, the support structure 4920 is disposed in an annular manner and is disposed around the head of the user through the forehead and back of the head portions of the user. In some embodiments, the support structure 4920 is a rear hanging structure formed in a curved shape and adapted to fit on the back side of the head of the user. In some embodiments, the support structure 4920 is an ear-hook structure for hanging above the ear of the user with a curved portion adapted to fit a human ear. In some embodiments, the support structure 4920 is a mirror frame structure with a nosepiece and mirror legs on both sides that can be worn on a face and the ears of the user. Further embodiments of the support structure 4920 can be found in FIGS. 48 (a)-(c) and the related descriptions.

FIG. 48 is a schematic diagram illustrating a wearing state of an acoustic output device 4900 according to some embodiments of the present disclosure. In some embodiments, as shown in (a) in FIG. 48, the support structure 4920 is disposed in an annular manner and disposed around an ear of a user, so that the acoustic output unit 4910 is positioned at the face of the user and close to the ear canal of the user. In some embodiments, as shown in (b) in FIG. 48, the support structure 4920 is disposed as an ear-hook and a rear hanging structure, which cooperates and surrounds a back of a head of the user and an auricle, so that the acoustic output unit 4910 is positioned at the face of the user and proximate to an ear canal of the user. In some embodiments, as shown in (c) in FIG. 48, the support structure 4920 is a headband structure in a curved shape disposed around a top portion of the head of the user, so that the acoustic output unit 4910 is positioned at the face of the user and near the ear canal of the user.

In some embodiments, the acoustic output device 4900 includes at least two acoustic output units 4910. Both of the at least two acoustic output units 4910 convert electrical signals into mechanical vibrations to enable the acoustic output device 4900 to realize a stereo sound effect. For example, the acoustic output device 4900 includes two acoustic output units 4910. The two acoustic output units 4910 are disposed on a left ear side and a right ear side of the user, respectively. In some application scenarios where stereo sound requirements are not particularly high (e.g., hearing aids for hearing patients, live teleprompter for hosts, etc.), the acoustic output device 4900 is also disposed with only one acoustic output unit 4910.

When the acoustic output device 4900 includes two acoustic output units 4910, as an example, the support structure 4920 includes two ear-hook assemblies and a rear hanging assembly. Two ends of the rear hanging assembly respectively connected to one end of the corresponding ear-hook assembly, and the other end of each ear-hook assembly departs from the rear hanging assembly is connected to a corresponding acoustic output unit 4910, respectively. Specifically, the rear hanging assembly is disposed in a curved shape for surrounding the back side of the head of the user, and the ear-hook assembly is disposed in a curved shape for hanging between the ear and the head of the user, which facilitates a realization of a wearing requirement of the acoustic output device 4900. In this way, when the acoustic output device 4900 is in a wearing state, the two acoustic output units 4910 are located on the left side and the right side of the head of the user, and the two acoustic output units 4910 are also pressed and held under the cooperation of the support structure 4920. The user is also able to hear the sound output by the acoustic output device 4900.

In some embodiments, the acoustic output unit 4910 in the present disclosure is a bone conduction speaker and/or an air conduction speaker. In some embodiments, the acoustic output device 4900 is an electronic device with an audio functionality, e.g., the acoustic output device 4900 may be a music headset, a hearing aid earphone, a bone conduction earphone, a hearing aid, audio glasses, a smart helmet, a VR device, an AR device, and other electronic devices.

FIG. 49A is a schematic diagram illustrating a structure of an acoustic output unit 4910 according to some embodiments of the present disclosure. As shown in FIG. 49A, the acoustic output unit 4910 includes a shell 4911, a transducer 4912, and a panel 4913 (also referred to as a vibration plate).

An accommodation cavity is formed in the shell 4911 for accommodating the transducer 4912. The transducer 4912 is disposed within the accommodation cavity of the shell 4911, and the panel 4913 is connected to the transducer 4912 and used to transmit mechanical vibrations generated by the transducer 4912 to a user. The support structure 4920 is connected to an outer side of the shell 4911. In some embodiments, the transducer 4912 converts the electrical signal into the mechanical vibration, and the panel 4913 is in contact with skin of the user in a wearing state, and the mechanical vibration generated by the transducer 4912 is transmitted to the panel and act on the auditory nerves of the user through the skin, bones, and/or tissues of the user, thereby creating a bone conduction sound. It is to be appreciated that the shell 4911 is rectangular, circular, rhombic, or polygonal, etc., or in any irregular shapes and combinations thereof, which are not limited to the shapes shown in the figure.

In some embodiments, the acoustic output unit 4910 further includes a damping sheet 4914.

The transducer 4912 is suspended within the accommodation cavity of the shell 4911 through the damping sheet 4914. The panel 4913 is not in contact with the shell 4911, at this time, due to the presence of the damping sheet 4914, the mechanical vibration generated by the transducer 4912 is less or even not transmitted to the shell 4911, thereby the shell 4911 is prevented from driving air outside the acoustic output unit 4910 to vibrate, which is beneficial for reducing a sound leakage of the acoustic output unit 4910. In some embodiments, the shell 4911 has an open end with an opening, and the panel 4913 is disposed outside of the shell 4911 and face the open end. That is to say, an edge of the panel 4913 is disconnected from the open end of the shell 4911. A connection rod member 49131 is disposed between the panel 4913 and the transducer 4912. The connection rod member 49131 is connected to the transducer 4912 at one end and connected to the panel 4913 at the other end penetrating out of the open end of the shell 4911 to keep the vibrating panel 4913 and the transducer 4912 from coming into contact with the shell 4911, so as to reduce the sound leakage of the acoustic output unit 4910. In some embodiments, the damping sheet 4914 is connected between the connection rod member 49131 and the shell 4911 to enable the suspension of the panel 4913 and the transducer 4912. In some embodiments, the shell 4911 also has at least one through hole (also known as a “sound leakage reduction hole”) for connecting the accommodation cavity of the shell 4911 to an exterior of the acoustic output unit 4910 to reduce the sound leakage of the acoustic output unit 4910.

In some embodiments, the acoustic output unit 4910 further includes a face-fitting cover (not shown in the figure) connected to the panel 4913. The face-fitting cover is used to come into contact with the skin of the user, i.e., the panel 4913 comes into contact with the skin of the user through the face-fitting cover. A Shore hardness of the face-fitting cover is less than the Shore hardness of the panel 4913, i.e., the face-fitting cover is softer than the panel 4913. For example, a material of the face-fitting cover is a soft material such as a silicone, and the material of the panel 4913 is a hard material such as a polycarbonate, or a glass fiber reinforced plastic. In this way, a wearing comfort of the acoustic output unit 4910 is improved, and the acoustic output unit 4910 is made to fit more closely to the skin of the user, which in turn improves a sound quality of the acoustic output unit 4910. In some embodiments, the face-fitting cover is detachably connected to the panel 4913 for an easy replacement by the user. For example, the face-fitting cover is socketed to the panel 4913.

Referring to FIG. 49A, the transducer 4912 includes a support 49121, a vibration transmission sheet 49122, a magnetic circuit assembly 49123, and a coil 49124. In some embodiments, the panel 4913 is connected to the support 49121. For example, the support 49121 is connected to an end of the connection rod member 49131 away from the panel 4913, as shown in FIG. 49A. The support 49121 is connected to the magnetic circuit assembly 49123 through the vibration transmission sheet 49122 to suspend the magnetic circuit assembly 49123 within the accommodation cavity of the shell 4911. In some embodiments, the damping sheet 4914 connects the support 49121 to the shell 4911 to suspend the transducer 4912 within the accommodation cavity of the shell 4911. The coil 49124 extends into a magnetic gap of the magnetic circuit assembly 49123 along a vibration direction of the transducer 4912.

In some embodiments, the magnetic circuit assembly 49123 includes a magnet assembly 491231 and a magnet conductive shield 491232. The magnetic conductive shield 491232 is socketed to the coil 49124, the magnet assembly 491231 is disposed within the coil 49124, and the magnetic conductive shield 491232 is spaced apart from the magnet assembly 491231 in a direction perpendicular to a vibration direction. An inner sidewall of the magnetic conductive shield 491232 and an outer side of the magnet assembly 491231 form the aforementioned magnetic gap. In some embodiments, the coil 49124 is socketed to the outer side of the magnet assembly 491231 around an axis parallel to the vibration direction of the transducer 4912. In some embodiments, the magnetic conductive shield 491232 of the magnetic circuit assembly 49123 is socketed around an axis parallel to the vibration direction of the transducer 4912 on the outside of the coil 49124, i.e., the magnetic conductive shield 491232 is spaced apart from the magnet assembly 491231 in a direction perpendicular to the vibration direction of the transducer 4912. Specifically, the coil 49124 is connected to the magnetic conductive shield 491232. In some embodiments of the present disclosure, the coil 49124 is affixed to an inner wall of the magnetic conductive shield 491232. In some embodiments, a vibration transmission sheet 49122 is connected between the magnetic conductive shield 491232 and the magnet assembly 491231 for elastically supporting the magnet assembly 491231. For example, the vibration transmission sheet 49122 and the magnetic circuit assembly 49123 are arranged along the vibration direction, and a side of the vibration transmission sheet 49122 perpendicular to the vibration direction is connected to the end of the magnetic conductive shield 491232 perpendicular to the vibration direction to realize the fixation of the magnetic circuit assembly 49123. It will be appreciated that in other embodiments of the present disclosure, a peripheral edge of the vibration transmission sheet 49122 is connected to the inner wall of the magnetic conductive shield 491232 or other positions to realize the fixation of the magnetic circuit assembly 49123 relative to the magnetic conductive shield 491232.

In some embodiments, the coil 49124 includes a first coil 491241 and a second coil 491242. In some embodiments, the first coil 491241 and the second coil 491242 are spaced apart in the vibration direction of the transducer 4912. The first coil 491241 extends into the magnetic gap of the magnetic circuit assembly 49123 from a side proximate to the panel 4913 in the vibration direction, and the second coil 491242 extends into the magnetic gap of the magnetic circuit assembly 49123 from a side away from the panel 4913 in the vibration direction. In some embodiments, to simplify the assembly process, the first coil 491241 and the second coil 491242 are extend together into the magnetic gap of the magnetic circuit assembly 49123 from the side proximate the panel 4913. In some embodiments, the transducer 4912 further includes a holding portion. The holding portion is used for holding and shaping the first coil 491241 and the second coil 491242. For example, the first coil 491241 and the second coil 491242 is an integrated structure. Specifically, the first coil 491241 and the second coil 491242 are wound on a shaping material and then adhered to the outside of the first coil 491241 and the second coil 491242 using the holding portion (e.g., a holding material such as a high-temperature adhesive tape) such that the first coil 491241 and the second coil 491242 form the integrated structure. The first coil 491241 and the second coil 491242 fixed to the holding portion penetrate deep into the magnetic gap of the magnetic circuit assembly 49123 from the same side of the panel 4913, thereby simplifying the assembly process of the coil 49124. In some embodiments, the two coils are wound by a same metal wire, or a section of the two coils is connected, so that there are only two leads for input and output of the two coils, which is convenient for wiring and facilitates subsequent electrical connection to other structures.

In some embodiments, the vibration transmission sheet 49122 (also referred to as an elastic support member) includes a first vibration transmission sheet 49125 and a second vibration transmission sheet 49126. The first vibration transmission sheet 49125 includes a center region 491252, a peripherally distributed edge region 491253, and a support rod 491251 connecting the two. The second vibration transmission sheet 49126 includes a center region 491262 and a peripherally distributed edge region 491263, and a support rod connecting the center region 491262 and the edge region 491263. In the vibration direction of the transducer 4912, the first vibration transmission sheet 49125 and the second vibration transmission sheet 49126 elastically support the magnet assembly 491231 from opposite sides of the magnet assembly 491231, respectively. In this manner, the magnet assembly 491231 in the embodiment of the present disclosure is elastically supported on opposite sides of the transducer 4912 in the vibration direction of the transducer 4912 so as to prevent the transducer 4912 from an abnormal vibration such as an obvious sway, which helps to increase the stability of the vibration of the transducer 4912.

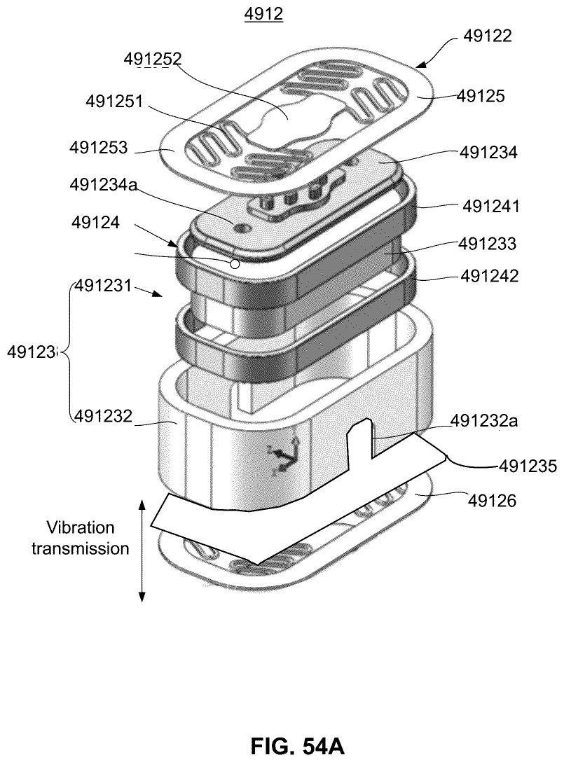

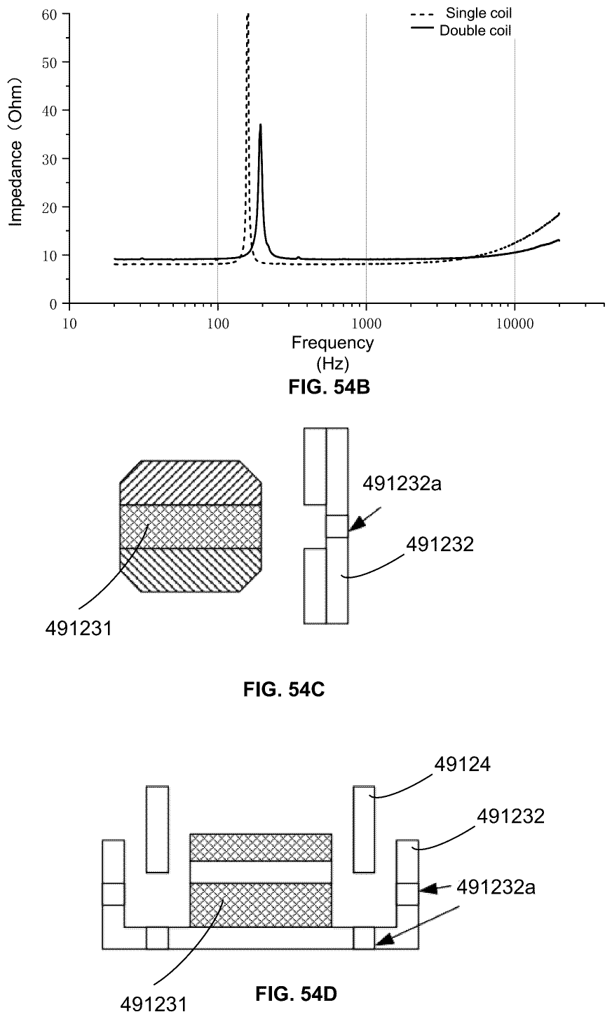

As an example, as shown in FIG. 49A, in the vibration direction, two portions of the edge region 491253 on opposite sides of the first vibration transmission sheet 49125 respectively connect the side of the support 49121 proximate to the magnetic circuit assembly 49123, and the side of the magnetic conductive shield 491232 proximate to the support 49121. The edge region 491263 of the second vibration transmission sheet 49126 is connected to the side of the magnetic conductive shield 491232 away from the support 49121. In some embodiments, the magnetic conductive shield 491232 is a cylindrical structure with open ends (e.g., as shown in FIGS. 49A-49B), a bow structure with one open end (e.g., as shown in FIG. 54D), etc. In some embodiments, by punching holes in the magnetic conductive shield 491232 (e.g., punching in the sidewall of the magnetic conductive shield of the cylindrical structure (e.g., as shown in FIG. 54C), or punching in a bottom and/or a side of the magnetic conductive shield of the bowl structure (e.g., as shown in FIG. 54D), etc.), a sound cavity effect of the magnetic circuit assembly 49123 is reduced, and thus reduces the sound leakage from the acoustic output device 4900. In some embodiments, the magnetic conductive shield 491232 is a closed structure, allowing no sound generated in the magnetic circuit assembly 49123 to leak. FIG. 49B is a schematic diagram illustrating a structure of a magnetic conductive shield 491232 according to some embodiments of the present disclosure. As shown in FIG. 49 B, two ends of the cylindrical structure with openings at both ends along the vibration direction of the transducer are closed by cover plates 491232-1 and 491232-2 to form the closed magnetic conductive shield 491232. It should be appreciated that the cover plates are only examples, and that other means (e.g., a cover film, etc.) can be used to close the opening ends of the cylindrical structure along the vibration direction to form the closed magnetic conductive shield 491232. In some other embodiments where a concentration requirement for the magnetic field generated by the magnet assembly 491231 is not very high, the magnetic conductive shield 491232 can be replaced with a non-magnetic member such as a plastic support. Based on this, the edge region 491253 of the first vibration transmission sheet 49125 and the edge region 491263 of the second vibration transmission sheet 49126 are connected to two ends of the plastic support, respectively.

In some embodiments, the magnet assembly 491231 includes a magnet 491233 and a magnetic conductive plate. In some embodiments, the magnet 491233 and the magnetic conductive plate are disposed in the vibration direction of the transducer 4912. In some embodiments, the magnetic conductive plate is disposed on one or both sides of the magnet 491233 in the vibration direction of the transducer 4912. In some embodiments, the magnetic conductive plate includes a first magnetic conductive plate 491234 and a second magnetic conductive plate 491235 disposed on opposite sides of the magnet 491233 in the vibration direction of the transducer 4912. The first vibration transmission sheet 49125 supports the magnet assembly 491231 from a side of the first magnetic conductive plate 491234 departs from the second magnetic conductive plate 491235, and the second vibration transmission sheet 49126 supports the magnet assembly 491231 from a side of the second magnetic conductive plate 491235 departs from the first magnetic conductive plate 491234. For example, the center region 491252 of the first vibration transmission sheet 49125 is connected to the side of the first magnetic conductive plate 491234 departs from the second magnetic conductive plate 491235. The center region 491262 of the second vibration transmission sheet 49126 is connected to the side of the second magnetic conductive plate 491235 departs from the first magnetic conductive plate 491234. In some embodiments, a corner of the magnetic conductive plate (e.g., the first magnetic conductive plate 491234 and/or the second magnetic conductive plate 491235) away from the magnet 491233 is a chamfer. For example, the corners on opposite sides (i.e., the corners away from the magnet 491233) of the first magnetic conductive plate 491234 and the second magnetic conductive plate 491235 are chamfered to adjust a distribution of the magnetic field formed by the magnetic circuit assembly 49123 to make the magnetic field more concentrated. In some embodiments, in the vibration direction of the transducer 4912, a half-height position of the first coil 491241 is equal in height to a half-thickness position on the edge line of the first magnetic conductive plate 491234 parallel to the vibration direction. The half-height position of the second coil 491242 is equal in height to the half-thickness position of the edge line of the second magnetic conductive plate 491235 parallel to the vibration direction. Thus, the magnetic field is centrally distributed in a rectangular portion other than the chamfer portion on the first magnetic conductive plate 491234 and/or the second magnetic conductive plate 491235. FIG. 49C is a schematic diagram illustrating positions of an exemplary first magnetic conductive plate 491234 and the first coil 491241 according to some embodiments of the present disclosure. As shown in FIG. 49 C, along a vibration direction of the transducer 4912, a half-height H1 of the first coil 491241 is at the same height of a half-thickness H2 of a sideline 491234-1 of the first magnetic conductive plate 491234 parallel to a vibration direction of the first magnetic conductive plate 491234, and both H1 and H2 are above the contour line L. In some embodiments, to simplify a fabrication of the magnetic conductive plate (e.g., the first magnetic conductive plate 491234 and/or the second magnetic conductive plate 491235), the corner of the magnetic conductive plate (e.g., the first magnetic conductive plate 491234 and/or the second magnetic conductive plate 491235) away from the magnet 491233 is a right angle. For example, the corners of the two sides of the first magnetic conductive plate 491234 and the second magnetic conductive plate 491235 depart from each other (i.e., the corners that are away from the magnet 491233) are not chamfered. In this case, in the vibration direction of the transducer 4912, the half-height position of the first coil 491241 is at the same height with the half-thickness position of the first magnetic conductive plate 491234, and the half-height position of the second coil 491242 is at the same height with the half-thickness position of the second magnetic conductive plate 491235, so that the magnetic field is centrally distributed on the first magnetic conductive plate 491234 and/or the second magnetic conductive plate 491235. Compared to the first magnetic conductive plate 491234 and the second magnetic conductive plate 491235 that are chamfered, the thicknesses of the first magnetic conductive plate 491234 and the second magnetic conductive plate 491235 that are not chamfered have smaller thicknesses to achieve the purpose of weight reduction and volume reduction of the entire transducer 4912.

In some embodiments, the magnetic conductive shield 491232 is connected to the support 49121. The support 49121 is connected to the shell 4911 through the damping sheet 4914, so as to suspend the transducer 4912 within an accommodation cavity of the shell 4911. At this time, as shown in FIG. 49 A, two ends of the edge region 491253 of the first vibration transmission sheet 49125 along a direction perpendicular to the vibration direction are connected to the support 49121 and the magnetic conductive shield 491232, respectively. Two ends of the edge region 491263 of the second vibration transmission sheet 49126 along the direction perpendicular to the vibration direction are connected to the magnetic conductive shield 491232. The panel 4913 is connected to the support 49121, and disconnected from the open end of the shell 4911.

In some embodiments, if the stiffness of the damping sheet 4914 is too small, it is difficult for the magnetic circuit assembly 49123 to be stably suspended in the shell 4911 by the damping sheet 4914, which easily leads to a poor stability of the transducer 4912 when vibrating. Conversely, if the stiffness of the damping sheet 4914 is too great, the vibration of the transducer 4912 is easily transmitted to the shell 4911 through the damping sheet 4914, which is likely to lead to an excessive sound leakage of the acoustic output unit 4910. In some embodiments, to provide a good stability for the transducer 4912 when it vibrates and to minimize the sound leakage from the acoustic output unit 4910, a ratio of the stiffness of the damping sheet 4914 to the stiffness of the first vibration transmission sheet 49125 (or the second vibration transmission sheet 49126) is in a range of 0.1-5. For a specific structure of the vibration transmission sheet (e.g., the first vibration transmission sheet 49125, second vibration transmission sheet 49126), please refer to the contents elsewhere in the present disclosure, e.g., FIGS. 46 and 47.

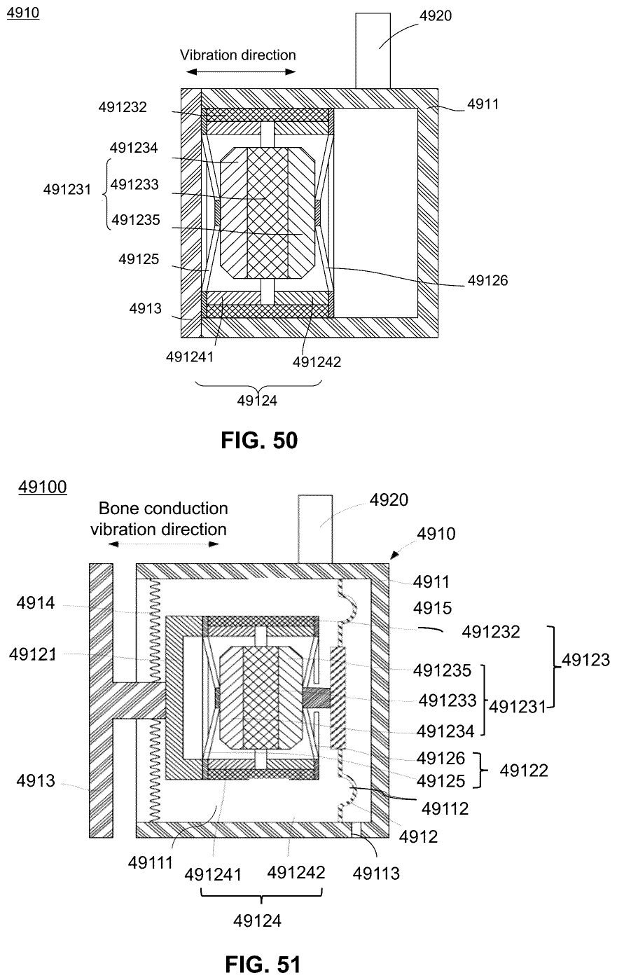

FIG. 50 is a schematic diagram illustrating a structure of the acoustic output unit 4910 according to some embodiments of the present disclosure. Referring to FIG. 50, this embodiment of the acoustic output unit 4910 is essentially the same as that of the embodiment shown in FIG. 49A. The main difference is that, in this embodiment, the magnetic conductive shield 491232 is set to be rigidly connected with the shell 4911 or panel 4913, i.e., the damping sheet 4914 does not exist in this embodiment. Moreover, in this embodiment, the magnet conductive shield 491232 is fitted to an inner wall of the shell 4911 to fully utilize an internal space of the shell 4911, which is beneficial for realizing a miniaturization of the acoustic output unit 4910. It is to be understood that in other embodiments of the present disclosure, the magnetic conductive shield 1232 is rigidly connected to the shell 4911 or the panel 4913 by other fixing structures. In some embodiments, an edge region (e.g., the edge region 491253 or the edge region 491263) of any one of the first vibration transmission sheet 49125 and the second vibration transmission sheet 49126 is connected to an open end of the shell 4911 by one or a combination of assembling manners such as a snap-fitting, a gluing, etc., and the panel 4913 is connected to the open end of the shell 4911 to form a closed cavity. In some embodiments, a side surface of any one of the first vibration transmission sheet 49125 and the second vibration transmission sheet 49126 proximate to the panel 4913 is connected to the panel 4913, and the panel 4913 is connected to the open end of the shell 4911. In some embodiments, the panel 4913 is made of the same material as shell 4911 and formed as a single unit. In some embodiments, the panel 4913 is made of different materials from the shell 4911 and connected by one or a combination of the assembly manners such as the snap-fit, the gluing, etc.

In some embodiments, the acoustic output unit 4910 further includes an additional element disposed within an accommodation cavity of the shell 4911, or fitted to an outer side of the shell 4911. In some embodiments, the additional element includes a vibration sensitive element and a non-vibration sensitive element. Merely by way of example, the vibration sensitive element includes an air conduction speaker, an accelerometer, etc. The non-vibration sensitive element includes a battery, a circuit board, etc. The battery is used for supplying power for the acoustic output unit 4910 to enable the acoustic output unit 4910 to operate. The circuit board is used to integrate a signal processing circuit. The signal processing circuit is used for signal processing of an electrical signal. In some embodiments, the signal processing includes a frequency modulation processing, an amplitude modulation processing, a filtering processing, a noise reduction processing, etc. The air conduction speaker is used to convert the electrical signal into a vibration signal (sound waves) that is conducted through air to auditory nerves and perceived by the user. The acceleration sensor is used to determine a vibration acceleration of the panel 4913. Related contents of the settings of the air conduction speaker and the accelerometer sensor, settings can be found below, for example, in the descriptions of FIGS. 51-56.

In various embodiments illustrated in FIG. 49 A and FIG. 50, the acoustic output unit 4910 is a bone conduction speaker. The following combines FIGS. 4-56 to illustrate embodiments where the acoustic output device 4900 is the bone conduction speaker or a bone-air conduction earphone.

FIG. 51 is a schematic diagram illustrating a structure of the acoustic output unit 4910 according to some embodiments of the present disclosure. The acoustic output unit 4910 shown in FIG. 51 is essentially the same as the acoustic output unit 4910 shown in FIG. 49A. A main difference is that an additional element of the acoustic output unit 4910 includes an air conduction speaker, and the air conduction speaker is disposed in an accommodation cavity of the shell 4911. As shown in FIG. 51, the acoustic output unit 4910 includes the transducer 4912 and the shell 4911 accommodating the transducer 4912. The transducer 4912 includes the magnetic circuit assembly 49123 (including the magnetic conductive shield 491232 and the magnet assembly 491231), the coil 49124 (including the first coil 491241 and the second coil 491242), a vibration transmission sheet 49122 (including the first vibration transmission sheet 49125 and the second vibration transmission sheet 49126). The coil 49124 is disposed in magnetic circuit assembly 49123, so as to make a magnetic field of the magnetic circuit assembly 49123 pass through the coil 49124. The first vibration transmission sheet 49125 and the second vibration transmission sheet 49126 elastically support the magnet assembly 491231. The air conduction speaker includes a diaphragm 4915 connected between the magnet assembly 491231 and the shell 4911. The diaphragm 4915 separates an interior space of the shell 4911 (i.e., the aforementioned accommodation cavity) into a front cavity 49111 near a skin contact region (e.g., the panel 4913) and a rear cavity 49112 away from the aforementioned skin contact region. In other words, when a user wears the acoustic output unit 4910, the front cavity 49111 is closer to the user compared to the rear cavity 49112. In some embodiments, the shell 4911 is disposed with a sound outlet 49113 that is connected to the rear cavity 49112, and the diaphragm 4915 is capable of generating an air conduction sound transmitted through the sound outlet 49113 to the human ear during a relative movement of the transducer 4912 and the shell 4911. In this way, the sound generated in the rear cavity 49112 is transmitted through the sound outlet 49113 and then act on a tympanic membrane of the user through the air, so that the user is also able to hear the air conduction sound through the acoustic output unit 4910.

In some embodiments, the diaphragm 4915 of the air conduction speaker is connected between the magnet assembly 491231 and the shell 4911 of the transducer 4912, and the vibration direction of the diaphragm 4915 is parallel to the vibration direction of the transducer 4912. Referring to FIG. 51, when the transducer 4912 makes the skin contact region to move in a direction proximate to a face of the user, this is simply regarded as an enhancement of the bone conduction sound. At the same time, a portion of the shell 4911 corresponding to the skin contact region moves in the direction proximate to the face of the user, and the magnet assembly 491231 moves in the direction away from the face of the user due to a relationship between a force of the action and a reaction force. As a result, the air in the rear cavity 49112 is squeezed, which corresponds to an increase in air pressure, which enhances the sound transmitted through the sound outlet 49113, which is simply regarded as an enhancement of the air conduction sound.

Thus, the bone conduction sound and the air conduction sound of the acoustic output unit 4910 are enhanced simultaneously. Correspondingly, when the bone conduction sound is weakened, the air conduction sound is weakened. Based on this, the bone conduction sound and the air conduction sound generated by the acoustic output unit 4910 have the same phase. Furthermore, if the front cavity 49111 is a closed cavity, as the front cavity 49111 is substantially separated from the rear cavity 49112 by structural members such as the diaphragm 4915 and the transducer 4912, a law of change of the air pressure in the front cavity 49111 is exactly the opposite to the law of change of the air pressure in the rear cavity 49112. In some embodiments, the shell 4911 is disposed with a pressure relief hole connected to the front cavity 49111, or the front cavity 49111 is set as an opening, so that the front cavity 49111 is connected to an external environment, that is, the air freely enters and exits the front cavity 49111. In this manner, the change of the air pressure in the rear cavity 49112 is as far as possible from being stagnated by the front cavity 49111, which effectively improves an acoustic expressiveness of the air conduction sound generated by the acoustic output unit 4910. In some embodiments, the pressure relief hole disposed in the front cavity 49111 is staggered from each other with the sound outlet 49113 disposed in the rear cavity 49112, i.e., the pressure relief hole and the sound outlet 49113 are not adjacent to each other. For example, the pressure relief hole is disposed on one side of the shell 4911, and the sound outlet 49113 is disposed on the other side of the shell 4911 relative to the pressure relief hole, so as to avoid, as much as possible, muffling of the two due to their opposite phases.

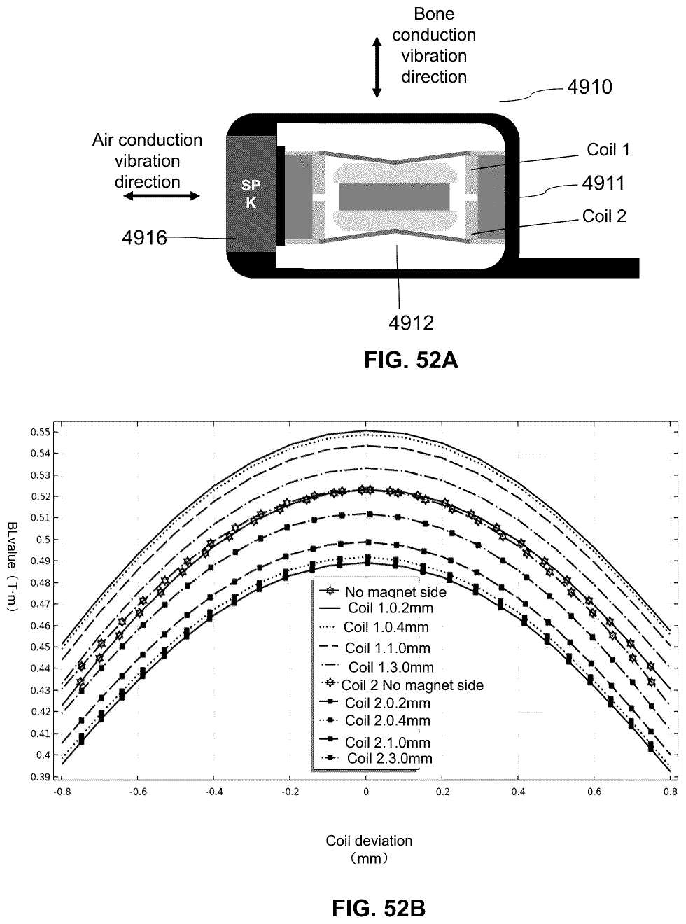

In some embodiments, to avoid the air conduction speaker from being affected by the vibration of the transducer 4912 and resonating to generate a sound leakage peak, the air conduction vibration direction of the air conduction speaker is made to be different from the vibration direction (i.e., the bone conduction vibration direction) of the transducer 4912 to prevent a mutual influence in the same direction. FIG. 52A is a schematic diagram illustrating a structure of the acoustic output unit 4910 according to some embodiments of the present disclosure. As shown in FIG. 52A, the air conduction speaker 4916 is disposed on a sidewall of the shell 4911. The air conduction speaker 4916 is connected to the transducer 4912, and the transducer 4912 and the shell 4911 in the acoustic output unit 4910 form a bone conduction speaker. The bone conduction speaker combines with the air conduction speaker 4916 to form a bone-air conduction speaker. In some embodiments, an air conduction vibration direction of the air conduction speaker 4916 is different from a vibration direction of the transducer 4912 (i.e., a bone conduction vibration direction). In some embodiments, the vibration direction of the transducer 4912 is set to be approximately perpendicular to the air conduction vibration direction of the air conduction speaker 4916. For example, the vibration direction of the transducer 4912 is set approximately perpendicular to the vibration direction of a diaphragm of the air conduction speaker 4916 to minimize a sound leakage of the air conduction speaker. The “approximately perpendicular” described in the present disclosure means that an angle between the two portions is within a range of 90°±20°. For example, the angle between the vibration direction of the transducer 4912 and the air conduction vibration direction of the air conduction speaker 4916 (or the diaphragm of the air conduction speaker 4916) is in the range of 90°±20°. For example, the vibration direction of the transducer 4912 is set to be perpendicular to the diaphragm of the air conduction speaker 4916. In some embodiments, the distance between the bone conduction speaker and the air conduction speaker 4916 is greater than a distance threshold so as to avoid generating an electromagnetic field between electromagnetic components of the bone conduction speaker and the air conduction speaker 4916, which affects a vibration output of the bone conduction speaker and the air conduction speaker 4916. The “distance between the bone conduction speaker and the air conduction speaker 4916” described in the present disclosure refers to a minimum distance between the magnetic component of the bone conduction speaker and the magnetic component of the air conduction speaker 4916. FIG. 52B is a comparison diagram illustrating the effects of different distances between a bone conduction speaker and an air conduction speaker 4916 on a magnetic field of a coil according to some embodiments of the present disclosure. As shown in FIG. 52 B, when the air conduction speaker 4916 is magnetized to the right as shown in FIG. 52A, the magnet assembly 491231 in the transducer 4912 is magnetized upwardly, resulting in an increase of an average magnetic field strength at coil 1 located above and a decrease of the average magnetic field strength at coil 2 located below in the transducer 4912. As a distance between the transducer 4912 of the bone conduction speaker and the air conduction speaker 4916 increases, the coil 1 and the sides of the coil 2 converge to magnet-free condition. Thus, the greater the distance between the transducer 4912 of the bone conduction speaker and the air conduction speaker 4916, the smaller the effect on the magnetic field of the coil in the transducer 4912. In some embodiments, to reduce the effect of the electromagnetic field generated between the electromagnetic components of the bone conduction speaker and the air conduction speaker 4916 on the magnetic field in the coil, the distance between the bone conduction speaker and the air conduction speaker 4916 is greater than 0.3 mm. For example, the distance between the bone conduction speaker and the air conduction speaker 4916 is greater than 0.4 mm.

In some embodiments, to avoid an accelerometer sensor being affected by the vibration of the transducer 4912 when detecting an acceleration of the panel 4913, the vibration direction of the transducer 4912 is made approximately perpendicular to a vibration sensitive end of the accelerometer sensor.

It should be noted that when the additional element is a vibration sensitive element such as the air conduction speaker or the accelerometer sensor, the vibration sensitive element is approximately perpendicular to the vibration direction of the transducer 4912 to avoid that the vibration sensitive element is affected by vibration of the transducer. The “vibration sensitive element being approximately perpendicular to the vibration direction of the transducer 4912” as described in the present disclosure refers to that when the vibration sensitive element is the air conduction speaker, the vibration direction of the transducer 4912 is approximately perpendicular to the vibration direction of the transducer 4912; when the vibration sensitive element is an acceleration sensor, the vibration direction of the transducer 4912 is approximately perpendicular to the vibration sensitive end of the acceleration sensor. When the additional element is a non-vibration sensitive element such as a battery or a circuit board, the battery or the circuit board are placed at any position within the shell 4911 to achieve an integrated design of the acoustic output device 4900.

It is appreciated that in some embodiments, the additional element includes a vibration sensitive element and a non-vibration sensitive element. The vibration sensitive element is approximately perpendicular to the vibration direction of the transducer 4912. For example, in some embodiments, the additional element includes an accelerometer sensor that is vibration sensitive and a circuit board that is not vibration-sensitive. The accelerometer sensor is disposed on the circuit board and accommodated in the shell of the acoustic output unit 4910 to enable the integration of the acoustic output device. At this point, the acceleration sensor is approximately perpendicular to the vibration direction of the transducer 4912.

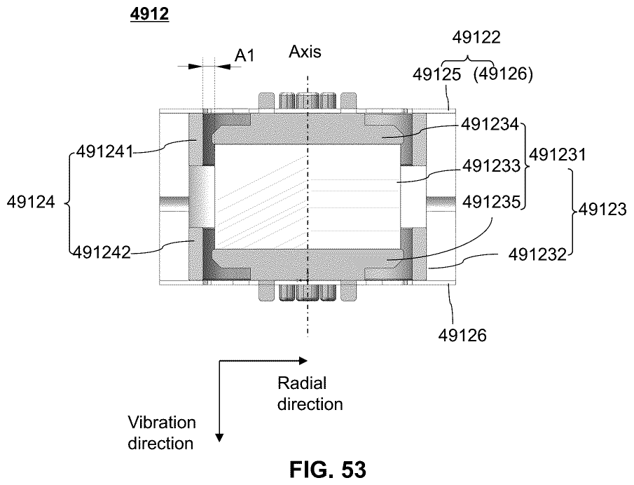

FIG. 53 is a schematic diagram illustrating a structure of the transducer 4912 according to some embodiments of the present disclosure. FIG. 54A is an exploded diagram illustrating the transducer 4912 according to some embodiments of the present disclosure. The transducer 4912 illustrated in FIG. 53 and FIG. 54A can be used in any of the acoustic output units 4910 shown in FIG. 49A-FIG. 52A. As shown in FIG. 53 and FIG. 54 A, the transducer 4912 includes the vibration transmission sheet 49122, the magnetic circuit assembly 49123, and the coil 49124. The magnetic circuit assembly 49123 includes the magnet assembly 491231 and the magnetic conductive shield 491232. The magnet assembly 491231 includes the magnet 491233, and the first magnetic conductive plate 491234 and the second magnetic conductive plate 491235 disposed on two opposite sides of the magnet 491233 in the vibration direction of the transducer 4912. In some embodiments, the magnetic conductive shield 491232 is disposed around an axis on the outer side of the magnet assembly 491231. The coil 49124 is within the magnetic field of the magnet assembly 491231. In some embodiments, the coil 49124 extends into a magnetic gap formed between the magnetic conductive shield 491232 and the magnet assembly 491231 along the vibration direction of the transducer 4912. The magnetic conductive shield 491232 is sleeved on the outside of the coil 49124. In some embodiments, the inner wall of the magnetic conductive shield 491232 is fitted to the outer wall of the coil 49124. In some embodiments, the vibration transmission sheet 49122 includes the first vibration transmission sheet 49125 and the second vibration transmission sheet 49126. The first vibration transmission sheet 49125 elastically supports the magnet assembly 491231 from the side of the first magnetic conductive plate 491234 depart from the second magnetic conductive plate 491235, and the second vibration transmission sheet 49126 elastically supports the magnet assembly 491231 from the side of the second magnetic conductive plate 491235 departs from the first magnetic conductive plate 491234. For example, the edge region 491253 of the first vibration transmission sheet 49125 is connected to one end of the magnetic conductive shield 491232 along the vibration direction of the transducer 4912, the second edge region 491263 of vibration transmission sheet 49126 is connected to the other end of magnetic conductive shield 491232 along the vibration direction of the transducer 4912.

In some embodiments, to facilitate an assembly of a lead of the coil 49124, so that incoming and outgoing positions of the coil 49124 are located at the same position in the magnetic conductive shield 491232, a number of coils 49124 along a radial direction of the transducer 4912 is an even number. For example, the number of a radial turns of the coil is 2, 4, 6, 8, etc. As shown in FIG. 53, the radial direction of the transducer 4912 is a direction perpendicular to an axis of the transducer 4912 (or the vibration direction of the transducer 4912).

In some embodiments, the coil 49124 includes the first coil 491241 and the second coil 491242. In some embodiments, the first coil 491241 and the second coil 491242 are distributed at intervals along the vibration direction of the transducer 4912. The first coil 491241 and the second coil 491242 are connected in series or in parallel. In the first coil 491241 and the second coil 491242 connected in series or parallel, the incoming position and the outgoing position of each coil are located at the same position of the magnetic conductive shield 491232 to facilitate the assembly of the leads of the first coil 491241 and the second coil 491242. The incoming position of the first coil 491241 and the outgoing position of the first coil 491241 are both located at the same position of the magnetic conductive shield 491232, and the incoming position of the second coil 491242 and the outgoing position of the second coil 491242 are both located at the same position of the magnetic conductive shield 491232. For example, the incoming position of the first coil 491241 and the outgoing position of the first coil 491241, the incoming position of the second coil 491242 and the outgoing position of the second coil 491242 are all located in the middle of the magnetic conductive shield 491232 (e.g., in the middle of the magnetic conductive shield 491232 along a direction perpendicular to the vibration direction of the transducer 4912). In some embodiments, winding directions of the first coil 491241 and the second coil 491242 are opposite, or directions of currents in the first coil 491241 and the second coil 491242 are opposite. The transducer 4912 vibrates relatively driven by the dual coils (i.e., the coil 49124 include the first coil 491241 and the second coil 491242), and the magnitude of vibration of the transducer 4912 is increased relative to the single voice coil 4912. In some embodiments, a lower high frequency impedance is achieved by employing a dual coil configuration. FIG. 54B is a comparison diagram illustrating the impedances of transducers of a single voice coil and a dual voice coil according to some embodiments of the present disclosure. As shown in FIG. 54 B, a high frequency impedance of a dual voice coil is lower relative to a single voice coil structure.

In some embodiments, too small impedance causes an increase in current under a same battery power supply voltage. As a result, on the one hand, more power is consumed and the battery life decreases under the same battery capacity, and on the other hand, if the battery cannot output the increased current, it may cause clipping distortion. Excessive impedance causes a decrease in current and sensitivity under the same battery supply voltage, which manifests as a decrease in sound volume. Therefore, to balance the battery life, the distortion, the sensitivity, the volume, etc., an overall direct current (DC) impedance of the coil 49124 is in a range of 6 Q-10 Q. In some embodiments, for the first coil 491241 and the second coil 491242 in the transducer 4912, the first coil 491241 and the second coil 491242 are designed according to the following requirements.

First, to ensure that the overall DC impedance of the coil 49124 including the first coil 491241 and the second coil 491242 is in a range of 6 Q-10 Q, a range of the DC impedance of the individual coil (the first coil 491241 and the second coil 491242) vary depends on different connection manners (series or parallel). For example, to ensure that the overall DC impedance of the coil 49124 is 8 Q, when the dual coils are connected in series, the individual coil (the first coil 491241 and the second coil 491242) has a DC impedance of 4Ω, and when the dual coils are connected in parallel, the individual coil (the first coil 491241 and the second coil 491242) has a DC impedance of 16Ω.

Secondly, to minimize an overall mass of the acoustic output unit 4910, by reducing a volume of the magnetic conductive shield 491232 and thus reducing the mass of the magnetic conductive shield 491232, an inner wall of the magnetic conductive shield 491232 is fitted to outer walls of the coils 49124 (including the first coil 491241 and the second coil 491242). On a premise of a spacing between the first coil 491241 and the second coil 491242 along the vibration direction of the transducer being in a range of 1.5 mm-2 mm, shapes of the coil 49124 (the first coil 491241 and the second coil 491242) are made as a “slender type”, i.e., to increase an axial height of the coil 49124 and to reduce a radial width of the coil 49124. At this time, an inner diameter of the magnetic conductive shield 491232 is also reduced, and an outer diameter of the magnetic conductive shield 491232 is simultaneously reduced when a thickness of the magnetic conductive shield 491232 remains unchanged, so that the mass of magnetic conductive shield 491232 and the mass of the acoustic output unit 4910 are also reduced accordingly. In some embodiments, by designing a wire diameter, a number of radial turns, a number of axial turns, and other parameters of the coil 49124 (the first coil 491241 and the second coil 491242), the shape of the coil 49124 (the first coil 491241 and the second coil 491242) can be made to be the “slender type” to meet the above requirements. In some embodiments, to make the shape of the coil 49124 (the first coil 491241 and the second coil 491242) to be the “slender type,” a ratio of the axial height to the radial width of the first coil or the second coil is not less than 3. For example, the ratio of the axial height to the radial width of the first coil or the second coil may be not less than 3.5.

Further, as the axial height of the transducer 4912 is mainly limited by a size of the magnet assembly 491231 disposed inside, to satisfy a size requirement of the transducer 4912 (e.g., when the acoustic output device 4900 is an earphone, to satisfy that the height of the acoustic output unit 4910 in the earphone is in a range of less than 5.7 mm), the axial height of the individual coil (the first coil 491241 and/or second coil 491242) is in a range of less than 2.85 mm. For example, the axial height of the single coil (first coil 491241 and/or second coil 491242) is about 2 mm.

To satisfy the above requirements, in some embodiments, the first coil 491241 and the second coil 491242 are connected in series. To ensure that an overall DC impedance of the coil 49124 is in a range of 6 Q-10 Q, the DC impedance of the first coil 491241 and/or the DC impedance of the second coil 491242 is in a range of 4 Q±1 Q. For example, to satisfy that the overall DC impedance of the coil 49124 is in a range of 7 Q-9 Q, the DC impedance of the first coil 491241 and/or the DC impedance of the second coil 491242 is in a range of 3.5 Q-4.5 Q. Further example, to satisfy that the overall DC impedance of the coil 49124 is in a range of 8 Q±0.8 Q, the DC impedance of the first coil 491241 and/or the DC impedance of the second coil 491242 is in a range of 4 Q±0.4 Q. In some embodiments, the diameters of the wires in the first coil 491241 and the second coil 491242 are in a range of 0.11 mm-0.13 mm.

To satisfy the above requirements, in some embodiments, the first coil 491241 and/or the second coil 491242 may satisfy one of the following features: a wire diameter is 0.11 mm, a number of radial turns is 2-6, and a number of axial layers is 8-20; the wire diameter is 0.12 mm, the number of radial turns is 2-6, and the number of axial layers is 9-20; and the wire diameter is 0.13 mm, the number of radial turns is 2-6, and the number of axial layers is 10-22. For example, the first coil 491241 and/or the second coil 491242 has the wire diameter of 0.11 mm, the radial number of turns is 3-5, and an axial number of layers is 12-20. For another example, the wire diameter of the first coil 491241 and/or the second coil 491242 is 0.12 mm, the number of radial turns is 3-5, and the number of axial layers is 14-20 layers. For another example, the wire diameter of the first coil 491241 and/or the second coil 491242 is 0.13 mm, the number of radial turns is 3-4, and the number of axial layers is 15-22 layers.

In some embodiments, a relationship among the wire diameter, the number of radial turns, the number of axial layers, and the DC impedance of individual coils (the first coil 491241 and/or the second coil 491242) connected in series is shown in Table 1.

TABLE 1

| Wire diameter | Number of | Number of | DC Impedance |
|---|---|---|---|
| mm | radial turns | axial layers | Ω |
| 0.11 | 4 | 12 | 4.00 |
| 0.11 | 4 | 13 | 4.33 |
| 0.11 | 5 | 11 | 3.66 |
| 0.12 | 4 | 14 | 3.93 |
| 0.12 | 4 | 15 | 4.21 |
| 0.13 | 4 | 17 | 4.08 |
| 0.13 | 4 | 18 | 4.32 |
| 0.13 | 4 | 16 | 3.84 |

According to Table 1, to make the DC impedance of the single coil (the first coil 491241 or the second coil 491242) in a range of 4 Ω±1Ω while the number of turns of the coil in the radial direction is an even number, the wire diameter of the exemplary first coil 491241 and/or the second coil 491242 is 0.11 mm, the number of radial turns is 4, and the number of axial layers is 12. At this time, the DC impedance of the first coil 491241 and/or the second coil 491242 is 4 Q. For another example, the wire diameter is 0.12 mm, the number of radial turns is 4, and the number of axial layers is 14. At this time, the DC impedance of the first coil 491241 and/or the second coil 491242 is 3.93 Q. As a further example, the wire diameter is 0.12 mm, the number of radial turns is 4, and the number of axial layers is 15. At this point, the DC impedance of the first coil 491241 and/or the second coil 491242 is 4 Q. As still a further example, the wire diameter is 0.13 mm, the number of radial turns is 4, and the number of axial layers is 18. At this point, the DC impedance of the first coil 491241 and/or the second coil 491242 is 4.08Ω.

In some embodiments, the first coil 491241 and the second coil 491242 are connected in parallel, and to ensure that the overall DC impedance of the coil 49124 is in a range of 6Ω-10Ω, the first coil 491241 and/or the second coil 491242 each has the DC impedance in a range of 12Ω-20Ω. For example, to satisfy that the overall DC impedance of the coil 49124 is in a range of 8 Ω 0.8 Q, the DC impedance of the first coil 491241 and/or the second coil 491242 is in a range of 16 Ω 1.6 Q. In some embodiments, the diameters of the wires in the first coil 491241 and the second coil 491242 are in a range of 0.07 mm-0.08 mm.

To satisfy the above requirements, in some embodiments, the number of radial turns of the first coil 491241 and/or the second coil 491242 is in a range of 4-8 and the number of axial layers is in a range of 16-22. For example, the number of radial turns of the first coil 491241 and/or the second coil 491242 is in a range of 4-6 and the number of axial layers is in a range of 17-20.

In some embodiments, to make the DC impedance of the single coil (the first coil 491241 or the second coil 491242) in a range of 16 Ω±1.6Ω while the number of coil turns in the radial direction is an even number, a relationship among the wire diameter, the number of turns in the radial direction, the number of layers, and the DC impedance of the exemplary parallel-connected single coil (the first coil 491241 and/or the second coil 491242) is shown in Table 2. For example, the wire diameter of the single coil (the first coil 491241 and/or the second coil 491242) connected in parallel is 0.08 mm, a number of radial turns is 6, an axial number of layers is 17, and a corresponding DC impedance is 16.16Ω. For another example, the wire diameter of the single coil (the first coil 491241 and/or the second coil 491242) connected in parallel is 0.08 mm, a number of radial turns is 4, and an axial number of layers is 20, and a corresponding DC impedance is 16.27Ω.

TABLE 2

| Wire diameter | Number of | Number of | DC Impedance |
|---|---|---|---|
| mm | radial turns | axial layers | Ω |
| 0.08 | 6 | 17 | 16.16 |
| 0.07 | 4 | 20 | 16.27 |

In some embodiments, as shown in FIG. 51 or FIG. 53, the coil 49124 is sleeved around an axis parallel to the vibration direction on the outside of the magnet assembly 491231, and a magnetic conductive shield 491232 is sleeved around the axis on the outer side of the coil 49124. A magnetic gap A1 is set between the coil 49124 and the magnet assembly 491231. The magnetic gap A1 refers to a magnetic gap formed between an inner wall of the coil 49124 and an outer wall of the magnet 491233 in the magnet assembly 491231. If the magnetic gap A1 is too great, the strength of the magnetic field can be reduced, and if the magnetic gap A1 is too small, a machining process can be difficult to be realized. Thus, in some embodiments, to balance the magnetic field strength and the realization of the machining process, the width of the magnetic gap A1 along the radial direction is in a range of 0.25 mm-0.35 mm. For example, the magnetic gap A1 is in a range of 0.27 mm-0.33 mm. Further example, the magnetic gap A1 is in a range of 0.29 mm-0.31 mm. For another example, the magnetic gap A1 between the coil 49124 and the magnet assembly 491231 is 0.3 mm. In some embodiments, under a premise of satisfying the width requirement of magnetic gap A1, a radial elasticity of the vibration transmission sheet (e.g., the first vibration transmission sheet 49125 and the second vibration transmission sheet 49126) is designed after selecting a suitably sized magnet 491233, so as to obtain a condition to be satisfied for resisting attraction of the magnet 491233.

In some embodiments, to avoid a magnetic saturation of the magnetic shield 491232, which is not conducive to the improvement of the magnetic field strength, a thickness of the magnetic conductive shield 491232 along the radial direction of the transducer 4912 cannot be too thin. In some embodiments, the thickness of the magnetic conductive shield 491232 along the radial direction of the transducer 4912 is no less than 0.3 mm. At the same time, a too-thick magnetic conductive shield 491232 can increase the thickness of the transducer 4912, and thus the thickness of the magnetic conductive shield 491232 cannot be too thick. Thus, to balance between the weight reduction and avoiding magnetic saturation, the thickness of the magnetic conductive shield 491232 along the radial direction of the transducer 4912 is in a range of 0.3 mm-1 mm. For example, the thickness of the magnetic conductive shield 491232 is in a range of 0.4 mm-0.9 mm. For another example, the thickness of the magnetic conductive shield 491232 is in a range of 0.5 mm-0.8 mm. In some embodiments, referring to FIG. 54A, to further reduce the mass of the transducer 4912 (and thus reduce the mass of the acoustic output unit 4910), the magnetic conductive shield 491232 has a weight reduction construction 491232a thereon. The weight reduction construction 491232a includes a weight reduction groove, a weight reduction hole, etc., that are disposed in the magnetic conductive shield 491232. The weight reduction groove or the weight reduction hole is a removal structure of any shape or any construction. For example, the weight reduction groove is a through groove or recesses with any cross-section on the magnetic conductive shield 491232. For another example, the weight reduction groove is an annular groove disposed in the inner wall of the magnetic conductive shield 491232. In some embodiments, the weight reduction groove is a rectangular through groove that extends through the sidewall of the magnetic conductive shield 491232 and extends to an end surface of the magnetic conductive shield 491232 along the vibration direction. FIG. 54C is a schematic diagram illustrating a portion of a cylindrical magnetic conductive shield 491232 according to some embodiments of the present disclosure. FIG. 54D is a schematic diagram illustrating a bowl-shaped magnetic conductive shield 491232 according to some embodiments of the present disclosure. As shown in FIG. 54 C, the weight reduction construction 491232a includes a weight reduction hole disposed on a sidewall of the cylindrical magnetic conductive shield 491232. As shown in FIG. 54D, the weight reduction construction 491232a includes the weight reduction hole disposed in the sidewall and/or a bottom of the bowl-shaped magnetic conductive shield 491232.

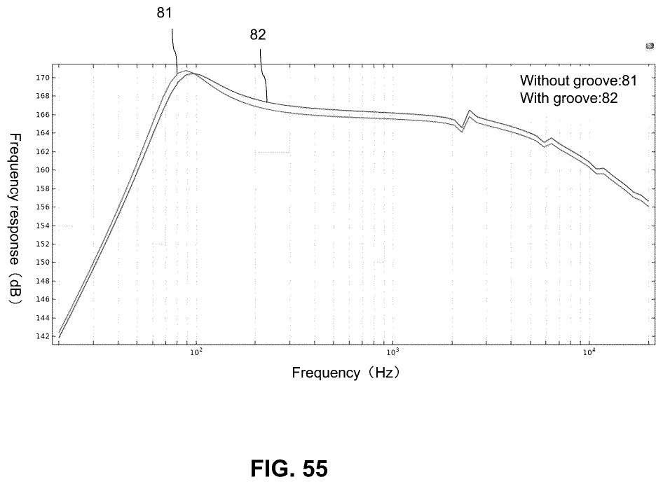

FIG. 55 is a comparison diagram illustrating frequency response curves of the magnetic conductive shield 491232 with and without grooves. As shown in FIG. 55, a horizontal axis indicates frequency (Hz), a vertical axis indicates frequency response (dB), curve 81 is the frequency response curve of the transducer 4912 without a groove, and curve 82 is the frequency response curve of the transducer 4912 with a groove. As shown in FIG. 55, the frequency corresponding to a resonance peak of curve 82 is higher than the frequency corresponding to the resonance peak of curve 81, and thus, after disposed with the groove, a mass of the magnetic conductive shield 491232 is reduced, so that the mass of the transducer 4912 decreases, thereby increasing a resonant frequency of the transducer 4912. At the same time, after the resonant frequency (about 100 Hz), the frequency response of the transducer 4912 with the groove is greater than the frequency response of the transducer 4912 without the groove at the same frequency, enhancing the sound quality of the transducer 4912.

In some embodiments, a shape of an outer diameter of the magnetic conductive shield 491232 is rectangular, elliptical, circular, runway, polygonal, etc. For example, as shown in FIG. 54 A, the shape of the outer diameter of the magnetic conductive shield 491232 is a runway shape, and the runway shape corresponds to an equivalent rectangle that has a length of less than 20 mm and a width of less than 12 mm. For another example, the equivalent rectangle corresponding to magnetic conductive shield 491232 has a length and width of 18.1 and 10.1 mm, respectively. The runway shape described in the present disclosure is typically a closed loop formed by connecting the ends of two arcs to the ends of two straight lines, respectively. For example, the runway shape is also a rounded rectangle, i.e., a rectangle in which all four right angles are replaced with rounded corners. The length/width of the equivalent rectangle here refers to the length/width of the rectangle corresponding to the runway shape (i.e., the shape after replacing the four rounded corners of the runway shape with right angles).

In some embodiments, the magnet assembly 491231 includes the magnet 491233, and a magnetic conductive plate disposed on one side of the magnet 491233 in a vibration direction of the transducer 4912. When the magnetic conductive plate is too thin, it is easy to be magnetically saturated, and a strength of the magnetic field at a coil is reduced accordingly; and when the magnetic conductive plate is too thick, due to a limitation of an overall volume of the magnet assembly 491231, it is likely to result in the magnet 491233 to be too thin, and thus the magnetic field strength generated is too low. Therefore, to increase the strength of the magnetic field and to avoid the magnetic saturation, a ratio of the thickness of the magnetic conductive plate to the thickness of the magnet 491233 is in a range of 0.05-0.35. For example, the ratio of the thickness of the magnetic conductive plate to the thickness of the magnet 491233 is in a range of 0.15-0.3. In some embodiments, the magnetic conductive plate includes a first magnetic conductive plate 491234 and a second magnetic conductive plate 491235. The first magnetic conductive plate 491234 is disposed on one side of the magnet 491233 in the vibration direction of the transducer 4912, and the second magnetic conductive plate 491235 is disposed on the other side of the magnet 491233 in the vibration direction of the transducer 4912. A ratio of a thickness of the first magnetic conductive plate 491234 or the second magnetic conductive plate 491235 (hereinafter referred to as the magnetic conductive plate) to the thickness of the magnet 491233 is in a range of 0.05-0.35. In some embodiments, to increase the strength of the magnetic field and to avoid the magnetic saturation, the thickness of the magnetic conductive plate (the first magnetic conductive plate 491234 or the second magnetic conductive plate 491235) is in a range of 0.5 mm-1 mm. For example, the thickness of the magnetic conductive plate (the first magnetic conductive plate 491234 or the second magnetic conductive plate 491235) is in a range of 0.6 mm-0.7 mm.

In some embodiments, to facilitate the assembly and positioning of the magnet 491233 and the magnetic conductive plate (the first magnetic conductive plate 491234 and/or the second magnetic conductive plate 491235), and to reduce the mass of the transducer 4912 (and further reduce the overall mass of the acoustic output device 4900), holes may be disposed in the magnet 491233 and/or the magnetic conductive plate (the first magnetic conductive plate 491234 and/or the second magnetic conductive plate 491235). For example, as shown in FIG. 54A, the magnet 491233 is disposed with a first hole 491233a, and the magnetic conductive plate is disposed with a second hole 491234a. The second hole 491234a and the first hole 491233a are disposed in correspondence so as to facilitate the assembly positioning of the magnet 491233 with the magnetic conductive plate (the first magnetic conductive plate 491234 and/or the second magnetic conductive plate 491235).

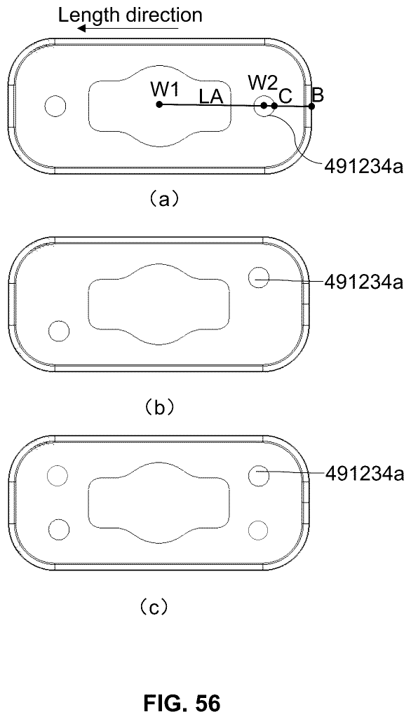

In some embodiments, to improve an assembly precision, there are at least two second holes 491234a in the magnetic conductive plate. Correspondingly, there are at least two first holes 491233a on the magnet 491233, and each first holes 491233a corresponds to one second hole 491234a. FIG. 56 is a schematic structure diagram illustrating a top view of a magnetic conductive plate according to some embodiments of the present disclosure. As shown in (a) in FIG. 56, the magnetic conductive plate is a rounded rectangular structure, and the two second holes 491234a are disposed along a length direction of the magnetic conductive plate (as shown in (a) in FIG. 56). In some embodiments, the two second holes 491234a are disposed on a centerline of the magnetic conductive plate along the length direction. As shown in (b) in FIG. 56, the magnetic conductive plate is a rounded rectangular structure, and the two second holes 491234a are disposed along a diagonal direction of the magnetic conductive plate. As shown in (c) in FIG. 56, the magnetic conductive plate is a rounded rectangular structure with second holes 491234a disposed therein near each of the four rounded corners.

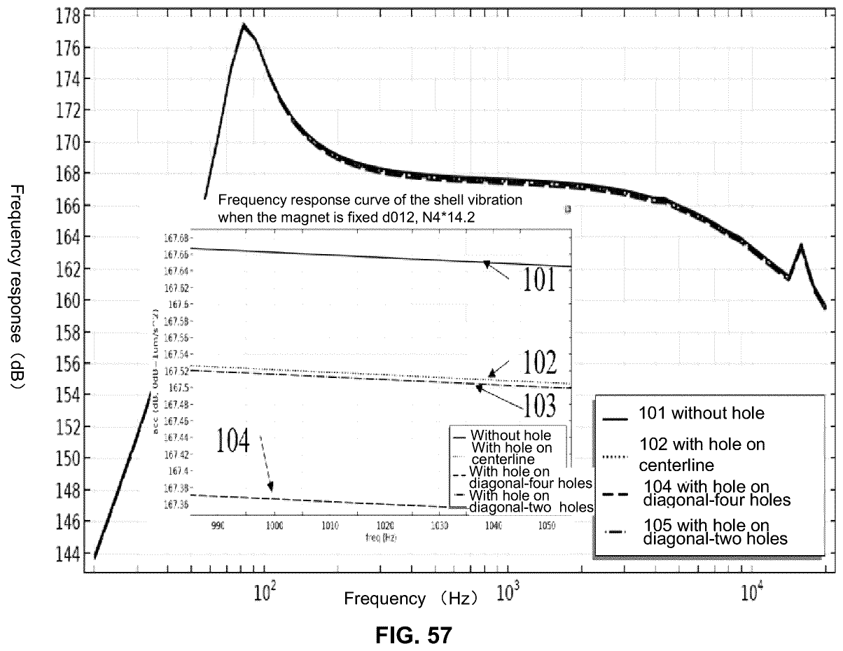

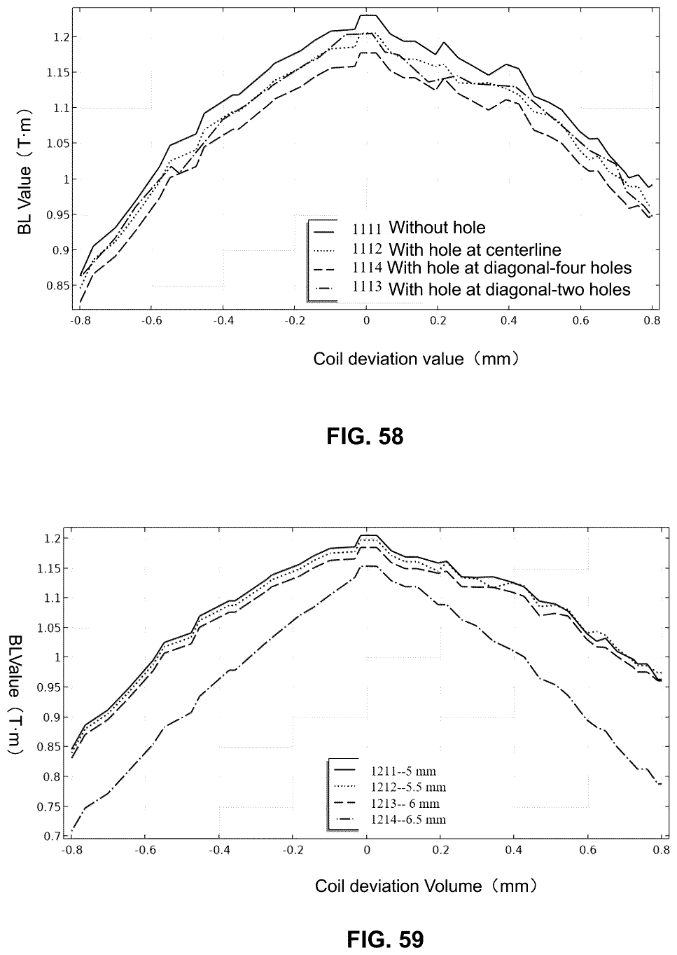

FIG. 57 is a comparison diagram illustrating frequency response curves of magnetic conductive plates without and with holes according to some embodiments of the present disclosure. FIG. 58 is a comparison diagram illustrating BL value curves of magnetic conductive plates without and with holes along the length direction according to embodiments of the present disclosure. In FIG. 57, curve 101 is the frequency response curve of the magnetic conductive plate without holes, curve 102 is the frequency response curve of the magnetic conductive plate with two holes disposed on a center line along a length direction of the magnetic conductive plate (as shown in (a) in FIG. 56), curve 103 is the frequency response curve of the magnetic conductive plate with two holes disposed along a diagonal line of the magnetic conductive plate (as shown in (b) in FIG. 56), and curve 104 is the frequency response curve of the magnetic conductive plate with four holes disposed along a diagonal line of the magnetic conductive plate (as shown in (c) in FIG. 56). As shown in FIG. 57, comparing curves 102 and 103, it can be seen that the frequency response curve of the magnetic conductive plate when two holes are set up on the center line along the length direction is almost the same as the frequency response curve with two holes disposed along the diagonal line; comparing curves 103 and 104, it can be seen that, when disposing holes along the diagonal line, with the increase in a number of holes, the frequency response is slightly reduced, and the reduction degree is almost in a range of 0.5 dB. Comparing curve 101 with the other curves (curves 102, 103, or 104), it can be seen that compared to the magnetic conductive plate without holes, the frequency response is slightly reduced by about 0.5 dB, so that the holes do not have a significant effect on the frequency response. However, from a point of view of weight reduction and ease of assembly and positioning, the holes allow the mass of the transducer 4912 to be reduced, while facilitating the assembly and positioning of the magnet 491233 with the magnetic conductive plate (the first magnetic conductive plate 491234 and/or the second magnetic conductive plate 491235).

In FIG. 58, curve 1111 is the BL value curve when the magnetic conductive plate has no holes, curve 1112 is the BL value curve when the magnetic conductive plate is disposed with two holes along the centerline in the length direction (as shown in (a) in FIG. 56), curve 1113 is the BL value curve when the magnetic conductive plate is disposed with two holes along the diagonal line (as shown in (b) in FIG. 56), and curve 1114 is the BL value curve when the magnetic conductive plate is disposed with four holes along the diagonal line (as shown in (c) in FIG. 56). The BL value refers to a product of the magnetic field strength and the length of the coil wire, which is used to reflect an electromagnetic feature. As shown in FIG. 58, comparing curves 1112 and 1113, it can be seen that the BL value curve of the magnetic conductive plate when two holes are disposed on the centerline along the length direction is almost the same as the BL value curve of the magnetic conductive plate when two holes are disposed along the diagonal line; and comparing curves 1113 and 1114, it can be seen that when the holes are disposed on the diagonal, it can be seen that the BL value decreases slightly with the increase in the number of holes. Comparing curve 1111 with the other curves (curves 1112 or 1113 or 1114), it can be seen that, compared to the magnetic conductive plate without holes, there is a slight decrease in the BL value, which is almost in the range of 0.05 T m, so that the holes do not have a significant effect on the BL value. However, from the point of view of a weight reduction and ease of assembly and positioning, the holes allow the mass of the transducer 4912 to be reduced, while facilitating the assembly and positioning of the magnet 491233 with the magnetic conductive plate (the first magnetic conductive plate 491234 and/or the second magnetic conductive plate 491235).

In some embodiments, the position at which the second hole 491234a on the magnetic conductive plate is set has a greater impact on the BL value of the transducer 4912. Taking the example of setting two second holes 491234a on the centerline of the magnetic conductive plate along the length direction, FIG. 59 is a comparison diagram illustrating BL value curves when a second hole on a magnetic conductive plate is at different distances from a center of the magnetic conductive plate according to some embodiments of the present disclosure. As shown in FIG. 59, curve 1211 is the BL value curve when the second hole 491234a is 5 mm away from a center of the magnetic conductive plate. Curve 1212 is the BL value curve when the second hole 491234a is 5.5 mm away from the center of the magnetic conductive plate. Curve 1213 is the BL value curve when the second hole 491234a is 6 mm from the center of the magnetic conductive plate. Curve 1214 is the BL value curve when the second hole 491234a is 6.5 mm from the center of the magnetic conductive plate. At the same coil offset (e.g., a coil offset of 0 mm), curve 1211, curve 1212, curve 1213, and curve 1214 decrease sequentially, with curve 1214 being significantly lower than the other three curves. The center of the magnetic conductive plate herein refers to a geometric center of the magnetic conductive plate. From FIG. 59, it can be seen that the further the second hole 491234a is from the center of the magnetic conductive plate, the more it tends to be located at an edge of the magnetic conductive plate, and the more significantly the BL value of the transducer 4912 decreases, so the second hole 491234a should not be set as close as possible to the edge of the magnetic conductive plate. It should be noted that a distance between the second hole 491234a and the center of the magnetic conductive plate refers to a distance between the center of the second hole and the geometric center of the magnetic conductive plate. In some embodiments, to increase the BL value of the transducer 4912, a ratio of a hole area of the second hole 491234a to an area of a surface of the magnetic conductive plate where the second hole 491234a is located is less than 36%, and a shape and a position of the second hole 491234a are not limited. It should be noted that the distance between the edge of the second hole 491234a and the edge of the magnetic conductive plate is shown in (a) in FIG. 56. A line connecting a hole center W2 of the second hole 491234a and a geometric center WI of the magnetic conductive plate and extending toward the edge of the magnetic conductive plate forms a straight line LA, an intersection of the straight line LA and the edge of the magnetic conductive plate is a point B, the intersection of the straight line LA and the edge of a side of the second hole 491234a near the point B is a point C, the distance between the edge of the second hole 491234a and the edge of the magnetic conductive plate is the distance between point B and point C on the straight line LA. In some embodiments, the distance between the edge of the second hole 491234a and the edge of the magnetic conductive plate is greater than 0.2 mm, which prevents the second hole from being too adjacent to the edge and reducing a structural strength, and also reduces an influence of the second hole on the magnetic field strength, so as to ensure that the sensitivity of the speaker is not significantly reduced.

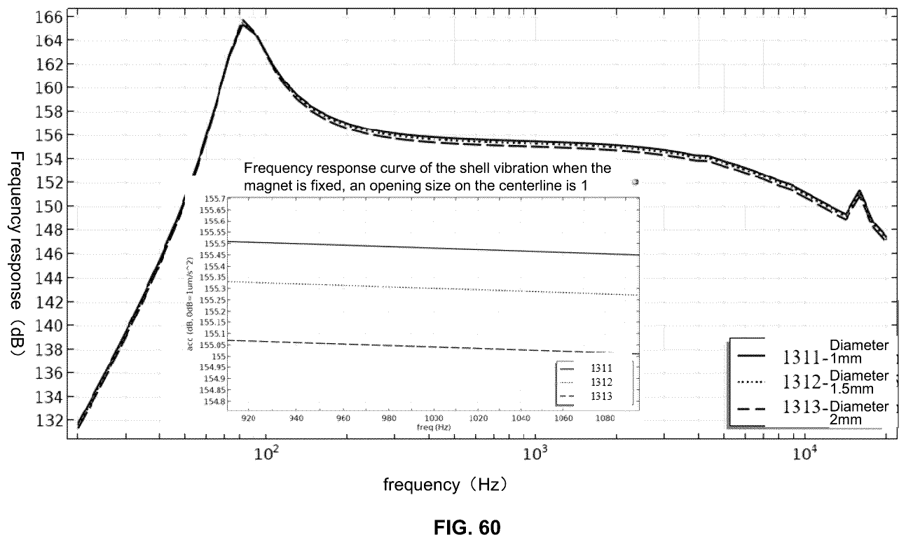

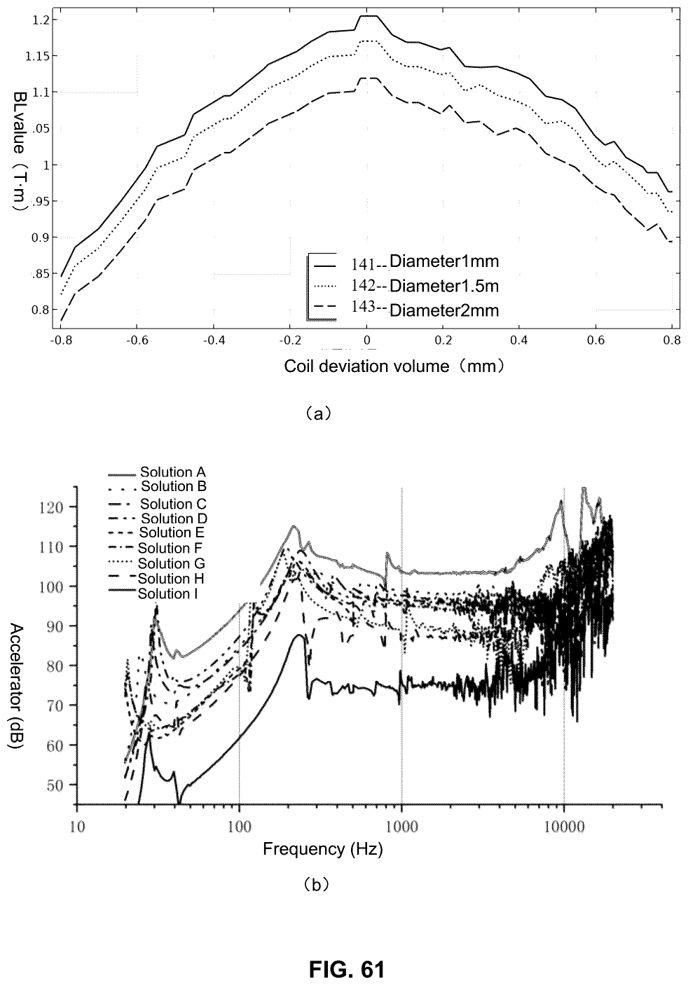

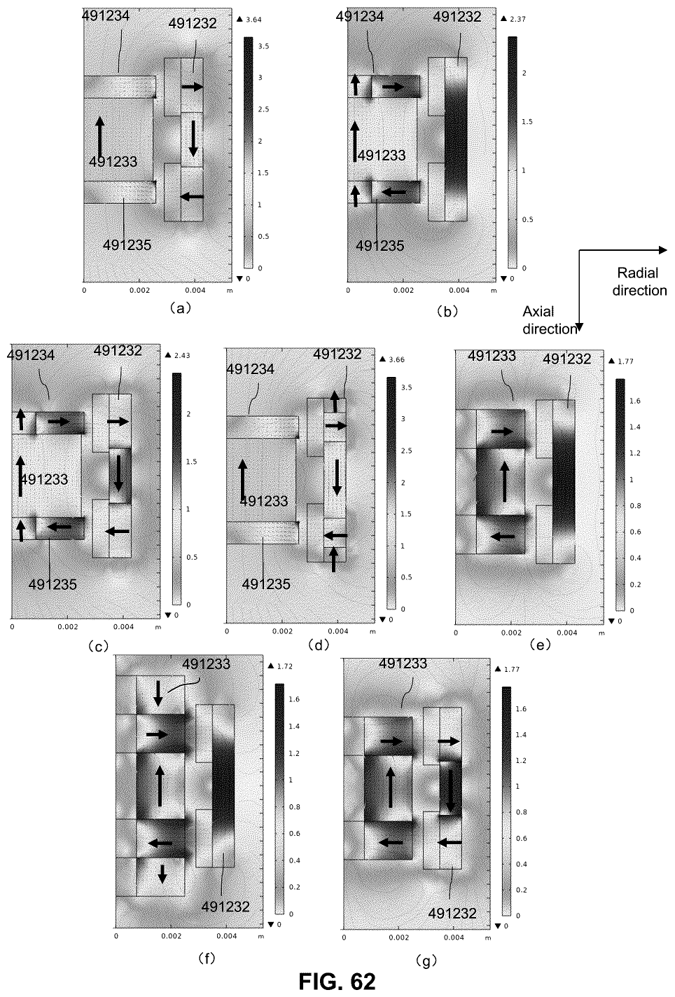

FIG. 60 is a comparison diagram illustrating frequency response curves when the second hole 491234a has different diameters according to some embodiments of the present disclosure. As shown in FIG. 60, curve 1311 is a frequency response curve when the second hole 491234a has a diameter of 1 mm, curve 1312 is the frequency response curve when the second hole 491234a has a diameter of 1.5 mm, and curve 1313 is the frequency response curve when the second hole 491234a has a diameter of 2 mm. As the diameter of the second hole 491234a increases, the frequency response of the transducer 4912 decreases, and for every increase of 0.5 mm in diameter, the frequency response of the transducer 4912 decreases by about 0.5 dB. FIG. 61 is a comparison diagram illustrating BL value curves when the second hole 491234a has different diameters. As shown in FIG. 61, curve 141 is a BL value curve when the second hole 491234a has a diameter of 1 mm, curve 142 is the BL value curve when the second hole 491234a has a diameter of 1.55 mm, and curve 143 is the BL value curve when the second hole 491234a has a diameter of 2 mm. As the diameter of the second hole 491234a increases, the BL value decreases. Therefore, the greater the diameter of the second hole 491234a, the smaller the frequency response and the BL value. However, due to the influence of machining accuracy and structural strength, the diameter of the second hole 491234a cannot be too small. Therefore, to avoid that the second hole 491234a is too small and the corresponding positioning column is too thin, and thus to avoid an insufficient structural strength caused by the positioning column being too thin and the machining accuracy requirement is too high, at the same time, to avoid that the diameter is too great to reduce the frequency response and the BL value, the diameter of the second hole 491234a is in a range of 1.5 mm-2.5 mm. For example, the diameter of the second hole 491234a is in a range of 1.8 mm-2.3 mm. In some embodiments, to balance a magnetic field strength and the sensitivity of the transducer 4912, a ratio of an area of the second hole 491234a to an area of a surface of the magnetic conductive plate where the second hole 491234a is disposed is less than 36%.

In some embodiments, by setting a number of turns of the coil 49124 along a radial direction of the transducer 4912 to an even number to make the incoming position and the outgoing position of the first coil 491241 or the second coil 491242 are located at the same position of the magnetic conductive shield 491232, so that an inner wall of the magnetic conductive shield 491232 fits to an outer wall of the coil 49124, the mass of the transducer 4912 may be reduced (and the mass of the acoustic output unit 4910 may be reduced). In addition, by shaping of the coil 49124 (the first coil 491241 and the second coil 491242) into a “slender type,” and by selecting suitable parameters for the coil 49124, it is possible to reduce the inner diameter of the magnetic conductive shield 491232, so as to reduce the mass of the transducer 4912 (and thus the mass of the acoustic output unit 4910 is reduced). In some embodiments, the mass of the transducer 4912 (and thus the mass of the acoustic output unit 4910) is reduced either by providing a weight reduction groove on the magnetic conductive shield 491232 or by providing holes in the magnet 491233 and/or the magnetic conductive plate (the first magnetic conductive plate 491234 and/or the second magnetic conductive plate 491235). In some embodiments, a mass m of the weight-reduced acoustic output unit 4910 is in a range of 2 g-5 g. For example, the mass m of the acoustic output unit 4910 is in a range of 3.8 g-4.5 g. [0277](b) in FIG. 61 is a comparison diagram illustrating acceleration curves of a speaker when a mass is in a range of 2 g to 5 g according to some embodiments of the present disclosure. d0 denotes a wire diameter of the coil (the first coil and the second coil), N denotes a number of radial turns and a number of axial layers (e.g., N5*12 denotes that the number of radial turns is 5, and the number of axial layers is 12), NO denotes a product of the number of radial turns and the number of axial layers, and “paralleling” denotes that two coils are connected in parallel. As shown in (b) in FIG. 61, under an excitation of a test voltage, the transducer 4912, which has been reduced in weight (the mass of the transducer 4912 is in the range of 2 g-5 g) as described in some embodiments of the present disclosure, has an acceleration in a range of 70 dB-110 dB at 1 kHz. The acceleration curve shown in (b) in FIG. 61 is measured as follows: the transducer 4012 of the present disclosure is excited to generate vibration under the test voltage, and a displacement generated by the transducer 4912 driving the panel 1913 is measured by laser testing, then the displacement is normalized by data processing, i.e., the displacement of a corresponding frequency band is divided by the corresponding test voltage, and then an acceleration dB value is obtained by dividing the normalized displacement by 1 mm/s². In some embodiments, the sensitivity of the transducer 4912 is increased by adjusting the transducer 4912 to a suitable range of acceleration so as to enhance a sound quality of the acoustic output unit 4910. Even though an amplitude of the BL value curve decreases after the weight reduction, the frequency response acceleration is enhanced. The acceleration curve shown in (b) in FIG. 61 is obtained by measuring the vibration acceleration of the panel 4913 when the support structure 4920 fixed.

In some embodiments, the acoustic output unit 4910 includes an air conduction speaker and a bone conduction speaker (e.g., as shown in FIG. 51 or FIG. 52A). In some embodiments, frequency division points of the bone conduction and the air conduction are set in a low-medium frequency range, e.g., a range of 400 Hz-500 Hz. A sound greater than the frequency division point is generated by the bone conduction speaker, and the sound smaller than the frequency division point is generated by the air conduction speaker. In this way, the bone conduction speaker is prevented from vibrating in a low frequency band and making the user feel an obvious vibration. At the same time, as the bone conduction speaker has a relatively flat frequency response curve at a distance after a resonance peak frequency, an output distortion corresponding to the portion of the frequency band is relatively small. Therefore, the resonance peak frequency of the bone conduction speaker is set at a position lower than the frequency division point, which keeps a certain distance from the frequency division point. In some embodiments, the resonance peak frequency of the transducer 4912 is less than 300 Hz.

In some embodiments, to make the resonance peak frequency of the transducer 4912 less than 300 Hz, a range of a ratio of an elasticity coefficient k of the vibration transmission sheet 49122 in a total axial direction (parallel to the vibration direction) to a mass m of the transducer 4912 is set as

$$\frac{k}{m} < {( 2 π \cdot 300 )}^{2} \approx 3.6 \times {10}^{6} {Hz}^{2} .$$

m. In some embodiments, the mass of the transducer 4912 includes a sum of the masses of the magnetic conductive shield 491232, the coil 49124, and the shell 4911, or includes a sum of the masses of the air conduction speaker 4916, the magnetic conductive shield 491232, the coil 49124, and the shell 4911. The elasticity coefficient k is in N/m (newtons per meter) and the mass m is in g (gram).

In some embodiments, to reduce the overall volume and mass so as to enhance the sound quality, the mass m of the transducer 4912 is in a range of 2 g-5 g. For example, the mass of the transducer 4912 is in a range of 2.2 g-4.8 g. Further example, the mass of the transducer 4912 is in a range of 3.8 g-4.5 g.

In some embodiments, based on the range of mass of the transducer 4912 and a range of the ratio of the elasticity coefficient k of the vibration transmission sheet 49122 in the total axial direction to the mass m of the transducer 4912, it can be determined that the elasticity coefficient k of the vibration transmission sheet 49122 in the total axial direction is less than 18000 N/m. In some embodiments, the vibration transmission sheet 49122 includes the first vibration transmission sheet 49125 and the second vibration transmission sheet 49126 connected in parallel, as shown in FIG. 51. In some embodiments, the first vibration transmission sheet 49125 and the second vibration transmission sheet 49126 have the same axial elasticity coefficient k₀, and k₀ of each vibration transmission sheet is less than 9,000 N/m. In some embodiments, each of the first vibration transmission sheet 49125 and the second vibration transmission sheet 49126 has a different axial elasticity coefficient k₀, but the first vibration transmission sheet 49125 and the second vibration transmission sheet 49126 together provide a total axial direction elastic coefficient k of less than 18,000 N/m.

Thus, by adjusting a mass range of a mass block connected to a dual vibration transmission sheet formed by the first vibration transmission sheet 49125 and the second vibration transmission sheet 49126 and/or the elasticity coefficient of the dual vibration transmission sheet, it can achieve bone conduction resonance peak frequency not exceeding 300 Hz. It is noted that the mass of the mass block described herein refers to the mass of all the components that the dual vibration transmission sheet needs to push. For example, in the embodiment shown in FIG. 49A, the mass of the mass block is a total mass of the coil 49124, the magnetic conductive shield 491232, the support 49121, the panel 13, and the damping sheet 4914. For example, in the embodiment shown in FIG. 50, the mass of the mass block is the total mass of the coil 49124, the magnet conductive shield 491232, the panel 13, and the shell 4911. Additionally, in the embodiment of the bone-air conduction speaker, the mass of the mass block also includes the mass of the air conduction speaker. In some embodiments, the mass of the mass block also includes the mass of other necessary connecting components.

Thus, by adjusting a mass range of a mass block connected to a dual vibration transmission sheet formed by the first vibration transmission sheet 49125 and the second vibration transmission sheet 49126 and/or the elasticity coefficient of the dual vibration transmission sheet, it can achieve bone conduction resonance peak frequency not exceeding 300 Hz. It is noted that the mass of the mass block described herein refers to the mass of all the components that the dual vibration transmission sheet needs to push. For example, in the embodiment shown in FIG. 49 A, the mass of the mass block is the overall mass of the coil 49124, the magnetic conductive shield 491232, the support 49121, the panel 13, and the damping sheet 4914. For another example, in the embodiment shown in FIG. 50, the mass of the mass block is the overall mass of the coil 49124, the magnetic conductive shield 491232, the panel 13, and the shell 4911. Additionally, in the embodiment of the bone-air conduction speaker, the mass of the mass block also includes the mass of the air conduction speaker. Additionally, the mass of the mass block includes the mass of other necessary connecting components.

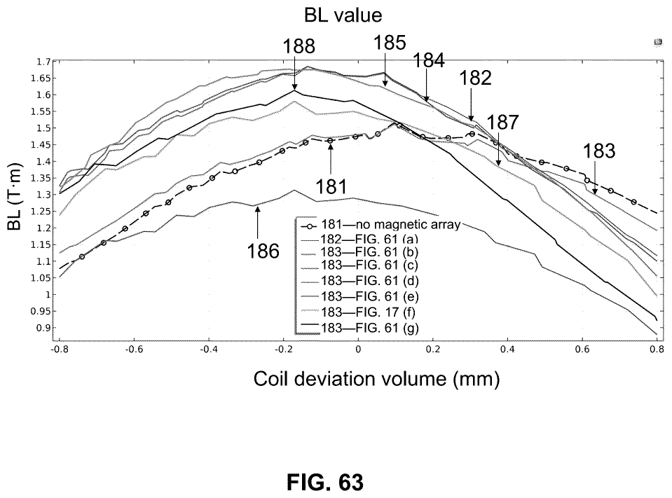

FIG. 62 is a schematic diagram illustrating a structure of a magnetic circuit assembly 49123 in a form of a Halbach Array (HA) according to some embodiments of the present disclosure. It is noted that FIG. 62 shows a center cross-section of the magnetic circuit assembly 49123 and is a right half of a 2D axisymmetric image. Referring to FIG. 51, FIG. 53, and FIG. 62, the transducer 4912 includes the magnetic circuit assembly 49123 and the coil 49124. The magnetic circuit assembly 49123 includes the magnet assembly 491231 and the magnetic conductive shield 491232. The coil 49124 is disposed on an outer side of the magnet assembly 491231 around an axis parallel to the vibration direction, and the magnetic conductive shield 491232 is disposed on an outer side of the coil 49124 around the axis. In some embodiments, at least one of the magnet 491233, the magnetic conductive plate, or the magnetic conductive shield 491232 included in the magnet assembly 491231 includes a plurality of magnetic portions with different magnetization directions. In some embodiments, the magnet assembly 491231 and/or the magnetic conductive shield 491232 includes a plurality of magnetic portions (e.g., magnets) with different magnetization directions. A plurality of magnetic portions with different magnetization directions can form a Halbach array (e.g., as shown in FIG. 62, (a)-(g)). With a particular array arrangement, the magnetic field is concentrated on a certain side of the magnetic assembly 1231, thereby enhancing the strength of the magnetic field at the coil 49124.

In some embodiments, the magnet 491233, the magnetic conductive plate, or the magnet conductive shield 491232 has a magnetic portion array formed by a plurality of magnetic portions with different magnetization directions. In some embodiments, the magnetization directions of the plurality of magnetic portions rotate in a clockwise or counterclockwise direction on a surface parallel to the vibration direction of the transducer. As shown in (a) in FIG. 62, there is no magnetic portion array in the magnet 491233 and the magnetic conductive plate (the first magnetic conductive plate 491234 and/or the second magnetic conductive plate 491235). The magnetic conductive shield 491232 includes three layers of magnetic portions arranged in an axial direction, which have magnetization directions of radially outward, axially downward, and radially inward, respectively, from top to bottom. As shown in (b) in FIG. 62, there is no magnetic portion array in the magnetic conductive shield 491232 and the magnet 491233, and the magnetic conductive plate (the first magnetic conductive plate 491234 and/or the second magnetic conductive plate 491235) includes four magnetic portions disposed in the radial direction. The uppermost magnetic portion and the lowermost magnetic portion each includes two magnetic portions disposed in the radial direction. The magnetization directions of the two magnetic portions of the uppermost magnetic portion are axially upward and radially outward from left to right, respectively, and the magnetization directions of the two magnetic portions of the lowermost magnetic portion are axially upward and radially inward from left to right, respectively. In some embodiments, the magnetic conductive plate (the first magnetic conductive plate 491234 and/or the second magnetic conductive plate 491235) and the magnetic conductive shield 491232 both have a magnetic portion array. As shown in (c) in FIG. 62, the magnetic portion array of the magnetic conductive plate (the first magnetic conductive plate 491234 and/or the second magnetic conductive plate 491235) is similar to the magnetic portion array of the magnetic conductive plate as shown in (b) in FIG. 62, and the magnetic portion array of the magnetic conductive shield 491232 is similar to the magnetic portion array of the magnetic conductive shield 491232 as shown in (a) in FIG. 62. In some embodiments, compared to the three-layer magnetic portion array, the magnet 491233, the magnetic conductive plate, and/or the magnetic conductive shield 491232 have a greater number of magnetic portion arrays. As shown in (d) in FIG. 62, there is no magnetic portion array in the magnet 491233 and the magnetic conductive plate (the first magnetic conductive plate 491234 and/or the second magnetic conductive plate 491235), and the magnetic conductive shield 491232 includes five layers of magnetic portions arranged in the axial direction. The five layers of magnetic portions have the magnetization directions of axially upward, radially outward, axially downward, radially inward, and axially upward, respectively, from top to bottom. In some embodiments, the magnet 491233 is a hollow ring structure. As shown in (e) in FIG. 62, the magnet 491233 includes three layers of magnetic portions arranged in the axial direction. The three layers of magnetic portions have the magnetization directions of radially outward, axially upward, and radially inward, respectively, from top to bottom. As shown in (f) in FIG. 62, the magnet 491233 includes five layers of magnetic portions arranged in the axial direction. The five layers of magnetic portions have the magnetization directions of axially downward, radially outward, axially upward, radially inward, and axially downward, respectively from top to bottom. As shown in (g) in FIG. 62, the magnet 491233 includes the three layers of magnetic portions arranged in the axial direction. The three layers of magnetic portions have the magnetization directions of radially outward, axially upward, and radially inward, respectively, from top to bottom. The magnetic conductive shield 491232 includes the three layers of magnetic portions arranged in the axial direction. The three layers of magnetic portions have the magnetization directions of radially outward, axially downward, and radially inward, respectively, from top to bottom. In some embodiments, at least two adjacent magnetic portions of the plurality of magnetic portions have magnetization directions perpendicular to each other.

FIG. 63 is a comparison diagram of BL value curves for the magnetic circuit assembly 49123 with different magnetic portion arrays. In FIG. 63, curve 181 is a BL value curve of the magnetic circuit assembly 49123 without the magnetic portion array, and curves 182-188 are BL value curves of the magnetic circuit assembly 49123 when the magnetic circuit assembly 49123 has the magnetic portion array as shown in (a)-(g) in FIG. 62, respectively. From FIG. 63, it can be seen that the magnetic field strength is increased by the magnetic conductive shield and/or the magnet assembly with the magnetic portion array compared to the magnetic conductive shield and/or the magnet assembly without the magnetic portion array. The magnetic conductive shield with the magnetic portion array has a more significant increase in the magnetic field strength of about 12% compared to the magnetic conductive shield without the magnetic portion array. By setting the magnet 491233 as a hollow ring-shaped magnetic portion array, the magnetic field strength is still increased by about 6% compared to the magnet without the magnetic portion array.

Beneficial effects of the embodiments of the acoustic output device 4900 of the present disclosure include, but are not limited to, (1) by setting the number of turns of the coil 49124 along the radial direction of the transducer 4912 to an even number, the incoming and outgoing lines of the first coil 491241 or second coil 491242 are located at the same position of the magnetic conductive shield 491232, the inner wall of the magnetic conductive shield 491232 can be fitted to the outer wall of the coils 49124, and the mass of the transducer 4912 (and thus the mass of the acoustic output unit 4910) can be reduced; (2) by shaping the coils 49124 (the first coil 491241 and the second coil 491242) into “slender type” and selecting suitable parameters of the coils 49124, the inner diameter of the magnetic conductive shield 491232 can be reduced to reduce the mass of the transducer 4912 (and thus reducing the mass of the acoustic output unit 4910); (3) by providing the weight reduction groove in the magnetic conductive shield 491232 or by disposing holes in the magnet 491233 and/or the magnetic conductive plate (the first magnetic conductive plate 491234 and/or the second magnetic conductive plate 491235), the mass of the transducer 4912 can be reduced (and thus reducing the mass of the acoustic output unit 4910); (4) by adjusting the mass of the acoustic output unit 4910 and a total axial elasticity coefficient of the vibration transmission sheet 49122, the bone conduction resonance peak frequency can be made no more than 300 Hz so as to prevent the bone conduction speaker from vibrating in the low frequency band and causing the user to feel obvious vibration; (5) by setting the stiffness of the vibration transmission sheet 49122 in any direction (radial direction) in a plane perpendicular to the vibration direction, the magnetic attraction force of the magnet assembly 491231 can be resisted to avoid the magnet deviation in the transducer 4912; (6) by setting the ratio of the thickness of the magnetic conductive plate to the thickness of the magnet 491233, the strength of the magnetic field can be improved and the magnetic saturation can be avoided to enhance the sensitivity of the acoustic output unit 4910; (7) by setting the magnetic portion array with different magnetization directions in at least one of the magnet 491233, the magnetic conductive plate, and/or the magnet conductive shield 491232, the strength of the magnetic field is enhanced, and thus the sensitivity of the acoustic output unit 4910 is enhanced; (8) by employing the double coil (the first coil 491241 and the second coil 491242), a double drive is realized, and the high-frequency impedance of the coils is reduced so that the sensitivity of the transducer 4912 can be improved; (9) by fixing the dual vibration transmission sheets 49122 on both sides of the magnet 491233, it is ensured that the output can be of high sensitivity while ensuring the stability of the vibration of the magnet 491233 through the support of the dual vibration transmission sheets 49122; (10) the coils 49124 are fitted to the magnetic conductive shield 491232, which makes the magnetic gap between the magnetic conductive shield 491232 and the coil 49124 smaller, and thus the magnetic field is more centralized, and thus the sensitivity of the transducer 4912 can be improved.

The basic concepts have been described above, and it is apparent to those skilled in the art that the foregoing detailed disclosure serves only as an example and does not constitute a limitation of the present disclosure. Although not explicitly stated here, those skilled in the art may make various modifications, improvements and amendments to the present disclosure. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, “an embodiment,” “one embodiment,” and/or “some embodiments” means a feature, a structure, or a characteristic associated with at least one embodiment of the present disclosure. Accordingly, it should be emphasized and noted that two or more references to “an embodiment” or “one embodiment” in different positions in the present disclosure are not intended to be used in the context of the present disclosure. In addition, some features, structures, or characteristics in one or more embodiments of the present disclosure may be appropriately combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

At last, it should be understood that the embodiments described in the present disclosure are merely illustrative of the principles of the embodiments of the present disclosure. Other modifications employed are within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An acoustic output device comprising:
a transducer configured to generate a mechanical vibration based on an electrical signal, the transducer including a magnetic circuit assembly and a vibration transmission sheet;
a housing configured to accommodate the transducer, the housing including a panel and a shell, the magnetic circuit assembly being elastically connected to the housing through the vibration transmission sheet, and the transducer transmitting the mechanical vibration to a user through the panel; and
an additional element connected to the magnetic circuit assembly, wherein the additional element is elastically connected to the panel through the magnetic circuit assembly, wherein the additional element includes an air conduction loudspeaker.

2. The acoustic output device of claim 1, wherein the additional element and the magnetic circuit assembly vibrate with respect to the panel to generate a resonant peak located within a target frequency range, the target frequency range being 20 Hz to 800 Hz.

3. The acoustic output device of claim 2, wherein the additional element and the magnetic circuit assembly vibrate with respect to the panel to further generate a resonant valley within the target frequency range, the resonant valley corresponding to a frequency less than a frequency corresponding to the resonant peak.

4. The acoustic output device of claim 1, wherein
the panel is located at one end of the shell and forms an accommodation cavity for accommodating the transducer with the shell,
the magnetic circuit assembly is elastically connected to the panel through the vibration transmission sheet,
the panel is connected to the shell through an elastic element,
the magnetic circuit assembly is rigidly connected to at least a portion of a sidewall of the shell adjacent to the panel, and
the vibration transmission sheet is located between the panel and the magnetic circuit assembly and elastically connects the magnetic circuit assembly with the panel.

5. The acoustic output device of claim 1, wherein
the shell includes a shell body and aback panel, the shell body being a sidewall of the shell adjacent to the panel, the back panel being a sidewall of the shell opposite to the panel;
the panel and the back panel are respectively disposed at opposite ends of the shell body and are rigidly connected to the panel; and
the acoustic output device further includes a support member, wherein
the support member is disposed around a peripheral side of the shell body or disposed on a side of the shell body,
the magnetic circuit assembly is rigidly connected to the support member, and
the additional element is rigidly connected to the support member.

6. The acoustic output device of claim 5, wherein the vibration transmission sheet is disposed between the magnetic circuit assembly and the panel, and elastically connects the magnetic circuit assembly with the panel.

7. The acoustic output device of claim 5, wherein the vibration transmission sheet is disposed between the magnetic circuit assembly and the back panel, and elastically connects the magnetic circuit assembly with the back panel.

8. The acoustic output device of claim 6, wherein filling materials or elastic elements are disposed between one end of the support member and the panel, and between another end of the support member and the back panel.

9. The acoustic output device of claim 5, wherein there are a plurality of vibration transmission sheets, and the plurality of vibration transmission sheets include a first vibration transmission sheet and a second vibration transmission sheet, wherein
the first vibration transmission sheet is disposed between the magnetic circuit assembly and the panel and elastically connects the magnetic circuit assembly with the panel; and
the second vibration transmission sheet is disposed between the magnetic circuit assembly and the back panel and elastically connects the magnetic circuit assembly with the back panel.

10. The acoustic output device of claim 5, wherein
the support member has a cylindrical structure disposed around the peripheral side of the shell body,
a notch is disposed on a sidewall corresponding to the shell body,
a peripheral side of the magnetic circuit assembly is rigidly connected to the cylindrical structure through the notch, and
the additional element is rigidly connected to the cylindrical structure.

11. The acoustic output device of claim 6, wherein
the support member has a plate structure provided on one side of the shell body,
a notch is provided on a sidewall corresponding to the shell body,
a portion structure of the magnetic circuit assembly is rigidly connected to the plate structure through the notch, and
the additional element is rigidly connected to the plate structure.

12. The acoustic output device of claim 1, wherein the vibration transmission sheet includes a center region, an edge region, and a plurality of supporting rods connecting the edge region and the center region, wherein
the central region of the vibration transmission sheet is connected to a side of the magnetic circuit assembly that faces away from the panel, and
the edge region of the vibration transmission sheet is connected to the shell.

13. The acoustic output device of claim 12, wherein in a natural state of the vibration transmission sheet, the edge region of the vibration transmission sheet is not coplanar with the center region of the vibration transmission sheet, and when the vibration transmission sheet is connected to the magnetic circuit assembly and the shell, a pretightening force is provided.

14. The acoustic output device of claim 12, wherein the plurality of supporting rods include four supporting rods spaced apart along a peripheral side of the center region of the vibration transmission sheet.

15. The acoustic output device of claim 12, wherein for one of the plurality of supporting rods, in a length direction of the vibration transmission sheet, a ratio of a distance between a start point and an end point of the supporting rod to a length of the supporting rod is in a range of 0-1.2.

16. The acoustic output device of claim 12, wherein, for one of the plurality of supporting rods, one or more of the following conditions are satisfied:
the length of the supporting rod is in a range of 7 mm-25 mm;
a thickness of the supporting rod is in a range of 0.1 mm-0.2 mm;
a width of the supporting rod is in a range of 0.25 mm-0.5 mm; or
a ratio of a thickness of the vibration transmission sheet where the supporting rod is located to a width of the supporting rod is in a range of 0.16-0.75.

17. The acoustic output device of claim 12, wherein each of the supporting rods includes one or more winding and bending structures.

18. The acoustic output device of claim 1, wherein the shell includes one or more pressure relief holes configured to connect air inside and outside the housing.

19. The acoustic output device of claim 1, wherein the acoustic output device includes a support structure configured to wear the acoustic output device in an ear or a head region of the user without blocking an ear canal of the user, and the support structure is rigidly connected to the panel or the shell.

20. The acoustic output device of claim 1, wherein a vibration direction of a diaphragm in the air conduction loudspeaker forms an angle of 75°-100° with the vibration direction of the transducer.
